(19) United States
(12) Patent Application Publication
(10) Pub. No.: US 2025/0173907 A1
(43) Pub. Date: May 29, 2025

(54) POINT CLOUD DATA TRANSMISSION DEVICE, POINT CLOUD DATA TRANSMISSION METHOD, POINT CLOUD DATA RECEPTION DEVICE, AND POINT CLOUD DATA RECEPTION METHOD

(71) Applicant: LG ELECTRONICS INC., Seoul (KR)

(72) Inventors: Daehyun KIM, Seoul (KR); Donggyu SIM, Seoul (KR); Hansol CHOI, Dongducheon-si, Gyeonggi-do (KR); Hanje PARK, Seoul (KR)

(21) Appl. No.: 18/843,673

(22) PCT Filed: Jan. 30, 2023
(86) PCT No.: PCT/KR2023/001342

§ 371 Date: Sep. 3, 2024

(30) Foreign Application Priority Data
Mar. 4, 2022 (KR) 10-2022-0028343
Sep. 14, 2022 (KR) 10-2022-0115429

(51) Int. Cl. G06T 9/00

(52) U.S. Cl. CPC G06T 9/001

(57) ABSTRACT

A point cloud data transmission method according to embodiments may comprise the steps of: encoding point cloud data; and transmitting the point cloud data. A point cloud data reception method according to embodiments may comprise the steps of: receiving a bitstream comprising point cloud data; and decoding the point cloud data.

### CROSS-REFERENCE TO RELATED APPLICATIONS

This application is a National Stage application under 35 U.S.C. § 371 of International Application No. PCT/KR2023/001342, filed on Jan. 30, 2023, which claims the benefit of and priority to Korean Patent Application No. 10-2022-0028343, filed on Mar. 4, 2022 and Korean Patent Application No. 10-2022-0115429, filed on Sep. 14, 2022. The disclosures of the prior applications are incorporated by reference in their entirety.

### TECHNICAL FIELD

Embodiments provide a method for providing point cloud content to provide a user with various services such as virtual reality (VR), augmented reality (AR), mixed reality (MR), and self-driving services.

### BACKGROUND

A point cloud is a set of points in a three-dimensional (3D) space. It is difficult to generate point cloud data because the number of points in the 3D space is large.

A large throughput is required to transmit and receive data of a point cloud.

### SUMMARY

An object of the present disclosure is to provide a point cloud data transmission device, a point cloud data transmission method, a point cloud data reception device, and a point cloud data reception method for efficiently transmitting and receiving a point cloud.

Another object of the present disclosure is to provide a point cloud data transmission device, a point cloud data transmission method, a point cloud data reception device, and a point cloud data reception method for addressing latency and encoding/decoding complexity.

Embodiments are not limited to the above-described objects, and the scope of the embodiments may be extended to other objects that can be inferred by those skilled in the art based on the entire contents of the present disclosure.

The object of the present disclosure can be achieved by providing a method of transmitting point cloud data. The method may include encoding point cloud data, and transmitting the point cloud data. In another aspect of the present disclosure, provided herein is a method of receiving point cloud data. The method may include receiving point cloud data, decoding the point cloud data, and rendering the point cloud data.

The point cloud data transmission method, the point cloud data transmission apparatus, the point cloud data reception method, and the point cloud data reception apparatus according to the embodiments may provide a good-quality point cloud service.

The point cloud data transmission method, the point cloud data transmission apparatus, the point cloud data reception method, and the point cloud data reception apparatus according to the embodiments may achieve various video codec methods.

The point cloud data transmission method, the point cloud data transmission apparatus, the point cloud data reception method, and the point cloud data reception apparatus according to the embodiments may provide universal point cloud content such as a self-driving service.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates an exemplary structure of a transmission/reception system for providing point cloud content according to embodiments;

FIG. 2 illustrates capture of point cloud data according to embodiments;

FIG. 3 illustrates an exemplary point cloud, geometry, and texture image according to embodiments;

FIG. 4 illustrates an exemplary V-PCC encoding process according to embodiments;

FIG. 5 illustrates an example of a tangent plane and a normal vector of a surface according to embodiments;

FIG. 6 illustrates an exemplary bounding box of a point cloud according to embodiments;

FIG. 7 illustrates an example of determination of individual patch positions on an occupancy map according to embodiments;

FIG. 8 shows an exemplary relationship among normal, tangent, and bitangent axes according to embodiments;

FIG. 9 shows an exemplary configuration of the minimum mode and maximum mode of a projection mode according to embodiments;

FIG. 10 illustrates an exemplary EDD code according to embodiments;

FIG. 11 illustrates an example of recoloring based on color values of neighboring points according to embodiments;

FIG. 12 illustrates an example of push-pull background filling according to embodiments;

FIG. 13 shows an exemplary possible traversal order for a 4*4 block according to embodiments;

FIG. 14 illustrates an exemplary best traversal order according to embodiments;

FIG. 15 illustrates an exemplary 2D video/image encoder according to embodiments;

FIG. 16 illustrates an exemplary V-PCC decoding process according to embodiments;

FIG. 17 shows an exemplary 2D video/image decoder according to embodiments;

FIG. 18 is a flowchart illustrating operation of a transmission device according to embodiments of the present disclosure;

FIG. 19 is a flowchart illustrating operation of a reception device according to embodiments;

FIG. 20 illustrates an exemplary structure operable in connection with point cloud data transmission/reception methods/devices according to embodiments;

FIG. 21 illustrates a video-based point cloud compression (VPCC) encoder and a mesh encoder according to embodiments;

FIG. 22 illustrates a VPCC decoder and a mesh decoder according to embodiments;

FIG. 23 illustrates a scalable mesh encoder according to embodiments;

FIG. 24 illustrates a low-resolution mesh according to embodiments;

FIG. 25 illustrates initial positions and offsets of additional vertices when a submesh is a triangle according to embodiments;

FIG. 26 illustrates a scalable mesh decoder according to embodiments;

FIG. 27 illustrates operation of a mesh splitter according to embodiments;

FIG. 28 illustrates an example of an object and a 3D vertex patch in a mesh reconstructed from a base layer according to embodiments;

FIG. 29 illustrates a method of splitting triangle fan vertices according to embodiments;

FIG. 30 illustrates an example of splitting an arbitrary triangle fan using a triangle fan vertex splitting method according to embodiments;

FIG. 31 illustrates an example of splitting an arbitrary triangle fan using a triangle fan vertex splitting method according to embodiments;

FIG. 32 illustrates an example of axes of a vertex included in groups 1 and 2 according to embodiments;

FIG. 33 illustrates a procedure of deriving an additional vertex initial geometry and deriving an additional vertex final geometry according to embodiments;

FIG. 34 illustrates a procedure of executing the group 2 axis initial geometry derivation module described in FIG. 33 according to embodiments;

FIG. 35 illustrates a visualization of a procedure of executing the group 2 axis initial geometry derivation module described in FIG. 33 according to embodiments;

FIG. 36 illustrates an example of traversing multiple triangle fans in a reconstructed mesh and splitting each triangle fan with a triangle fan vertex splitting method according to embodiments;

FIG. 37 illustrates the execution of a triangle fan edge splitting method according to embodiments;

FIG. 38 illustrates an example of splitting a reconstructed triangle fan with a triangle fan edge splitting method according to embodiments;

FIG. 39 illustrates an example of traversing multiple triangle fans in a reconstructed mesh and splitting each triangle fan with a triangle fan edge splitting method according to embodiments;

FIG. 40 illustrates a procedure of performing triangle splitting according to embodiments;

FIG. 41 illustrates an example of splitting a reconstructed triangle with triangle splitting method 1 according to embodiments;

FIG. 42 illustrates an example of splitting a reconstructed triangle with triangle splitting method 2 according to embodiments;

FIG. 43 illustrates an example of splitting a reconstructed triangle with triangle splitting method 3 according to embodiments;

FIG. 44 illustrates an example of splitting a reconstructed triangle with triangle splitting method 4 according to embodiments;

FIG. 45 illustrates an example of traversing multiple triangles in a reconstructed mesh and splitting each triangle with triangle splitting method 2 according to embodiments;

FIG. 46 illustrates an example of traversing multiple triangles in a reconstructed mesh and splitting each triangle with an edge splitting method according to embodiments;

FIG. 47 illustrates the execution of a patch boundary splitting module according to embodiments;

FIG. 48 illustrates an example of bounding triangle groups according to embodiments;

FIG. 49 illustrates an example of a splitting result of bounding triangle group 2 according to embodiments;

FIG. 50 illustrates a VPCC bitstream according to embodiments;

FIG. 51 illustrates a V3C parameter set and enhancement layer tile data unit according to embodiments;

FIG. 52 illustrates enhancement layer patch information data and submesh split data according to embodiments;

FIG. 53 shows (x, y, z) delta values for each delta geometry index according to embodiments;

FIG. 54 illustrates a point cloud data transmission device according to embodiments;

FIG. 55 illustrates a point cloud data reception device according to embodiments;

FIG. 56 illustrates a method of transmitting point cloud data according to embodiments; and

FIG. 57 illustrates a method of receiving point cloud data according to embodiments.

### DETAILED DESCRIPTION

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

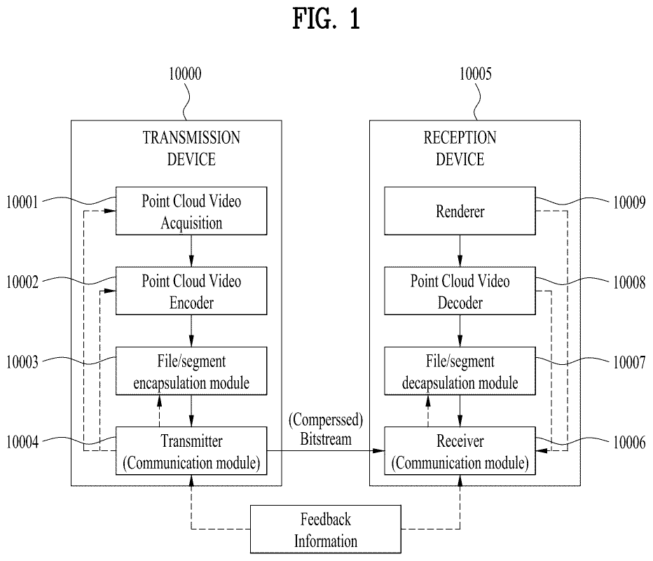

FIG. 1 illustrates an exemplary structure of a transmission/reception system for providing point cloud content according to embodiments.

The present disclosure provides a method of providing point cloud content to provide a user with various services such as virtual reality (VR), augmented reality (AR), mixed reality (MR), and self-driving. The point cloud content according to the embodiments represent data representing objects as points, and may be referred to as a point cloud, point cloud data, point cloud video data, point cloud image data, or the like.

A point cloud data transmission device 10000 according to embodiment may include a point cloud video acquirer 10001, a point cloud video encoder 10002, a file/segment encapsulation module 10003, and/or a transmitter (or communication module) 10004. The transmission device according to the embodiments may secure and process point cloud video (or point cloud content) and transmit the same. According to embodiments, the transmission device may include a fixed station, a base transceiver system (BTS), a network, an artificial intelligence (AI) device and/or system, a robot, and an AR/VR/XR device and/or a server. According to embodiments, the transmission device 10000 may include a device robot, a vehicle, AR/VR/XR devices, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The point cloud video acquirer 10001 according to the embodiments acquires a point cloud video through a process of capturing, synthesizing, or generating a point cloud video.

The point cloud video encoder 10002 according to the embodiments encodes the point cloud video data. According to embodiments, the point cloud video encoder 10002 may be referred to as a point cloud encoder, a point cloud data encoder, an encoder, or the like. The point cloud compression coding (encoding) according to the embodiments is not limited to the above-described embodiment. The point cloud video encoder may output a bitstream containing the encoded point cloud video data. The bitstream may not only include encoded point cloud video data, but also include signaling information related to encoding of the point cloud video data.

The encoder according to the embodiments may support both the geometry-based point cloud compression (G-PCC) encoding scheme and/or the video-based point cloud compression (V-PCC) encoding scheme. In addition, the encoder may encode a point cloud (referring to either point cloud data or points) and/or signaling data related to the point cloud. The specific operation of encoding according to embodiments will be described below.

As used herein, the term V-PCC may stand for Video-based Point Cloud Compression (V-PCC). The term V-PCC may be the same as Visual Volumetric Video-based Coding (V3C). These terms may be complementarily used.

The file/segment encapsulation module 10003 according to the embodiments encapsulates the point cloud data in the form of a file and/or segment form. The point cloud data transmission method/device according to the embodiments may transmit the point cloud data in a file and/or segment form.

The transmitter (or communication module) 10004 according to the embodiments transmits the encoded point cloud video data in the form of a bitstream. According to embodiments, the file or segment may be transmitted to a reception device over a network, or stored in a digital storage medium (e.g., USB, SD, CD, DVD, Blu-ray, HDD, SSD, etc.). The transmitter according to the embodiments is capable of wired/wireless communication with the reception device (or the receiver) over a network of 4G, 5G, 6G, etc. In addition, the transmitter may perform necessary data processing operation according to the network system (e.g., a 4G, 5G or 6G communication network system). The transmission device may transmit the encapsulated data in an on-demand manner.

A point cloud data reception device 10005 according to the embodiments may include a receiver 10006, a file/segment decapsulation module 10007, a point cloud video decoder 10008, and/or a renderer 10009. According to embodiments, the reception device may include a device robot, a vehicle, AR/VR/XR devices, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The receiver 10006 according to the embodiments receives a bitstream containing point cloud video data. According to embodiments, the receiver 10006 may transmit feedback information to the point cloud data transmission device 10000.

The file/segment decapsulation module 10007 decapsulates a file and/or a segment containing point cloud data. The decapsulation module according to the embodiments may perform a reverse process of the encapsulation process according to the embodiments.

The point cloud video decoder 10007 decodes the received point cloud video data. The decoder according to the embodiments may perform a reverse process of encoding according to the embodiments.

The renderer 10009 renders the decoded point cloud video data. According to embodiments, the renderer 10009 may transmit the feedback information obtained at the reception side to the point cloud video decoder 10008. The point cloud video data according to the embodiments may carry feedback information to the receiver. According to embodiments, the feedback information received by the point cloud transmission device may be provided to the point cloud video encoder.

The arrows indicated by dotted lines in the drawing represent a transmission path of feedback information acquired by the reception device 10005. The feedback information is information for reflecting interactivity with a user who consumes point cloud content, and includes user information (e.g., head orientation information), viewport information, and the like). In particular, when the point cloud content is content for a service (e.g., self-driving service, etc.) that requires interaction with a user, the feedback information may be provided to the content transmitting side (e.g., the transmission device 10000) and/or the service provider. According to embodiments, the feedback information may be used in the reception device 10005 as well as the transmission device 10000, and may not be provided.

The head orientation information according to embodiments is information about a user's head position, orientation, angle, motion, and the like. The reception device 10005 according to the embodiments may calculate viewport information based on the head orientation information. The viewport information may be information about a region of the point cloud video that the user is viewing. A viewpoint is a point where a user is viewing a point cloud video, and may refer to a center point of the viewport region. That is, the viewport is a region centered on the viewpoint, and the size and shape of the region may be determined by a field of view (FOV). Accordingly, the reception device 10005 may extract the viewport information based on a vertical or horizontal FOV supported by the device in addition to the head orientation information. In addition, the reception device 10005 performs gaze analysis to check how the user consumes a point cloud, a region that the user gazes at in the point cloud video, a gaze time, and the like. According to embodiments, the reception device 10005 may transmit feedback information including the result of the gaze analysis to the transmission device 10000. The feedback information according to the embodiments may be acquired in the rendering and/or display process. The feedback information according to the embodiments may be secured by one or more sensors included in the reception device 10005. In addition according to embodiments, the feedback information may be secured by the renderer 10009 or a separate external element (or device, component, etc.). The dotted lines in FIG. 1 represent a process of transmitting the feedback information secured by the renderer 10009. The point cloud content providing system may process (encode/decode) point cloud data based on the feedback information. Accordingly, the point cloud video data decoder 10008 may perform a decoding operation based on the feedback information. The reception device 10005 may transmit the feedback information to the transmission device. The transmission device (or the point cloud video data encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) all point cloud data, and provide point cloud content to the user.

According to embodiments, the transmission device 10000 may be called an encoder, a transmission device, a transmitter, or the like, and the reception device 10004 may be called a decoder, a reception device, a receiver, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to point cloud data.

The elements of the point cloud content providing system illustrated in FIG. 1 may be implemented by hardware, software, a processor, and/or combinations thereof.

Embodiments may provide a method of providing point cloud content to provide a user with various services such as virtual reality (VR), augmented reality (AR), mixed reality (MR), and self-driving.

In order to provide a point cloud content service, a point cloud video may be acquired first. The acquired point cloud video may be transmitted through a series of processes, and the reception side may process the received data back into the original point cloud video and render the processed point cloud video. Thereby, the point cloud video may be provided to the user. Embodiments provide a method of effectively performing this series of processes.

The entire processes for providing a point cloud content service (the point cloud data transmission method and/or point cloud data reception method) may include an acquisition process, an encoding process, a transmission process, a decoding process, a rendering process, and/or a feedback process.

According to embodiments, the process of providing point cloud content (or point cloud data) may be referred to as a point cloud compression process. According to embodiments, the point cloud compression process may represent a geometry-based point cloud compression process.

Each element of the point cloud data transmission device and the point cloud data reception device according to the embodiments may be hardware, software, a processor, and/or a combination thereof.

In order to provide a point cloud content service, a point cloud video may be acquired. The acquired point cloud video is transmitted through a series of processes, and the reception side may process the received data back into the original point cloud video and render the processed point cloud video. Thereby, the point cloud video may be provided to the user. Embodiments provide a method of effectively performing this series of processes.

The entire processes for providing a point cloud content service may include an acquisition process, an encoding process, a transmission process, a decoding process, a rendering process, and/or a feedback process.

The point cloud compression system may include a transmission device and a reception device. The transmission device may output a bitstream by encoding a point cloud video, and deliver the same to the reception device through a digital storage medium or a network in the form of a file or a stream (streaming segment). The digital storage medium may include various storage media such as a USB, SD, CD, DVD, Blu-ray, HDD, and SSD.

The transmission device may include a point cloud video acquirer, a point cloud video encoder, a file/segment encapsulator, and a transmitter. The reception device may include a receiver, a file/segment decapsulator, a point cloud video decoder, and a renderer. The encoder may be referred to as a point cloud video/picture/picture/frame encoder, and the decoder may be referred to as a point cloud video/picture/picture/frame decoding device. The transmitter may be included in the point cloud video encoder. The receiver may be included in the point cloud video decoder. The renderer may include a display. The renderer and/or the display may be configured as separate devices or external components. The transmission device and the reception device may further include a separate internal or external module/unit/component for the feedback process.

According to embodiments, the operation of the reception device may be the reverse process of the operation of the transmission device.

The point cloud video acquirer may perform the process of acquiring point cloud video through a process of capturing, composing, or generating point cloud video. In the acquisition process, data of 3D positions (x, y, z)/attributes (color, reflectance, transparency, etc.) of multiple points, for example, a polygon file format (PLY) (or the Stanford Triangle format) file may be generated. For a video having multiple frames, one or more files may be acquired. During the capture process, point cloud related metadata (e.g., capture related metadata) may be generated.

A point cloud data transmission device according to embodiments may include an encoder configured to encode point cloud data, and a transmitter configured to transmit the point cloud data. The data may be transmitted in the form of a bitstream containing a point cloud.

A point cloud data reception device according to embodiments may include a receiver configured to receive point cloud data, a decoder configured to decode the point cloud data, and a renderer configured to render the point cloud data.

The method/device according to the embodiments represents the point cloud data transmission device and/or the point cloud data reception device.

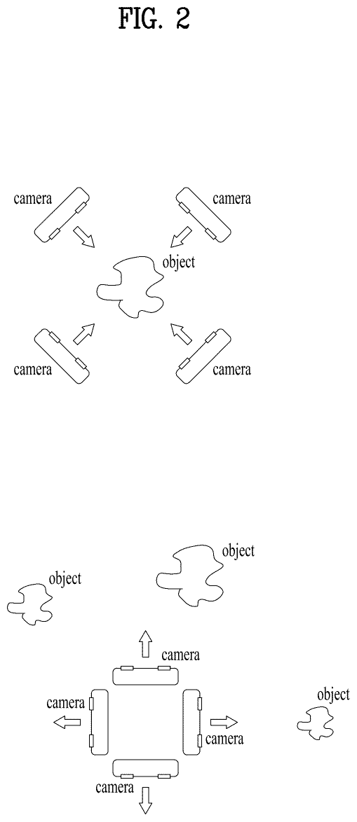

FIG. 2 illustrates capture of point cloud data according to embodiments.

Point cloud data according to embodiments may be acquired by a camera or the like. A capturing technique according to embodiments may include, for example, inward-facing and/or outward-facing.

In the inward-facing according to the embodiments, one or more cameras inwardly facing an object of point cloud data may photograph the object from the outside of the object.

In the outward-facing according to the embodiments, one or more cameras outwardly facing an object of point cloud data may photograph the object. For example according to embodiments, there may be four cameras.

The point cloud data or the point cloud content according to the embodiments may be a video or a still image of an object/environment represented in various types of 3D spaces. According to embodiments, the point cloud content may include video/audio/an image of an object.

For capture of point cloud content, a combination of camera equipment (a combination of an infrared pattern projector and an infrared camera) capable of acquiring depth and RGB cameras capable of extracting color information corresponding to the depth information may be configured. Alternatively, the depth information may be extracted through LiDAR, which uses a radar system that measures the location coordinates of a reflector by emitting a laser pulse and measuring the return time. A shape of the geometry consisting of points in a 3D space may be extracted from the depth information, and an attribute representing the color/reflectance of each point may be extracted from the RGB information. The point cloud content may include information about the positions (x, y, z) and color (YCbCr or RGB) or reflectance (r) of the points. For the point cloud content, the outward-facing technique of capturing an external environment and the inward-facing technique of capturing a central object may be used. In the VR/AR environment, when an object (e.g., a core object such as a character, a player, a thing, or an actor) is configured into point cloud content that may be viewed by the user in any direction (360 degrees), the configuration of the capture camera may be based on the inward-facing technique. When the current surrounding environment is configured into point cloud content in a mode of a vehicle, such as self-driving, the configuration of the capture camera may be based on the outward-facing technique. Because the point cloud content may be captured by multiple cameras, a camera calibration process may need to be performed before the content is captured to configure a global coordinate system for the cameras.

The point cloud content may be a video or still image of an object/environment presented in various types of 3D spaces.

Additionally, in the point cloud content acquisition method, any point cloud video may be composed based on the captured point cloud video. Alternatively, when a point cloud video for a computer-generated virtual space is to be provided, capturing with an actual camera may not be performed. In this case, the capture process may be replaced simply by a process of generating related data.

Post-processing may be needed for the captured point cloud video to improve the quality of the content. In the video capture process, the maximum/minimum depth may be adjusted within a range provided by the camera equipment. Even after the adjustment, point data of an unwanted area may still be present. Accordingly, post-processing of removing the unwanted area (e.g., the background) or recognizing a connected space and filling the spatial holes may be performed. In addition, point clouds extracted from the cameras sharing a spatial coordinate system may be integrated into one piece of content through the process of transforming each point into a global coordinate system based on the coordinates of the location of each camera acquired through a calibration process. Thereby, one piece of point cloud content having a wide range may be generated, or point cloud content with a high density of points may be acquired.

The point cloud video encoder may encode the input point cloud video into one or more video streams. One video may include a plurality of frames, each of which may correspond to a still image/picture. In this specification, a point cloud video may include a point cloud image/frame/picture/video/audio. In addition, the term “point cloud video” may be used interchangeably with a point cloud image/frame/picture. The point cloud video encoder may perform a video-based point cloud compression (V-PCC) procedure. The point cloud video encoder may perform a series of procedures such as prediction, transformation, quantization, and entropy coding for compression and encoding efficiency. The encoded data (encoded video/image information) may be output in the form of a bitstream. Based on the V-PCC procedure, the point cloud video encoder may encode point cloud video by dividing the same into a geometry video, an attribute video, an occupancy map video, and auxiliary information, which will be described later. The geometry video may include a geometry image, the attribute video may include an attribute image, and the occupancy map video may include an occupancy map image. The auxiliary information may include auxiliary patch information. The attribute video/image may include a texture video/image.

The encapsulation processor (file/segment encapsulation module) 1003 may encapsulate the encoded point cloud video data and/or metadata related to the point cloud video in the form of, for example, a file. Here, the metadata related to the point cloud video may be received from the metadata processor. The metadata processor may be included in the point cloud video encoder or may be configured as a separate component/module. The encapsulation processor may encapsulate the data in a file format such as ISOBMFF or process the same in the form of a DASH segment or the like. According to an embodiment, the encapsulation processor may include the point cloud video-related metadata in the file format. The point cloud video metadata may be included, for example, in boxes at various levels on the ISOBMFF file format or as data in a separate track within the file. According to an embodiment, the encapsulation processor may encapsulate the point cloud video-related metadata into a file. The transmission processor may perform processing for transmission on the point cloud video data encapsulated according to the file format. The transmission processor may be included in the transmitter or may be configured as a separate component/module. The transmission processor may process the point cloud video data according to a transmission protocol. The processing for transmission may include processing for delivery over a broadcast network and processing for delivery through a broadband. According to an embodiment, the transmission processor may receive point cloud video-related metadata from the metadata processor along with the point cloud video data, and perform processing of the point cloud video data for transmission.

The transmitter 1004 may transmit the encoded video/image information or data that is output in the form of a bitstream to the receiver of the reception device through a digital storage medium or a network in the form of a file or streaming. The digital storage medium may include various storage media such as USB, SD, CD, DVD, Blu-ray, HDD, and SSD. The transmitter may include an element for generating a media file in a predetermined file format, and may include an element for transmission over a broadcast/communication network. The receiver may extract the bitstream and transmit the extracted bitstream to the decoding device.

The receiver 1003 may receive point cloud video data transmitted by the point cloud video transmission device according to the present disclosure. Depending on the transmission channel, the receiver may receive the point cloud video data over a broadcast network or through a broadband. Alternatively, the point cloud video data may be received through a digital storage medium.

The reception processor may process the received point cloud video data according to the transmission protocol. The reception processor may be included in the receiver or may be configured as a separate component/module. The reception processor may reversely perform the above-described process of the transmission processor such that the processing corresponds to the processing for transmission performed at the transmission side. The reception processor may deliver the acquired point cloud video data to the decapsulation processor, and the acquired point cloud video-related metadata to the metadata parser. The point cloud video-related metadata acquired by the reception processor may take the form of a signaling table.

The decapsulation processor (file/segment decapsulation module) 10007 may decapsulate the point cloud video data received in the form of a file from the reception processor. The decapsulation processor may decapsulate the files according to ISOBMFF or the like, and may acquire a point cloud video bitstream or point cloud video-related metadata (a metadata bitstream). The acquired point cloud video bitstream may be delivered to the point cloud video decoder, and the acquired point cloud video-related metadata (metadata bitstream) may be delivered to the metadata processor. The point cloud video bitstream may include the metadata (metadata bitstream). The metadata processor may be included in the point cloud video decoder or may be configured as a separate component/module. The point cloud video-related metadata acquired by the decapsulation processor may take the form of a box or a track in the file format. The decapsulation processor may receive metadata necessary for decapsulation from the metadata processor, when necessary. The point cloud video-related metadata may be delivered to the point cloud video decoder and used in a point cloud video decoding procedure, or may be transferred to the renderer and used in a point cloud video rendering procedure.

The point cloud video decoder may receive the bitstream and decode the video/image by performing an operation corresponding to the operation of the point cloud video encoder. In this case, the point cloud video decoder may decode the point cloud video by dividing the same into a geometry video, an attribute video, an occupancy map video, and auxiliary information as described below. The geometry video may include a geometry image, and the attribute video may include an attribute image. The occupancy map video may include an occupancy map image. The auxiliary information may include auxiliary patch information. The attribute video/image may include a texture video/image.

The 3D geometry may be reconstructed based on the decoded geometry image, the occupancy map, and auxiliary patch information, and then may be subjected to a smoothing process. A color point cloud image/picture may be reconstructed by assigning color values to the smoothed 3D geometry based on the texture image. The renderer may render the reconstructed geometry and the color point cloud image/picture. The rendered video/image may be displayed through the display. The user may view all or part of the rendered result through a VR/AR display or a typical display.

The feedback process may include transferring various kinds of feedback information that may be acquired in the rendering/displaying process to the transmission side or to the decoder of the reception side. Interactivity may be provided through the feedback process in consuming point cloud video. According to an embodiment, head orientation information, viewport information indicating a region currently viewed by a user, and the like may be delivered to the transmission side in the feedback process. According to an embodiment, the user may interact with things implemented in the VR/AR/MR/self-driving environment. In this case, information related to the interaction may be delivered to the transmission side or a service provider during the feedback process. According to an embodiment, the feedback process may be skipped.

The head orientation information may represent information about the location, angle and motion of a user's head. On the basis of this information, information about a region of the point cloud video currently viewed by the user, that is, viewport information may be calculated.

The viewport information may be information about a region of the point cloud video currently viewed by the user. Gaze analysis may be performed using the viewport information to check the way the user consumes the point cloud video, a region of the point cloud video at which the user gazes, and how long the user gazes at the region. The gaze analysis may be performed at the reception side and the result of the analysis may be delivered to the transmission side on a feedback channel. A device such as a VR/AR/MR display may extract a viewport region based on the location/direction of the user's head, vertical or horizontal FOV supported by the device, and the like.

According to an embodiment, the aforementioned feedback information may not only be delivered to the transmission side, but also be consumed at the reception side. That is, decoding and rendering processes at the reception side may be performed based on the aforementioned feedback information. For example, only the point cloud video for the region currently viewed by the user may be preferentially decoded and rendered based on the head orientation information and/or the viewport information.

Here, the viewport or viewport region may represent a region of the point cloud video currently viewed by the user. A viewpoint is a point which is viewed by the user in the point cloud video and may represent a center point of the viewport region. That is, a viewport is a region around a viewpoint, and the size and form of the region may be determined by the field of view (FOV).

The present disclosure relates to point cloud video compression as described above. For example, the methods/embodiments disclosed in the present disclosure may be applied to the point cloud compression or point cloud coding (PCC) standard of the moving picture experts group (MPEG) or the next generation video/image coding standard.

As used herein, a picture/frame may generally represent a unit representing one image in a specific time interval.

A pixel or a pel may be the smallest unit constituting one picture (or image). Also, “sample” may be used as a term corresponding to a pixel. A sample may generally represent a pixel or a pixel value. It may represent only a pixel/pixel value of a luma component, only a pixel/pixel value of a chroma component, or only a pixel/pixel value of a depth component.

A unit may represent a basic unit of image processing. The unit may include at least one of a specific region of the picture and information related to the region. The unit may be used interchangeably with term such as block or area in some cases. In a general case, an M×N block may include samples (or a sample array) or a set (or array) of transform coefficients configured in M columns and N rows.

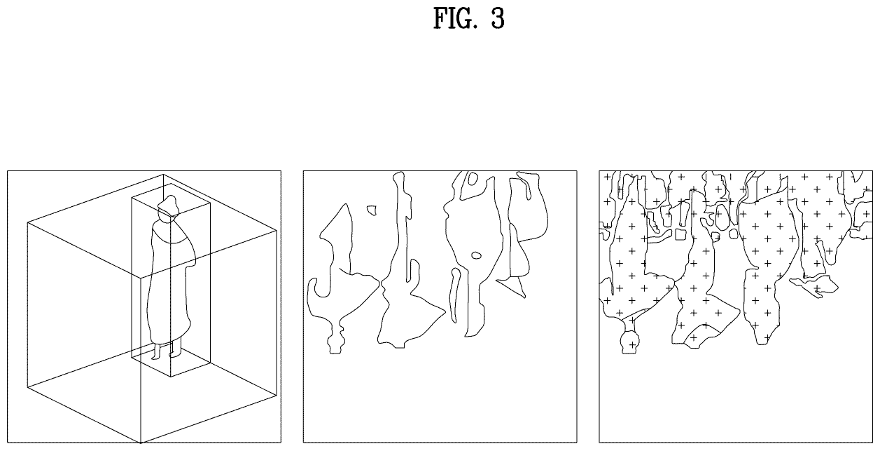

FIG. 3 illustrates an example of a point cloud, a geometry image, and a texture image according to embodiments.

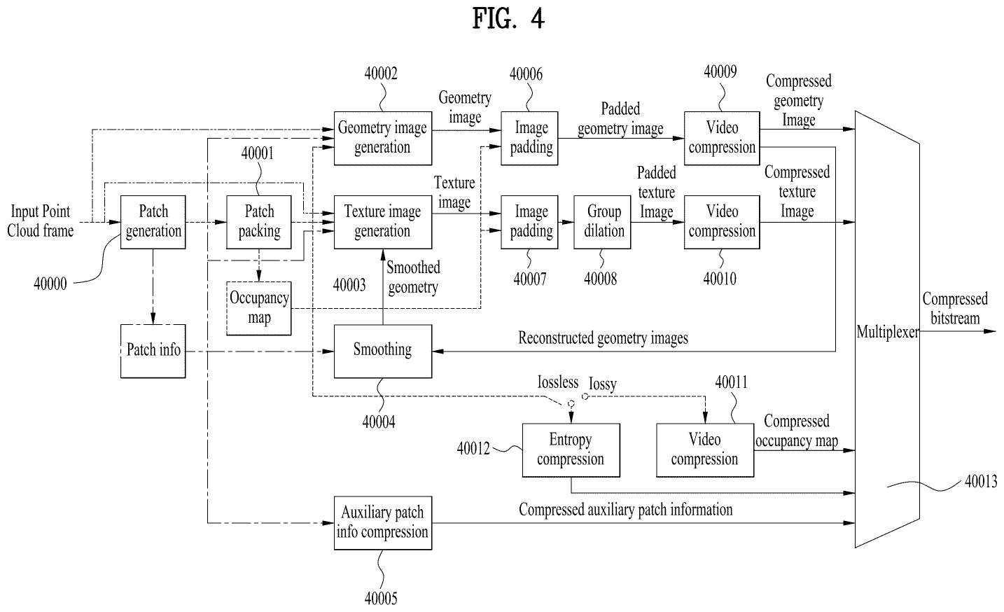

A point cloud according to the embodiments may be input to the V-PCC encoding process of FIG. 4, which will be described later, to generate a geometric image and a texture image. According to embodiments, a point cloud may have the same meaning as point cloud data.

As shown in the figure, the left part shows a point cloud, in which an object is positioned in a 3D space and may be represented by a bounding box or the like. The middle part shows the geometry, and the right part shows a texture image (non-padded image).

Video-based point cloud compression (V-PCC) according to embodiments may provide a method of compressing 3D point cloud data based on a 2D video codec such as HEVC or VVC. Data and information that may be generated in the V-PCC compression process are as follows:

Occupancy map: this is a binary map indicating whether there is data at a corresponding position in a 2D plane, using a value of 0 or 1 in dividing the points constituting a point cloud into patches and mapping the same to the 2D plane. The occupancy map may represent a 2D array corresponding to ATLAS, and the values of the occupancy map may indicate whether each sample position in the atlas corresponds to a 3D point.

An atlas is a collection of 2D bounding boxes positioned in a rectangular frame that correspond to a 3D bounding box in a 3D space in which volumetric data is rendered and information related thereto.

The atlas bitstream is a bitstream for one or more atlas frames constituting an atlas and related data.

The atlas frame is a 2D rectangular array of atlas samples onto which patches are projected.

An atlas sample is a position of a rectangular frame onto which patches associated with the atlas are projected.

An atlas frame may be partitioned into tiles. A tile is a unit in which a 2D frame is partitioned. That is, a tile is a unit for partitioning signaling information of point cloud data called an atlas.

Patch: A set of points constituting a point cloud, which indicates that points belonging to the same patch are adjacent to each other in 3D space and are mapped in the same direction among 6-face bounding box planes in the process of mapping to a 2D image.

Geometry image: this is an image in the form of a depth map that presents position information (geometry) about each point constituting a point cloud on a patch-by-patch basis. The geometry image may be composed of pixel values of one channel. Geometry represents a set of coordinates associated with a point cloud frame.

Texture image: this is an image representing the color information about each point constituting a point cloud on a patch-by-patch basis. A texture image may be composed of pixel values of a plurality of channels (e.g., three channels of R, G, and B). The texture is included in an attribute. According to embodiments, a texture and/or attribute may be interpreted as the same object and/or having an inclusive relationship.

Auxiliary patch info: this indicates metadata needed to reconstruct a point cloud with individual patches. Auxiliary patch info may include information about the position, size, and the like of a patch in a 2D/3D space.

Point cloud data according to the embodiments, for example, V-PCC components may include an atlas, an occupancy map, geometry, and attributes.

Atlas represents a set of 2D bounding boxes. It may be patches, for example, patches projected onto a rectangular frame. Atlas may correspond to a 3D bounding box in a 3D space, and may represent a subset of a point cloud.

An attribute may represent a scalar or vector associated with each point in the point cloud. For example, the attributes may include color, reflectance, surface normal, time stamps, material ID.

The point cloud data according to the embodiments represents PCC data according to video-based point cloud compression (V-PCC) scheme. The point cloud data may include a plurality of components. For example, it may include an occupancy map, a patch, geometry and/or texture.

FIG. 4 illustrates a V-PCC encoding process according to embodiments.

The figure illustrates a V-PCC encoding process for generating and compressing an occupancy map, a geometry image, a texture image, and auxiliary patch information. The V-PCC encoding process of FIG. 4 may be processed by the point cloud video encoder 10002 of FIG. 1. Each element of FIG. 4 may be performed by software, hardware, processor and/or a combination thereof.

The patch generation or patch generator 40000 receives a point cloud frame (which may be in the form of a bitstream containing point cloud data). The patch generator 40000 generates a patch from the point cloud data. In addition, patch information including information about patch generation is generated.

The patch packing or patch packer 40001 packs patches for point cloud data. For example, one or more patches may be packed. In addition, the patch packer generates an occupancy map containing information about patch packing.

The geometry image generation or geometry image generator 40002 generates a geometry image based on the point cloud data, patches, and/or packed patches. The geometry image refers to data containing geometry related to the point cloud data.

The texture image generation or texture image generator 40003 generates a texture image based on the point cloud data, patches, and/or packed patches. In addition, the texture image may be generated further based on smoothed geometry generated by smoothing processing of smoothing based on the patch information.

The smoothing or smoother 40004 may mitigate or eliminate errors contained in the image data. For example, based on the patched reconstructed geometry image, portions that may cause errors between data may be smoothly filtered out to generate smoothed geometry.

The auxiliary patch info compression or auxiliary patch info compressor 40005, auxiliary patch information related to the patch information generated in the patch generation is compressed. In addition, the compressed auxiliary patch information may be transmitted to the multiplexer. The auxiliary patch information may be used in the geometry image generation 40002.

The image padding or image padder 40006, 40007 may pad the geometry image and the texture image, respectively. The padding data may be padded to the geometry image and the texture image.

The group dilation or group dilator 40008 may add data to the texture image in a similar manner to image padding. The added data may be inserted into the texture image.

The video compression or video compressor 40009, 40010, 40011 may compress the padded geometry image, the padded texture image, and/or the occupancy map, respectively. The compression may encode geometry information, texture information, occupancy information, and the like.

The entropy compression or entropy compressor 40012 may compress (e.g., encode) the occupancy map based on an entropy scheme.

According to embodiments, the entropy compression and/or video compression may be performed, respectively depending on whether the point cloud data is lossless and/or lossy.

The multiplexer 40013 multiplexes the compressed geometry image, the compressed texture image, and the compressed occupancy map into a bitstream.

The specific operations in the respective processes of FIG. 4 are described below.

### Patch Generation 40000

The patch generation process refers to a process of dividing a point cloud into patches, which are mapping units, in order to map the point cloud to the 2D image. The patch generation process may be divided into three steps: normal value calculation, segmentation, and patch segmentation.

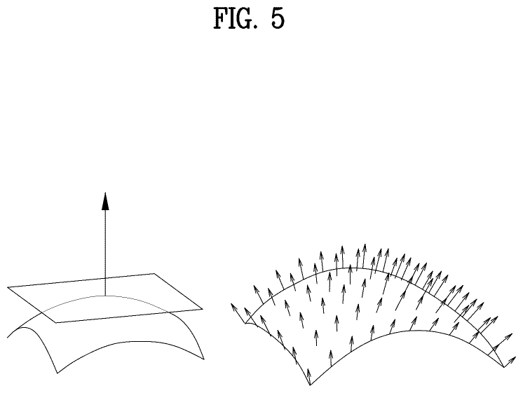

The normal value calculation process will be described in detail with reference to FIG. 5.

FIG. 5 illustrates an example of a tangent plane and a normal vector of a surface according to embodiments.

The surface of FIG. 5 is used in the patch generation process 40000 of the V-PCC encoding process of FIG. 4 as follows.

### Normal Calculation Related to Patch Generation:

Each point of a point cloud has its own direction, which is represented by a 3D vector called a normal vector. Using the neighbors of each point obtained using a K-D tree or the like, a tangent plane and a normal vector of each point constituting the surface of the point cloud as shown in the figure may be obtained. The search range applied to the process of searching for neighbors may be defined by the user.

The tangent plane refers to a plane that passes through a point on the surface and completely includes a tangent line to the curve on the surface.

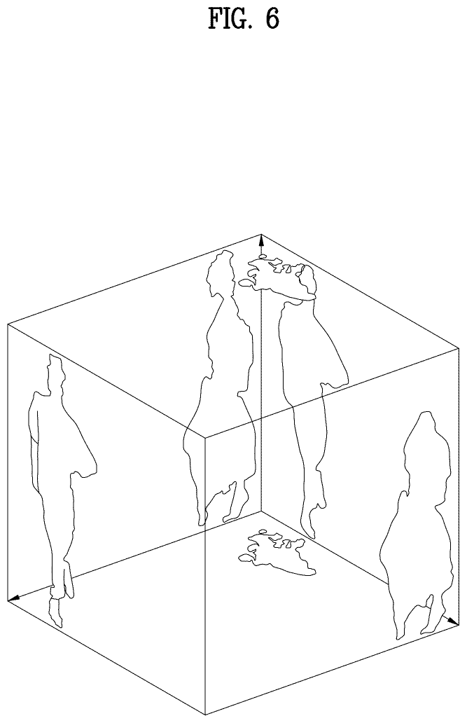

FIG. 6 illustrates an exemplary bounding box of a point cloud according to embodiments.

A method/device according to embodiments, for example, patch generation, may employ a bounding box in generating a patch from point cloud data.

The bounding box according to the embodiments refers to a box of a unit for dividing point cloud data based on a hexahedron in a 3D space.

The bounding box may be used in the process of projecting a target object of the point cloud data onto a plane of each planar face of a hexahedron in a 3D space. The bounding box may be generated and processed by the point cloud video acquirer 10000 and the point cloud video encoder 10002 of FIG. 1. Further, based on the bounding box, the patch generation 40000, patch packing 40001, geometry image generation 40002, and texture image generation 40003 of the V-PCC encoding process of FIG. 2 may be performed.

### Segmentation Related to Patch Generation

Segmentation is divided into two processes: initial segmentation and refine segmentation.

The point cloud encoder 10002 according to the embodiments projects a point onto one face of a bounding box. Specifically, each point constituting a point cloud is projected onto one of the six faces of a bounding box surrounding the point cloud as shown in the figure. Initial segmentation is a process of determining one of the planar faces of the bounding box onto which each point is to be projected.

\vec{n}ₚ_{ᵢ}, which is a normal value corresponding to each of the six planar faces, is defined as follows:
(1.0, 0.0, 0.0), (0.0, 1.0, 0.0), (0.0, 0.0, 1.0), (−1.0, 0.0, 0.0), (0.0, −1.0, 0.0), (0.0, 0.0, −1.0).

As shown in the equation below, a face that yields the maximum value of dot product of the normal vector \vec{n}ₚ_{ᵢ} of each point, which is obtained in the normal value calculation process, and \vec{n}ₚ_{_{idx}} is determined as a projection plane of the corresponding point. That is, a plane whose normal vector is most similar to the direction of the normal vector of a point is determined as the projection plane of the point.

$${max}_{{p}_{idx}} \{ {\vec{n}}_{{p}_{i}} \cdot {\vec{n}}_{{p}_{idx}} \}$$

The determined plane may be identified by one cluster index, which is one of 0 to 5.

Refine segmentation is a process of enhancing the projection plane of each point constituting the point cloud determined in the initial segmentation process in consideration of the projection planes of neighboring points. In this process, a score normal, which represents the degree of similarity between the normal vector of each point and the normal of each planar face of the bounding box which are considered in determining the projection plane in the initial segmentation process, and score smooth, which indicates the degree of similarity between the projection plane of the current point and the projection planes of neighboring points, may be considered together.

Score smooth may be considered by assigning a weight to the score normal. In this case, the weight value may be defined by the user. The refine segmentation may be performed repeatedly, and the number of repetitions may also be defined by the user.

### Patch Segmentation Related to Patch Generation

Patch segmentation is a process of dividing the entire point cloud into patches, which are sets of neighboring points, based on the projection plane information about each point constituting the point cloud obtained in the initial/refine segmentation process. The patch segmentation may include the following steps:
1) Calculate neighboring points of each point constituting the point cloud, using the K-D tree or the like. The maximum number of neighbors may be defined by the user;
2) When the neighboring points are projected onto the same plane as the current point (when they have the same cluster index), extract the current point and the neighboring points as one patch;
3) Calculate geometry values of the extracted patch. The details are described below; and
4) Repeat operations 2) to 4) until there is no unextracted point.

The occupancy map, geometry image and texture image for each patch as well as the size of each patch are determined through the patch segmentation process.

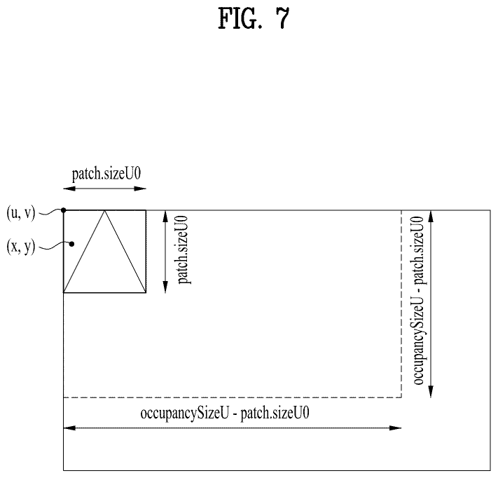

FIG. 7 illustrates an example of determination of individual patch positions on an occupancy map according to embodiments.

The point cloud encoder 10002 according to the embodiments may perform patch packing and generate an occupancy map.

### Patch Packing & Occupancy Map Generation (40001)

This is a process of determining the positions of individual patches in a 2D image to map the segmented patches to the 2D image. The occupancy map, which is a kind of 2D image, is a binary map that indicates whether there is data at a corresponding position, using a value of 0 or 1. The occupancy map is composed of blocks and the resolution thereof may be determined by the size of the block. For example, when the block is 1*1 block, a pixel-level resolution is obtained. The occupancy packing block size may be determined by the user.

The process of determining the positions of individual patches on the occupancy map may be configured as follows:
1) Set all positions on the occupancy map to 0;
2) Place a patch at a point (u, v) having a horizontal coordinate within the range of (0, occupancySizeU−patch.sizeU0) and a vertical coordinate within the range of (0, occupancySizeV−patch.sizeV0) in the occupancy map plane;
3) Set a point (x, y) having a horizontal coordinate within the range of (0, patch.sizeU0) and a vertical coordinate within the range of (0, patch.sizeV0) in the patch plane as a current point;
4) Change the position of point (x, y) in raster order and repeat operations 3) and 4) if the value of coordinate (x, y) on the patch occupancy map is 1 (there is data at the point in the patch) and the value of coordinate (u+x, v+y) on the global occupancy map is 1 (the occupancy map is filled with the previous patch). Otherwise, proceed to operation 6);
5) Change the position of (u, v) in raster order and repeat operations 3) to 5);
6) Determine (u, v) as the position of the patch and copy the occupancy map data about the patch onto the corresponding portion on the global occupancy map; and
7) Repeat operations 2) to 7) for the next patch.
occupancySizeU: indicates the width of the occupancy map. The unit thereof is occupancy packing block size.
occupancySizeV: indicates the height of the occupancy map. The unit thereof is occupancy packing block size.
patch.sizeU0: indicates the width of the occupancy map. The unit thereof is occupancy packing block size.
patch.sizeV0: indicates the height of the occupancy map. The unit thereof is occupancy packing block size.

For example, as shown in FIG. 7, there is a box corresponding to a patch having a patch size in a box corresponding to an occupancy packing size block, and a point (x, y) may be located in the box.

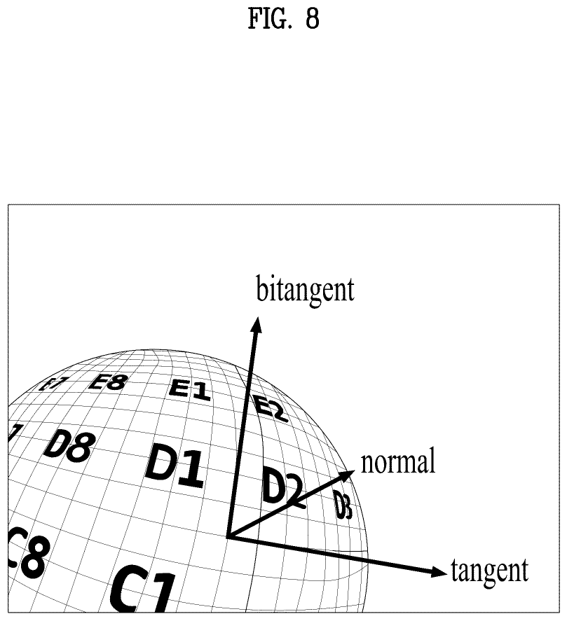

FIG. 8 shows an exemplary relationship among normal, tangent, and bitangent axes according to embodiments.

The point cloud encoder 10002 according to embodiments may generate a geometry image. The geometry image refers to image data including geometry information about a point cloud. The geometry image generation process may employ three axes (normal, tangent, and bitangent) of a patch in FIG. 8.

### Geometry Image Generation (40002)

In this process, the depth values constituting the geometry images of individual patches are determined, and the entire geometry image is generated based on the positions of the patches determined in the patch packing process described above. The process of determining the depth values constituting the geometry images of individual patches may be configured as follows.
1) Calculate parameters related to the position and size of an individual patch. The parameters may include the following information.

A normal index indicating the normal axis is obtained in the previous patch generation process. The tangent axis is an axis coincident with the horizontal axis u of the patch image among the axes perpendicular to the normal axis, and the bitangent axis is an axis coincident with the vertical axis v of the patch image among the axes perpendicular to the normal axis. The three axes may be expressed as shown in the figure.

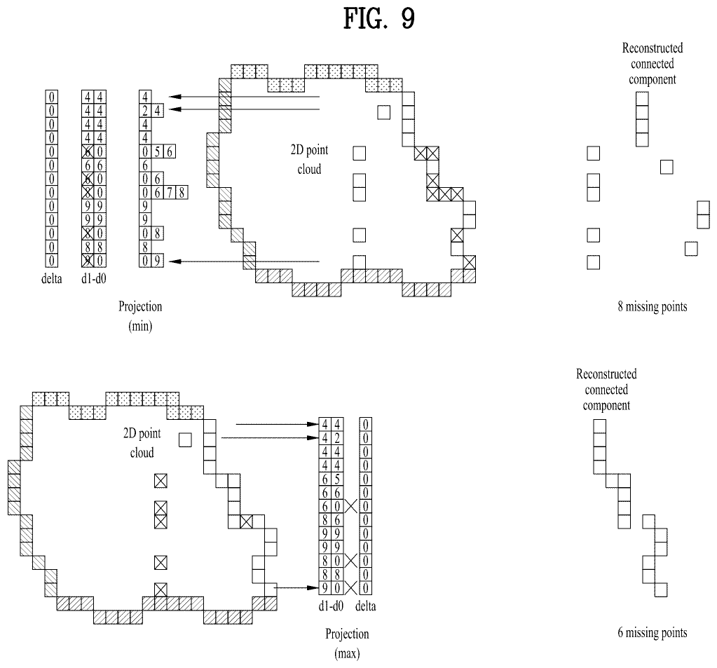

FIG. 9 shows an exemplary configuration of the minimum mode and maximum mode of a projection mode according to embodiments.

The point cloud encoder 10002 according to embodiments may perform patch-based projection to generate a geometry image, and the projection mode according to the embodiments includes a minimum mode and a maximum mode.

3D spatial coordinates of a patch may be calculated based on the bounding box of the minimum size surrounding the patch. For example, the 3D spatial coordinates may include the minimum tangent value of the patch (on the patch 3d shift tangent axis) of the patch, the minimum bitangent value of the patch (on the patch 3d shift bitangent axis), and the minimum normal value of the patch (on the patch 3d shift normal axis).

2D size of a patch indicates the horizontal and vertical sizes of the patch when the patch is packed into a 2D image. The horizontal size (patch 2d size u) may be obtained as a difference between the maximum and minimum tangent values of the bounding box, and the vertical size (patch 2d size v) may be obtained as a difference between the maximum and minimum bitangent values of the bounding box.
2) Determine a projection mode of the patch. The projection mode may be either the min mode or the max mode. The geometry information about the patch is expressed with a depth value. When each point constituting the patch is projected in the normal direction of the patch, two layers of images, an image constructed with the maximum depth value and an image constructed with the minimum depth value, may be generated.

In the min mode, in generating the two layers of images d0 and d1, the minimum depth may be configured for d0, and the maximum depth within the surface thickness from the minimum depth may be configured for d1, as shown in the figure.

For example, when a point cloud is located in 2D as illustrated in the figure, there may be a plurality of patches including a plurality of points. As shown in the figure, it is indicated that points marked with the same style of shadow may belong to the same patch. The figure illustrates the process of projecting a patch of points marked with blanks.

When projecting points marked with blanks to the left/right, the depth may be incremented by 1 as 0, 1, 2, . . . , 6, 7, 8, 9 with respect to the left side, and the number for calculating the depths of the points may be marked on the right side.

The same projection mode may be applied to all point clouds or different projection modes may be applied to respective frames or patches according to user definition. When different projection modes are applied to the respective frames or patches, a projection mode that may enhance compression efficiency or minimize missed points may be adaptively selected.
3) Calculate the depth values of the individual points.

In the min mode, image d0 is constructed with depth0, which is a value obtained by subtracting the minimum normal value of the patch (on the patch 3d shift normal axis) calculated in operation 1) from the minimum normal value of the patch (on the patch 3d shift normal axis) for the minimum normal value of each point. If there is another depth value within the range between depth0 and the surface thickness at the same position, this value is set to depth1. Otherwise, the value of depth0 is assigned to depth1. Image d1 is constructed with the value of depth1.

For example, a minimum value may be calculated in determining the depth of points of image d0 (4 2 4 4 0 6 0 0 9 9 0 8 0). In determining the depth of points of image d1, a greater value among two or more points may be calculated. When only one point is present, the value thereof may be calculated (4 4 4 4 6 6 6 8 9 9 8 8 9). In the process of encoding and reconstructing the points of the patch, some points may be lost (For example, in the figure, eight points are lost).

In the max mode, image d0 is constructed with depth0, which is a value obtained by subtracting the minimum normal value of the patch (on the patch 3d shift normal axis) calculated in operation 1) from the minimum normal value of the patch (on the patch 3d shift normal axis) for the maximum normal value of each point. If there is another depth value within the range between depth0 and the surface thickness at the same position, this value is set to depth1. Otherwise, the value of depth0 is assigned to depth1. Image d1 is constructed with the value of depth1.

For example, a maximum value may be calculated in determining the depth of points of d0 (4 4 4 4 6 6 6 8 9 9 8 8 9). In addition, in determining the depth of points of d1, a lower value among two or more points may be calculated. When only one point is present, the value thereof may be calculated (4 2 4 4 5 6 0 6 9 9 0 8 0). In the process of encoding and reconstructing the points of the patch, some points may be lost (For example, in the figure, six points are lost).

The entire geometry image may be generated by placing the geometry images of the individual patches generated through the above-described processes onto the entire geometry image based on the patch position information determined in the patch packing process.

Layer d1 of the generated entire geometry image may be encoded using various methods. A first method (absolute d1 method) is to encode the depth values of the previously generated image d1. A second method (differential method) is to encode a difference between the depth values of previously generated image d1 and the depth values of image d0.

In the encoding method using the depth values of the two layers, d0 and d1 as described above, if there is another point between the two depths, the geometry information about the point is lost in the encoding process, and therefore an enhanced-delta-depth (EDD) code may be used for lossless coding.

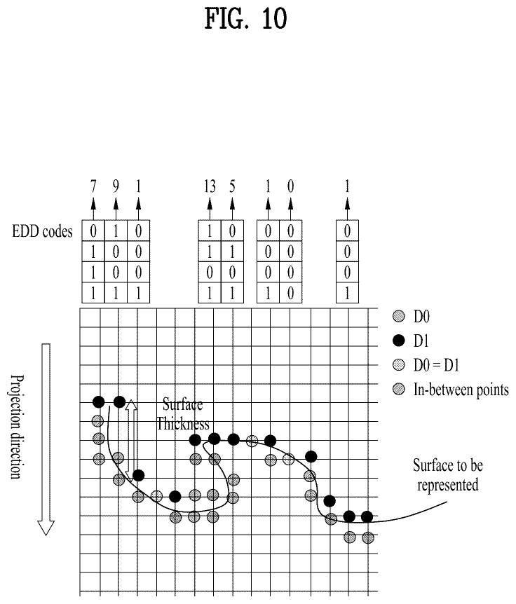

Hereinafter, the EDD code will be described in detail with reference to FIG. 10.

FIG. 10 illustrates an exemplary EDD code according to embodiments.

In some/all processes of the point cloud encoder 10002 and/or V-PCC encoding (e.g., video compression 40009), the geometry information about points may be encoded based on the EOD code.

As shown in the figure, the EDD code is used for binary encoding of the positions of all points within the range of surface thickness including d1. For example, in the figure, the points included in the second left column may be represented by an EDD code of 0b1001 (=9) because the points are present at the first and fourth positions over DO and the second and third positions are empty. When the EDD code is encoded together with DO and transmitted, a reception terminal may restore the geometry information about all points without loss.

For example, when there is a point present above a reference point, the value is 1. When there is no point, the value is 0. Thus, the code may be expressed based on 4 bits.

### Smoothing (40004)

Smoothing is an operation for eliminating discontinuity that may occur on the patch boundary due to deterioration of the image quality occurring during the compression process. Smoothing may be performed by the point cloud encoder or smoother:
1) Reconstruct the point cloud from the geometry image. This operation may be the reverse of the geometry image generation described above. For example, the reverse process of encoding may be reconstructed;
2) Calculate neighboring points of each point constituting the reconstructed point cloud using the K-D tree or the like;
3) Determine whether each of the points is positioned on the patch boundary. For example, when there is a neighboring point having a different projection plane (cluster index) from the current point, it may be determined that the point is positioned on the patch boundary;
4) If there is a point present on the patch boundary, move the point to the center of mass of the neighboring points (positioned at the average x, y, z coordinates of the neighboring points). That is, change the geometry value. Otherwise, maintain the previous geometry value.

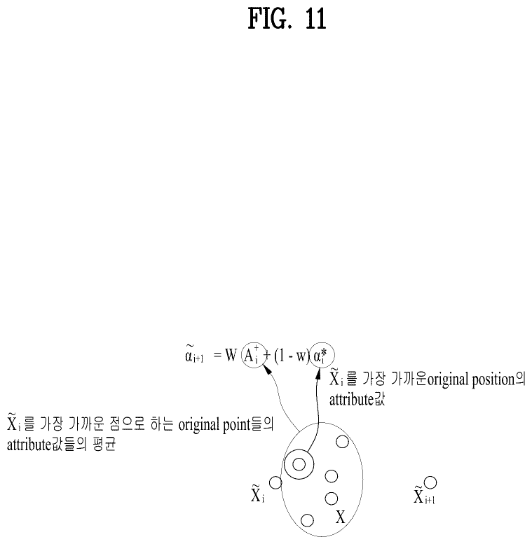

FIG. 11 illustrates an example of recoloring based on color values of neighboring points according to embodiments.

The point cloud encoder or the texture image generator 40003 according to the embodiments may generate a texture image based on recoloring.

### Texture Image Generation (40003)

The texture image generation process, which is similar to the geometry image generation process described above, includes generating texture images of individual patches and generating an entire texture image by arranging the texture images at determined positions. However, in the operation of generating texture images of individual patches, an image with color values (e.g., R, G, and B values) of the points constituting a point cloud corresponding to a position is generated in place of the depth values for geometry generation.

In estimating a color value of each point constituting the point cloud, the geometry previously obtained through the smoothing process may be used. In the smoothed point cloud, the positions of some points may have been shifted from the original point cloud, and accordingly a recoloring process of finding colors suitable for the changed positions may be required. Recoloring may be performed using the color values of neighboring points. For example, as shown in the figure, a new color value may be calculated in consideration of the color value of the nearest neighboring point and the color values of the neighboring points.

For example, referring to the figure, in the recoloring, a suitable color value for a changed position may be calculated based on the average of the attribute information about the closest original points to a point and/or the average of the attribute information about the closest original positions to the point.

Texture images may also be generated in two layers of t0 and t1, like the geometry images, which are generated in two layers of d0 and d1.

### Auxiliary Patch Info Compression (40005)

The point cloud encoder or the auxiliary patch info compressor according to the embodiments may compress the auxiliary patch information (auxiliary information about the point cloud).

The auxiliary patch info compressor compresses the auxiliary patch information generated in the operations of patch generation, patch packing, and geometry generation described above. The auxiliary patch information may include the following parameters:
Index (cluster index) for identifying the projection plane (normal plane);
3D spatial position of a patch, i.e., the minimum tangent value of the patch (on the patch 3d shift tangent axis), the minimum bitangent value of the patch (on the patch 3d shift bitangent axis), and the minimum normal value of the patch (on the patch 3d shift normal axis);
2D spatial position and size of the patch, i.e., the horizontal size (patch 2d size u), the vertical size (patch 2d size v), the minimum horizontal value (patch 2d shift u), and the minimum vertical value (patch 2d shift u); and
Mapping information about each block and patch, i.e., a candidate index (when patches are disposed in order based on the 2D spatial position and size information about the patches, multiple patches may be mapped to one block in an overlapping manner. In this case, the mapped patches constitute a candidate list, and the candidate index indicates the position in sequential order of a patch whose data is present in the block), and a local patch index (which is an index indicating one of the patches present in the frame). Table X shows a pseudo code representing the process of matching between blocks and patches based on the candidate list and the local patch indexes.

The maximum number of candidate lists may be defined by a user.

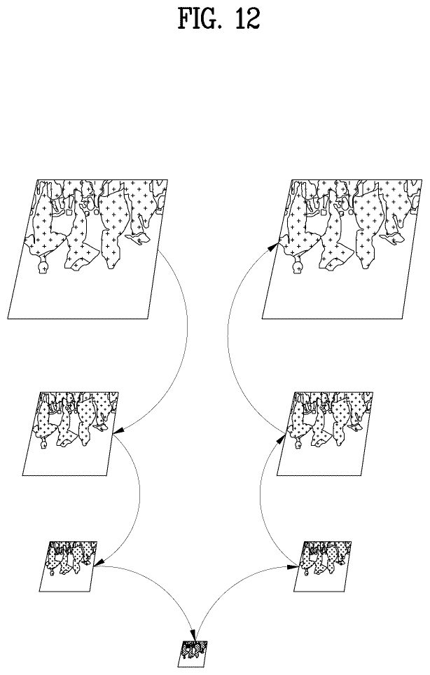

```
  for(i=0; i<BlockCount; i++) {
  if(candidatePatches[i].size( ) == 1) {
  blockToPatch[i] = candidatePatches[i][0] } else {
  candidate_index if(candidate_index == max_candidate_count)
{ blockToPatch[i] = local_patch_index } else { blockToPatch[i] =
candidatePatches[i][candidate_index } } FIG. 12 illustrates push-pull
background filling according to embodiments. Image padding and
group dilation (40006, 40007, 40008)
```

The image padder according to the embodiments may fill the space except the patch area with meaningless supplemental data based on the push-pull background filling technique.

Image padding is a process of filling the space other than the patch region with meaningless data to improve compression efficiency. For image padding, pixel values in columns or rows close to a boundary in the patch may be copied to fill the empty space. Alternatively, as shown in the figure, a push-pull background filling method may be used. According to this method, the empty space is filled with pixel values from a low resolution image in the process of gradually reducing the resolution of a non-padded image and increasing the resolution again.

Group dilation is a process of filling the empty spaces of a geometry image and a texture image configured in two layers, d0/d1 and t0/t0, respectively. In this process, the empty spaces of the two layers calculated through image padding are filled with the average of the values for the same position.

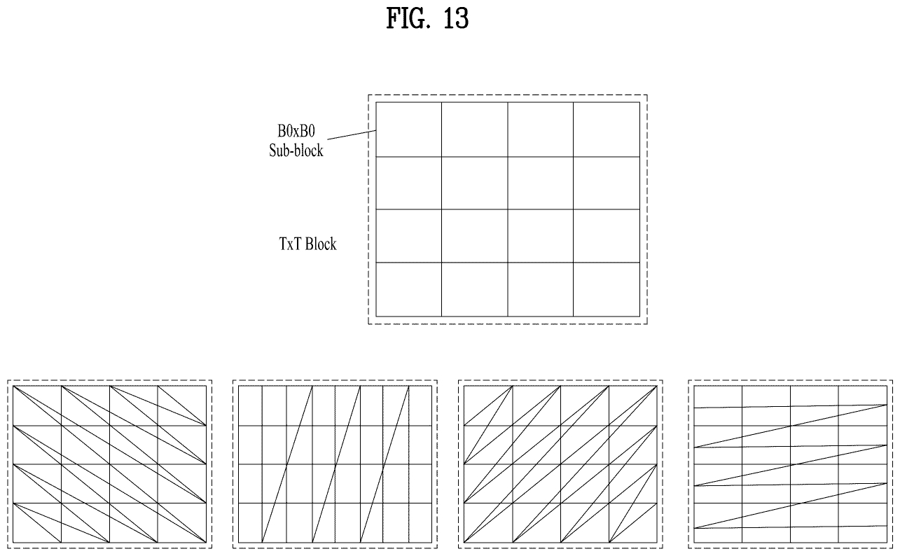

FIG. 13 shows an exemplary possible traversal order for a 4*4 block according to embodiments.

### Occupancy Map Compression (40012, 40011)

The occupancy map compressor according to the embodiments may compress the previously generated occupancy map. Specifically, two methods, namely video compression for lossy compression and entropy compression for lossless compression, may be used. Video compression is described below.

The entropy compression may be performed through the following operations.
1) If a block constituting an occupancy map is fully occupied, encode 1 and repeat the same operation for the next block of the occupancy map. Otherwise, encode 0 and perform operations 2) to 5).
2) Determine the best traversal order to perform run-length coding on the occupied pixels of the block. The figure shows four possible traversal orders for a 4*4 block.

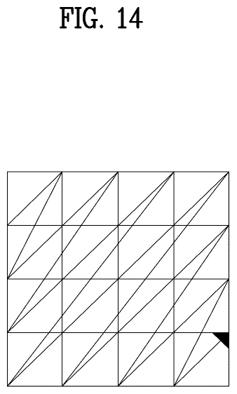

FIG. 14 illustrates an exemplary best traversal order according to embodiments.

As described above, the entropy compressor according to the embodiments may code (encode) a block based on the traversal order scheme as described above.

For example, the best traversal order with the minimum number of runs is selected from among the possible traversal orders and the index thereof is encoded. The figure illustrates a case where the third traversal order in FIG. 13 is selected. In the illustrated case, the number of runs may be minimized to 2, and therefore the third traversal order may be selected as the best traversal order.
3) Encode the number of runs. In the example of FIG. 14, there are two runs, and therefore 2 is encoded.
4) Encode the occupancy of the first run. In the example of FIG. 14, 0 is encoded because the first run corresponds to unoccupied pixels.
5) Encode lengths of the individual runs (as many as the number of runs). In the example of FIG. 14, the lengths of the first run and the second run, 6 and 10, are sequentially encoded.

### Video Compression (40009, 40010, 40011)

The video compressor according to the embodiments encodes a sequence of a geometry image, a texture image, an occupancy map image, and the like generated in the above-described operations, using a 2D video codec such as HEVC or VVC.

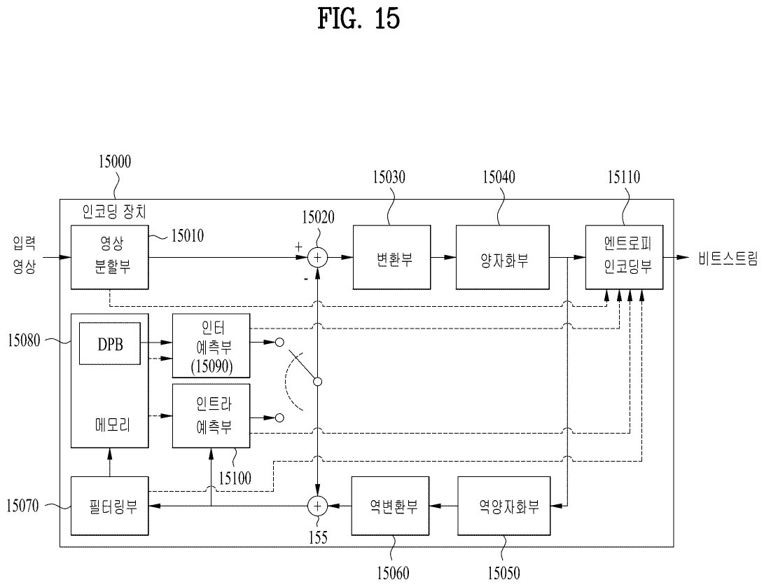

FIG. 15 illustrates an exemplary 2D video/image encoder according to embodiments.

The figure, which represents an embodiment to which the video compression or video compressor 40009, 40010, and 40011 described above is applied, is a schematic block diagram of a 2D video/image encoder 15000 configured to encode a video/image signal. The 2D video/image encoder 15000 may be included in the point cloud video encoder described above or may be configured as an internal/external component. Each component of FIG. 15 may correspond to software, hardware, processor and/or a combination thereof.

Here, the input image may include the geometry image, the texture image (attribute(s) image), and the occupancy map image described above. The output bitstream (i.e., the point cloud video/image bitstream) of the point cloud video encoder may include output bitstreams for the respective input images (i.e., the geometry image, the texture image (attribute(s) image), the occupancy map image, etc.).

An inter-predictor 15090 and an intra-predictor 15100 may be collectively called a predictor. That is, the predictor may include the inter-predictor 15090 and the intra-predictor 15100. A transformer 15030, a quantizer 15040, an inverse quantizer 15050, and an inverse transformer 15060 may be included in the residual processor. The residual processor may further include a subtractor 15020. According to an embodiment, the image splitter 15010, the subtractor 15020, the transformer 15030, the quantizer 15040, the inverse quantizer 15050, the inverse transformer 15060, the adder 155, the filter 15070, the inter-predictor 15090, the intra-predictor 15100, and the entropy encoder 15110 described above may be configured by one hardware component (e.g., an encoder or a processor). In addition, the memory 15080 may include a decoded picture buffer (DPB) and may be configured by a digital storage medium.

The image splitter 15010 may spit an image (or a picture or a frame) input to the encoder 15000 into one or more processing units. For example, the processing unit may be called a coding unit (CU). In this case, the CU may be recursively split from a coding tree unit (CTU) or a largest coding unit (LCU) according to a quad-tree binary-tree (QTBT) structure. For example, one CU may be split into a plurality of CUs of a lower depth based on a quad-tree structure and/or a binary-tree structure. In this case, for example, the quad-tree structure may be applied first and the binary-tree structure may be applied later. Alternatively, the binary-tree structure may be applied first. The coding procedure according to the present disclosure may be performed based on a final CU that is not split anymore. In this case, the LCU may be used as the final CU based on coding efficiency according to characteristics of the image. When necessary, a CU may be recursively split into CUs of a lower depth, and a CU of the optimum size may be used as the final CU. Here, the coding procedure may include prediction, transformation, and reconstruction, which will be described later. As another example, the processing unit may further include a prediction unit (PU) or a transform unit (TU). In this case, the PU and the TU may be split or partitioned from the aforementioned final CU. The PU may be a unit of sample prediction, and the TU may be a unit for deriving a transform coefficient and/or a unit for deriving a residual signal from the transform coefficient.

The term “unit” may be used interchangeably with terms such as block or area. In a general case, an M×N block may represent a set of samples or transform coefficients configured in M columns and N rows. A sample may generally represent a pixel or a value of a pixel, and may indicate only a pixel/pixel value of a luma component, or only a pixel/pixel value of a chroma component. “Sample” may be used as a term corresponding to a pixel or a pel in one picture (or image).

The encoder 15000 may generate a residual signal (residual block or residual sample array) by subtracting a prediction signal (predicted block or predicted sample array) output from the inter-predictor 15090 or the intra-predictor 15100 from an input image signal (original block or original sample array), and the generated residual signal is transmitted to the transformer 15030. In this case, as shown in the figure, the unit that subtracts the prediction signal (predicted block or predicted sample array) from the input image signal (original block or original sample array) in the encoder 15000 may be called a subtractor 15020. The predictor may perform prediction for a processing target block (hereinafter referred to as a current block) and generate a predicted block including prediction samples for the current block. The predictor may determine whether intra-prediction or inter-prediction is applied on a current block or CU basis. As will be described later in the description of each prediction mode, the predictor may generate various kinds of information about prediction, such as prediction mode information, and deliver the generated information to the entropy encoder 15110. The information about the prediction may be encoded and output in the form of a bitstream by the entropy encoder 15110.

The intra-predictor 15100 may predict the current block with reference to the samples in the current picture. The samples may be positioned in the neighbor of or away from the current block depending on the prediction mode. In intra-prediction, the prediction modes may include a plurality of non-directional modes and a plurality of directional modes. The non-directional modes may include, for example, a DC mode and a planar mode. The directional modes may include, for example, 33 directional prediction modes or 65 directional prediction modes according to fineness of the prediction directions. However, this is merely an example, and more or fewer directional prediction modes may be used depending on the setting. The intra-predictor 15100 may determine a prediction mode to be applied to the current block, based on the prediction mode applied to the neighboring block.

The inter-predictor 15090 may derive a predicted block for the current block based on a reference block (reference sample array) specified by a motion vector on the reference picture. In this case, in order to reduce the amount of motion information transmitted in the inter-prediction mode, the motion information may be predicted on a per block, subblock, or sample basis based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. The reference picture including the reference block may be the same as or different from the reference picture including the temporal neighboring block. The temporal neighboring block may be referred to as a collocated reference block or a collocated CU (colCU), and the reference picture including the temporal neighboring block may be referred to as a collocated picture (colPic). For example, the inter-predictor 15090 may configure a motion information candidate list based on the neighboring blocks and generate information indicating a candidate to be used to derive a motion vector and/or a reference picture index of the current block. Inter-prediction may be performed based on various prediction modes. For example, in a skip mode and a merge mode, the inter-predictor 15090 may use motion information about a neighboring block as motion information about the current block. In the skip mode, unlike the merge mode, the residual signal may not be transmitted. In a motion vector prediction (MVP) mode, the motion vector of a neighboring block may be used as a motion vector predictor and the motion vector difference may be signaled to indicate the motion vector of the current block.

The prediction signal generated by the inter-predictor 15090 or the intra-predictor 15100 may be used to generate a reconstruction signal or to generate a residual signal.

The transformer 15030 may generate transform coefficients by applying a transformation technique to the residual signal. For example, the transformation technique may include at least one of discrete cosine transform (DCT), discrete sine transform (DST), Karhunen-Loeve transform (KLT), graph-based transform (GBT), or conditionally non-linear transform (CNT). Here, the GBT refers to transformation obtained from a graph depicting the relationship between pixels. The CNT refers to transformation obtained based on a prediction signal generated based on all previously reconstructed pixels. In addition, the transformation operation may be applied to pixel blocks having the same size of a square, or may be applied to blocks of a variable size other than the square.

The quantizer 15040 may quantize the transform coefficients and transmit the same to the entropy encoder 15110. The entropy encoder 15110 may encode the quantized signal (information about the quantized transform coefficients) and output a bitstream of the encoded signal. The information about the quantized transform coefficients may be referred to as residual information. The quantizer 15040 may rearrange the quantized transform coefficients, which are in a block form, in the form of a one-dimensional vector based on a coefficient scan order, and generate information about the quantized transform coefficients based on the quantized transform coefficients in the form of the one-dimensional vector. The entropy encoder 15110 may employ various encoding techniques such as, for example, exponential Golomb, context-adaptive variable length coding (CAVLC), and context-adaptive binary arithmetic coding (CABAC). The entropy encoder 15110 may encode information necessary for video/image reconstruction (e.g., values of syntax elements) together with or separately from the quantized transform coefficients. The encoded information (e.g., encoded video/image information) may be transmitted or stored in the form of a bitstream on a network abstraction layer (NAL) unit basis. The bitstream may be transmitted over a network or may be stored in a digital storage medium. Here, the network may include a broadcast network and/or a communication network, and the digital storage medium may include various storage media such as USB, SD, CD, DVD, Blu-ray, HDD, and SSD. A transmitter (not shown) to transmit the signal output from the entropy encoder 15110 and/or a storage (not shown) to store the signal may be configured as internal/external elements of the encoder 15000. Alternatively, the transmitter may be included in the entropy encoder 15110.

The quantized transform coefficients output from the quantizer 15040 may be used to generate a prediction signal. For example, inverse quantization and inverse transform may be applied to the quantized transform coefficients through the inverse quantizer 15050 and the inverse transformer 15060 to reconstruct the residual signal (residual block or residual samples). The adder 155 may add the reconstructed residual signal to the prediction signal output from the inter-predictor 15090 or the intra-predictor 15100. Thereby, a reconstructed signal (reconstructed picture, reconstructed block, reconstructed sample array) may be generated. When there is no residual signal for a processing target block as in the case where the skip mode is applied, the predicted block may be used as the reconstructed block. The adder 155 may be called a reconstructor or a reconstructed block generator. The generated reconstructed signal may be used for intra-prediction of the next processing target block in the current picture, or may be used for inter-prediction of the next picture through filtering as described below.

The filter 15070 may improve subjective/objective image quality by applying filtering to the reconstructed signal. For example, the filter 15070 may generate a modified reconstructed picture by applying various filtering techniques to the reconstructed picture, and the modified reconstructed picture may be stored in the memory 15080, specifically, the DPB of the memory 15080. The various filtering techniques may include, for example, deblocking filtering, sample adaptive offset, adaptive loop filtering, and bilateral filtering. As described below in the description of the filtering techniques, the filter 15070 may generate various kinds of information about filtering and deliver the generated information to the entropy encoder 15110. The information about filtering may be encoded and output in the form of a bitstream by the entropy encoder 15110.

The modified reconstructed picture transmitted to the memory 15080 may be used as a reference picture by the inter-predictor 15090. Thus, when inter-prediction is applied, the encoder may avoid prediction mismatch between the encoder 15000 and the decoder and improve encoding efficiency.

The DPB of the memory 15080 may store the modified reconstructed picture so as to be used as a reference picture by the inter-predictor 15090. The memory 15080 may store the motion information about a block from which the motion information in the current picture is derived (or encoded) and/or the motion information about the blocks in a picture that has already been reconstructed. The stored motion information may be delivered to the inter-predictor 15090 so as to be used as motion information about a spatial neighboring block or motion information about a temporal neighboring block. The memory 15080 may store the reconstructed samples of the reconstructed blocks in the current picture and deliver the reconstructed samples to the intra-predictor 15100.

At least one of the prediction, transform, and quantization procedures described above may be skipped. For example, for a block to which the pulse coding mode (PCM) is applied, the prediction, transform, and quantization procedures may be skipped, and the value of the original sample may be encoded and output in the form of a bitstream.

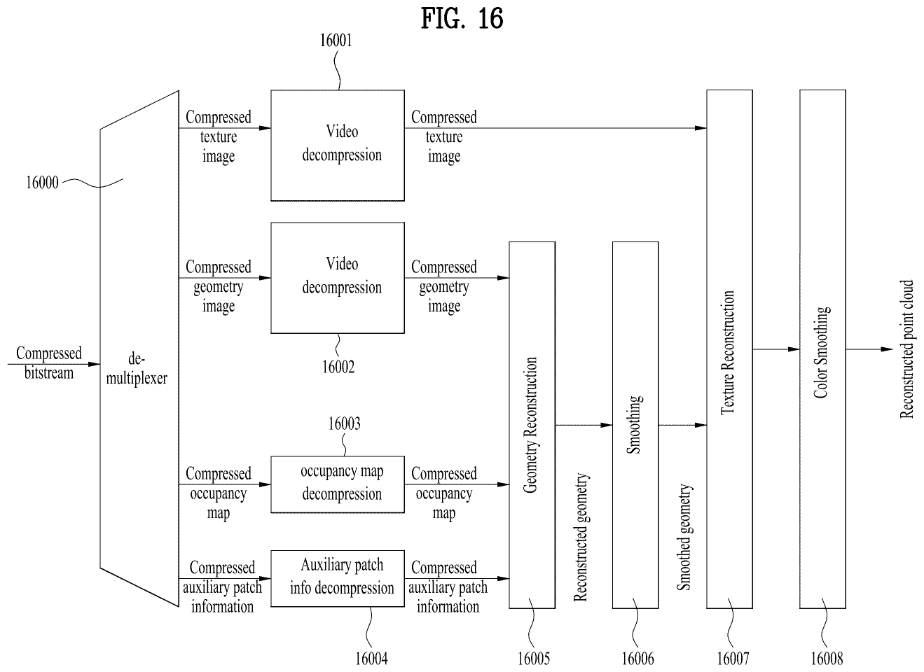

FIG. 16 illustrates an exemplary V-PCC decoding process according to embodiments.

The V-PCC decoding process or V-PCC decoder may follow the reverse process of the V-PCC encoding process (or encoder) of FIG. 4. Each component in FIG. 16 may correspond to software, hardware, a processor, and/or a combination thereof.

The demultiplexer 16000 demultiplexes the compressed bitstream to output a compressed texture image, a compressed geometry image, a compressed occupancy map, and compressed auxiliary patch information.

The video decompression or video decompressor 16001, 16002 decompresses (or decodes) each of the compressed texture image and the compressed geometry image.

The occupancy map decompression or occupancy map decompressor 16003 decompresses the compressed occupancy map.

The auxiliary patch info decompression or auxiliary patch info decompressor 16004 decompresses auxiliary patch information.

The geometry reconstruction or geometry reconstructor 16005 restores (reconstructs) the geometry information based on the decompressed geometry image, the decompressed occupancy map, and/or the decompressed auxiliary patch information. For example, the geometry changed in the encoding process may be reconstructed.

The smoothing or smoother 16006 may apply smoothing to the reconstructed geometry. For example, smoothing filtering may be applied.

The texture reconstruction or texture reconstructor 16007 reconstructs the texture from the decompressed texture image and/or the smoothed geometry.

The color smoothing or color smoother 16008 smoothes color values from the reconstructed texture. For example, smoothing filtering may be applied.

As a result, reconstructed point cloud data may be generated.

The figure illustrates a decoding process of the V-PCC for reconstructing a point cloud by decoding the compressed occupancy map, geometry image, texture image, and auxiliary path information. Each process according to the embodiments is operated as follows.

### Video Decompression (1600, 16002)

Video decompression is a reverse process of the video compression described above. In video decompression, a 2D video codec such as HEVC or VVC is used to decode a compressed bitstream containing the geometry image, texture image, and occupancy map image generated in the above-described process.

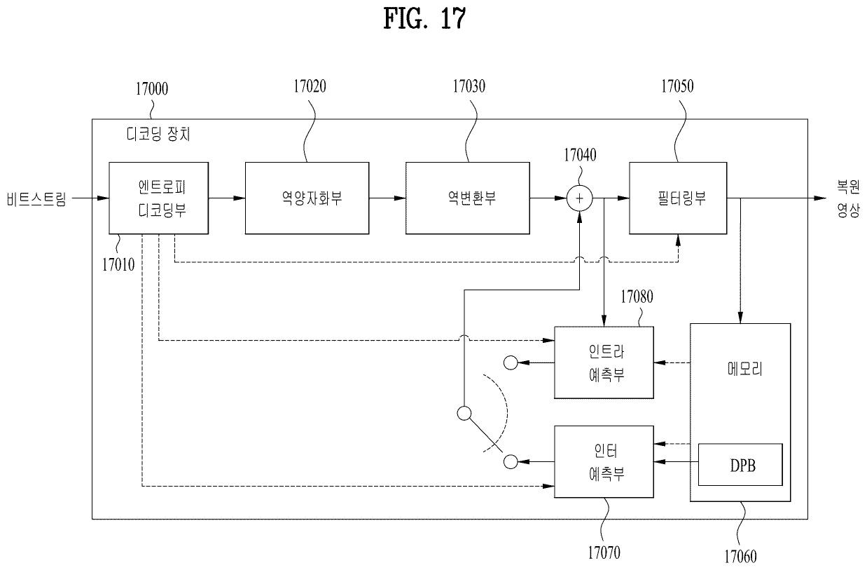

FIG. 17 illustrates an exemplary 2D video/image decoder according to embodiments.

The 2D video/image decoder may follow the reverse process of the 2D video/image encoder of FIG. 15.

The 2D video/image decoder of FIG. 17 is an embodiment of the video decompression or video decompressor of FIG. 16. FIG. 17 is a schematic block diagram of a 2D video/image decoder 17000 by which decoding of a video/image signal is performed. The 2D video/image decoder 17000 may be included in the point cloud video decoder of FIG. 1, or may be configured as an internal/external component. Each component in FIG. 17 may correspond to software, hardware, a processor, and/or a combination thereof.

Here, the input bitstream may include bitstreams for the geometry image, texture image (attribute(s) image), and occupancy map image described above. The reconstructed image (or the output image or the decoded image) may represent a reconstructed image for the geometry image, texture image (attribute(s) image), and occupancy map image described above.

Referring to the figure, an inter-predictor 17070 and an intra-predictor 17080 may be collectively referred to as a predictor. That is, the predictor may include the inter-predictor 17070 and the intra-predictor 17080. An inverse quantizer 17020 and an inverse transformer 17030 may be collectively referred to as a residual processor. That is, the residual processor may include the inverse quantizer 17020 and the inverse transformer 17030. The entropy decoder 17010, the inverse quantizer 17020, the inverse transformer 17030, the adder 17040, the filter 17050, the inter-predictor 17070, and the intra-predictor 17080 described above may be configured by one hardware component (e.g., a decoder or a processor) according to an embodiment. In addition, the memory 170 may include a decoded picture buffer (DPB) or may be configured by a digital storage medium.

When a bitstream containing video/image information is input, the decoder 17000 may reconstruct an image in a process corresponding to the process in which the video/image information is processed by the encoder of FIG. 1. For example, the decoder 17000 may perform decoding using a processing unit applied in the encoder. Thus, the processing unit of decoding may be, for example, a CU. The CU may be split from a CTU or an LCU along a quad-tree structure and/or a binary-tree structure. Then, the reconstructed video signal decoded and output through the decoder 17000 may be played through a player.

The decoder 17000 may receive a signal output from the encoder in the form of a bitstream, and the received signal may be decoded through the entropy decoder 17010. For example, the entropy decoder 17010 may parse the bitstream to derive information (e.g., video/image information) necessary for image reconstruction (or picture reconstruction). For example, the entropy decoder 17010 may decode the information in the bitstream based on a coding technique such as exponential Golomb coding, CAVLC, or CABAC, output values of syntax elements required for image reconstruction, and quantized values of transform coefficients for the residual. More specifically, in the CABAC entropy decoding, a bin corresponding to each syntax element in the bitstream may be received, and a context model may be determined based on decoding target syntax element information and decoding information about neighboring and decoding target blocks or information about a symbol/bin decoded in a previous step. Then, the probability of occurrence of a bin may be predicted according to the determined context model, and arithmetic decoding of the bin may be performed to generate a symbol corresponding to the value of each syntax element. According to the CABAC entropy decoding, after a context model is determined, the context model may be updated based on the information about the symbol/bin decoded for the context model of the next symbol/bin. Information about the prediction in the information decoded by the entropy decoder 17010 may be provided to the predictors (the inter-predictor 17070 and the intra-predictor 17080), and the residual values on which entropy decoding has been performed by the entropy decoder 17010, that is, the quantized transform coefficients and related parameter information, may be input to the inverse quantizer 17020. In addition, information about filtering of the information decoded by the entropy decoder 17010 may be provided to the filter 17050. A receiver (not shown) configured to receive a signal output from the encoder may be further configured as an internal/external element of the decoder 17000. Alternatively, the receiver may be a component of the entropy decoder 17010.

The inverse quantizer 17020 may output transform coefficients by inversely quantizing the quantized transform coefficients. The inverse quantizer 17020 may rearrange the quantized transform coefficients in the form of a two-dimensional block. In this case, the rearrangement may be performed based on the coefficient scan order implemented by the encoder. The inverse quantizer 17020 may perform inverse quantization on the quantized transform coefficients using a quantization parameter (e.g., quantization step size information), and acquire transform coefficients.

The inverse transformer 17030 acquires a residual signal (residual block and residual sample array) by inversely transforming the transform coefficients.

The predictor may perform prediction on the current block and generate a predicted block including prediction samples for the current block. The predictor may determine whether intra-prediction or inter-prediction is to be applied to the current block based on the information about the prediction output from the entropy decoder 17010, and may determine a specific intra-/inter-prediction mode.

The intra-predictor 265 may predict the current block with reference to the samples in the current picture. The samples may be positioned in the neighbor of or away from the current block depending on the prediction mode. In intra-prediction, the prediction modes may include a plurality of non-directional modes and a plurality of directional modes. The intra-predictor 17080 may determine a prediction mode to be applied to the current block, using the prediction mode applied to the neighboring block.

The inter-predictor 17070 may derive a predicted block for the current block based on a reference block (reference sample array) specified by a motion vector on the reference picture. In this case, in order to reduce the amount of motion information transmitted in the inter-prediction mode, the motion information may be predicted on a per block, subblock, or sample basis based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. For example, the inter-predictor 17070 may configure a motion information candidate list based on neighboring blocks and derive a motion vector of the current block and/or a reference picture index based on the received candidate selection information. Inter-prediction may be performed based on various prediction modes. The information about the prediction may include information indicating an inter-prediction mode for the current block.

The adder 17040 may add the acquired residual signal to the prediction signal (predicted block or prediction sample array) output from the inter-predictor 17070 or the intra-predictor 17080, thereby generating a reconstructed signal (a reconstructed picture, a reconstructed block, or a reconstructed sample array). When there is no residual signal for a processing target block as in the case where the skip mode is applied, the predicted block may be used as the reconstructed block.

The adder 17040 may be called a reconstructor or a reconstructed block generator. The generated reconstructed signal may be used for intra-prediction of the next processing target block in the current picture, or may be used for inter-prediction of the next picture through filtering as described below.

The filter 17050 may improve subjective/objective image quality by applying filtering to the reconstructed signal. For example, the filter 17050 may generate a modified reconstructed picture by applying various filtering techniques to the reconstructed picture, and may transmit the modified reconstructed picture to the memory 250, specifically, the DPB of the memory 17060. The various filtering techniques may include, for example, deblocking filtering, sample adaptive offset, adaptive loop filtering, and bilateral filtering.

The reconstructed picture stored in the DPB of the memory 17060 may be used as a reference picture in the inter-predictor 17070. The memory 17060 may store the motion information about a block from which the motion information is derived (or decoded) in the current picture and/or the motion information about the blocks in a picture that has already been reconstructed. The stored motion information may be delivered to the inter-predictor 17070 so as to be used as the motion information about a spatial neighboring block or the motion information about a temporal neighboring block. The memory 17060 may store the reconstructed samples of the reconstructed blocks in the current picture, and deliver the reconstructed samples to the intra-predictor 17080.

In the present disclosure, the embodiments described regarding the filter 160, the inter-predictor 180, and the intra-predictor 185 of the encoding device 100 may be applied to the filter 17050, the inter-predictor 17070 and the intra-predictor 17080 of the decoder 17000, respectively, in the same or corresponding manner.

At least one of the prediction, transform, and quantization procedures described above may be skipped. For example, for a block to which the pulse coding mode (PCM) is applied, the prediction, transform, and quantization procedures may be skipped, and the value of a decoded sample may be used as a sample of the reconstructed image.

### Occupancy Map Decompression (16003)

This is a reverse process of the occupancy map compression described above. Occupancy map decompression is a process for reconstructing the occupancy map by decompressing the occupancy map bitstream.

### Auxiliary Patch Info Decompression (16004)

The auxiliary patch information may be reconstructed by performing the reverse process of the aforementioned auxiliary patch info compression and decoding the compressed auxiliary patch info bitstream.

### Geometry Reconstruction (16005)

This is a reverse process of the geometry image generation described above. Initially, a patch is extracted from the geometry image using the reconstructed occupancy map, the 2D position/size information about the patch included in the auxiliary patch info, and the information about mapping between a block and the patch. Then, a point cloud is reconstructed in a 3D space based on the geometry image of the extracted patch and the 3D position information about the patch included in the auxiliary patch info. When the geometry value corresponding to a point (u, v) within the patch is g(u, v), and the coordinates of the position of the patch on the normal, tangent and bitangent axes of the 3D space are (δ0, s0, r0), ·δ(u, v), s(u, v), and r(u, v), which are the normal, tangent, and bitangent coordinates in the 3D space of a position mapped to point (u, v) may be expressed as follows:

$$δ ( u , v ) = δ 0 + g ( u , v ) ; \\ s ( u , v ) = s 0 + u ; \\ r ( u , v ) = r 0 + v .$$

### Smoothing (16006)

Smoothing, which is the same as the smoothing in the encoding process described above, is a process for eliminating discontinuity that may occur on the patch boundary due to deterioration of the image quality occurring during the compression process.

### Texture Reconstruction (16007)

Texture reconstruction is a process of reconstructing a color point cloud by assigning color values to each point constituting a smoothed point cloud. It may be performed by assigning color values corresponding to a texture image pixel at the same position as in the geometry image in the 2D space to points of a point of a point cloud corresponding to the same position in the 3D space, based on the mapping information about the geometry image and the point cloud in the geometry reconstruction process described above.

### Color Smoothing (16008)

Color smoothing is similar to the process of geometry smoothing described above. Color smoothing is a process for eliminating discontinuity that may occur on the patch boundary due to deterioration of the image quality occurring during the compression process.

### Color Smoothing May be Performed Through the Following Operations:

1) Calculate neighboring points of each point constituting the reconstructed point cloud using the K-D tree or the like. The neighboring point information calculated in the geometry smoothing process described in section 2.5 may be used.
2) Determine whether each of the points is positioned on the patch boundary. These operations may be performed based on the boundary information calculated in the geometry smoothing process described above.
3) Check the distribution of color values for the neighboring points of the points present on the boundary and determine whether smoothing is to be performed. For example, when the entropy of luminance values is less than or equal to a threshold local entry (there are many similar luminance values), it may be determined that the corresponding portion is not an edge portion, and smoothing may be performed. As a method of smoothing, the color value of the point may be replaced with the average of the color values of the neighboring points.

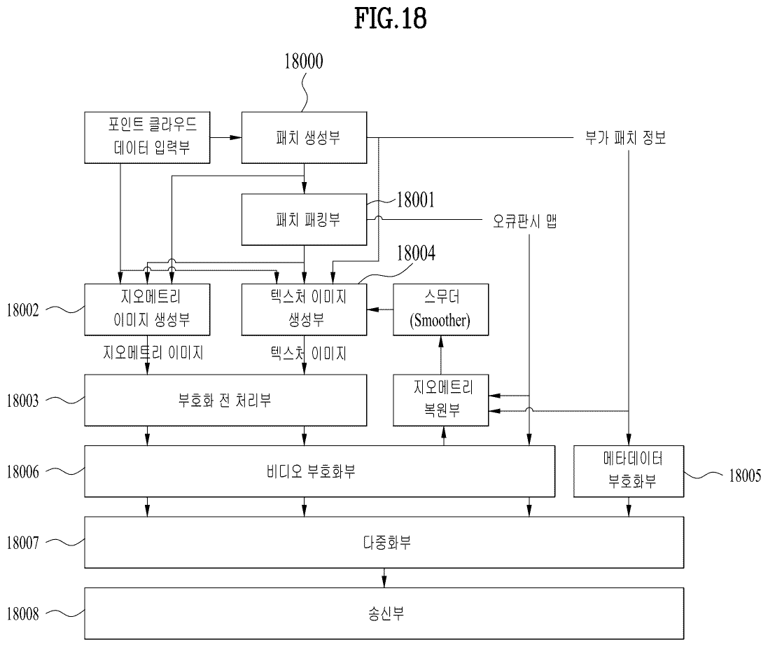

FIG. 18 is a flowchart illustrating operation of a transmission device according to embodiments of the present disclosure.

The transmission device according to the embodiments may correspond to the transmission device of FIG. 1, the encoding process of FIG. 4, and the 2D video/image encoder of FIG. 15, or perform some/all of the operations thereof. Each component of the transmission device may correspond to software, hardware, a processor and/or a combination thereof.

An operation process of the transmission terminal for compression and transmission of point cloud data using V-PCC may be performed as illustrated in the figure.

The point cloud data transmission device according to the embodiments may be referred to as a transmission device.

Regarding a patch generator 18000, a patch for 2D image mapping of a point cloud is generated. Auxiliary patch information is generated as a result of the patch generation. The generated information may be used in the processes of geometry image generation, texture image generation, and geometry reconstruction for smoothing.

Regarding a patch packer 18001, a patch packing process of mapping the generated patches into the 2D image is performed. As a result of patch packing, an occupancy map may be generated. The occupancy map may be used in the processes of geometry image generation, texture image generation, and geometry reconstruction for smoothing.

A geometry image generator 18002 generates a geometry image based on the auxiliary patch information and the occupancy map. The generated geometry image is encoded into one bitstream through video encoding.

An encoding preprocessor 18003 may include an image padding procedure. The geometry image regenerated by decoding the generated geometry image or the encoded geometry bitstream may be used for 3D geometry reconstruction and then be subjected to a smoothing process.

A texture image generator 18004 may generate a texture image based on the (smoothed) 3D geometry, the point cloud, the auxiliary patch information, and the occupancy map. The generated texture image may be encoded into one video bitstream.

A metadata encoder 18005 may encode the auxiliary patch information into one metadata bitstream.

A video encoder 18006 may encode the occupancy map into one video bitstream.

A multiplexer 18007 may multiplex the video bitstreams of the generated geometry image, texture image, and occupancy map and the metadata bitstream of the auxiliary patch information into one bitstream.

A transmitter 18008 may transmit the bitstream to the reception terminal. Alternatively, the video bitstreams of the generated geometry image, texture image, and the occupancy map and the metadata bitstream of the auxiliary patch information may be processed into a file of one or more track data or encapsulated into segments and may be transmitted to the reception terminal through the transmitter.

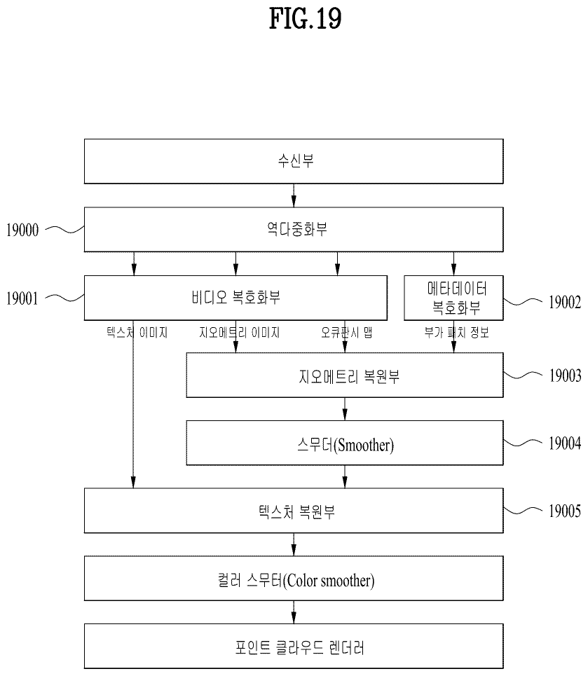

FIG. 19 is a flowchart illustrating operation of a reception device according to embodiments.

The reception device according to the embodiments may correspond to the reception device of FIG. 1, the decoding process of FIG. 16, and the 2D video/image encoder of FIG. 17, or perform some/all of the operations thereof. Each component of the reception device may correspond to software, hardware, a processor and/or a combination thereof.

The operation of the reception terminal for receiving and reconstructing point cloud data using V-PCC may be performed as illustrated in the figure. The operation of the V-PCC reception terminal may follow the reverse process of the operation of the V-PCC transmission terminal of FIG. 18.

The point cloud data reception device according to the embodiments may be referred to as a reception device.

The bitstream of the received point cloud is demultiplexed into the video bitstreams of the compressed geometry image, texture image, occupancy map and the metadata bitstream of the auxiliary patch information by a demultiplexer 19000 after file/segment decapsulation. A video decoder 19001 and a metadata decoder 19002 decode the demultiplexed video bitstreams and metadata bitstream. 3D geometry is reconstructed by a geometry reconstructor 19003 based on the decoded geometry image, occupancy map, and auxiliary patch information, and is then subjected to a smoothing process performed by a smoother 19004. A color point cloud image/picture may be reconstructed by a texture reconstructor 19005 by assigning color values to the smoothed 3D geometry based on the texture image. Thereafter, a color smoothing process may be additionally performed to improve the objective/subjective visual quality, and a modified point cloud image/picture derived through the color smoothing process is shown to the user through the rendering process (through, for example, the point cloud renderer). In some cases, the color smoothing process may be skipped.

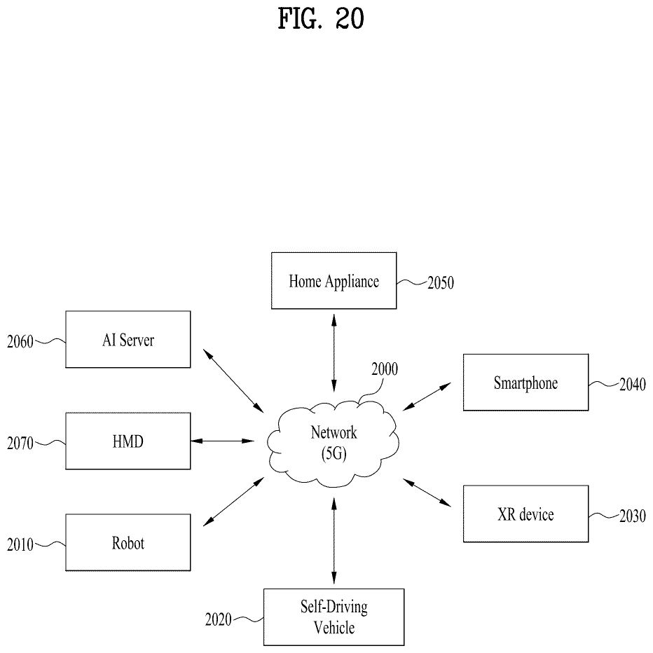

FIG. 20 illustrates an exemplary structure operable in connection with point cloud data transmission/reception methods/devices according to embodiments.

In the structure according to the embodiments, at least one of a server 2060, a robot 2010, a self-driving vehicle 2020, an XR device 2030, a smartphone 2040, a home appliance 2050 and/or a head-mount display (HMD) 2070 is connected to a cloud network 2010. Here, the robot 2010, the self-driving vehicle 2020, the XR device 2030, the smartphone 2040, or the home appliance 2050 may be referred to as a device. In addition, the XR device 2030 may correspond to a point cloud data (PCC) device according to embodiments or may be operatively connected to the PCC device.

The cloud network 2000 may represent a network that constitutes part of the cloud computing infrastructure or is present in the cloud computing infrastructure. Here, the cloud network 2000 may be configured using a 3G network, 4G or Long Term Evolution (LTE) network, or a 5G network.

The server 2060 may be connected to at least one of the robot 2010, the self-driving vehicle 2020, the XR device 2030, the smartphone 2040, the home appliance 2050, and/or the HMD 2070 over the cloud network 2000 and may assist at least a part of the processing of the connected devices 2010 to 2070.

The HMD 2070 represents one of the implementation types of the XR device and/or the PCC device according to the embodiments. An HMD type device according to embodiments includes a communication unit, a control unit, a memory, an I/O unit, a sensor unit, and a power supply unit.

Hereinafter, various embodiments of the devices 2010 to 2050 to which the above-described technology is applied will be described. The devices 2010 to 2050 illustrated in FIG. 20 may be operatively connected/coupled to a point cloud data transmission and reception device according to the above-described embodiments.

<PCC+XR> The XR/PCC device 2030 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 2030 may analyze 3D point cloud data or image data acquired through various sensors or from an external device and generate position data and attribute data about 3D points. Thereby, the XR/PCC device 2030 may acquire information about the surrounding space or a real object, and render and output an XR object. For example, the XR/PCC device 2030 may match an XR object including auxiliary information about a recognized object with the recognized object and output the matched XR object.

<PCC+Self-driving+XR> The self-driving vehicle 2020 may be implemented as a mobile robot, a vehicle, an unmanned aerial vehicle, or the like by applying the PCC technology and the XR technology.

The self-driving vehicle 2020 to which the XR/PCC technology is applied may represent an autonomous vehicle provided with means for providing an XR image, or an autonomous vehicle that is a target of control/interaction in the XR image. In particular, the self-driving vehicle 2020, which is a target of control/interaction in the XR image, may be distinguished from the XR device 2030 and may be operatively connected thereto.

The self-driving vehicle 2020 having means for providing an XR/PCC image may acquire sensor information from the sensors including a camera, and output the generated XR/PCC image based on the acquired sensor information. For example, the self-driving vehicle may have an HUD and output an XR/PCC image thereto to provide an occupant with an XR/PCC object corresponding to a real object or an object present on the screen.

In this case, when the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap the object on the screen. For example, the self-driving vehicle may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only real-world objects, backgrounds, and the like as CG images. On the other hand, the AR technology refers to a technology for showing a CG image virtually created on a real object image. The MR technology is similar to the AR technology described above in that virtual objects to be shown are mixed and combined with the real world. However, the MR technology differs from the AR technology makes a clear distinction between a real object and a virtual object created as a CG image and uses virtual objects as complementary objects for real objects, whereas the MR technology treats virtual objects as objects having the same characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to all VR, AR, MR, and XR technologies. For such technologies, encoding/decoding based on PCC, V-PCC, and G-PCC techniques may be applied.

The PCC method/device according to the embodiments may be applied to a vehicle that provides a self-driving service.

A vehicle that provides the self-driving service is connected to a PCC device for wired/wireless communication.

When the point cloud data transmission and reception device (PCC device) according to the embodiments is connected to a vehicle for wired/wireless communication, the device may receive and process content data related to an AR/VR/PCC service that may be provided together with the self-driving service and transmit the processed content data to the vehicle. In the case where the point cloud data transmission and reception device is mounted on a vehicle, the point cloud transmitting and reception device may receive and process content data related to the AR/VR/PCC service according to a user input signal input through a user interface device and provide the processed content data to the user. The vehicle or the user interface device according to the embodiments may receive a user input signal. The user input signal according to the embodiments may include a signal indicating the self-driving service.

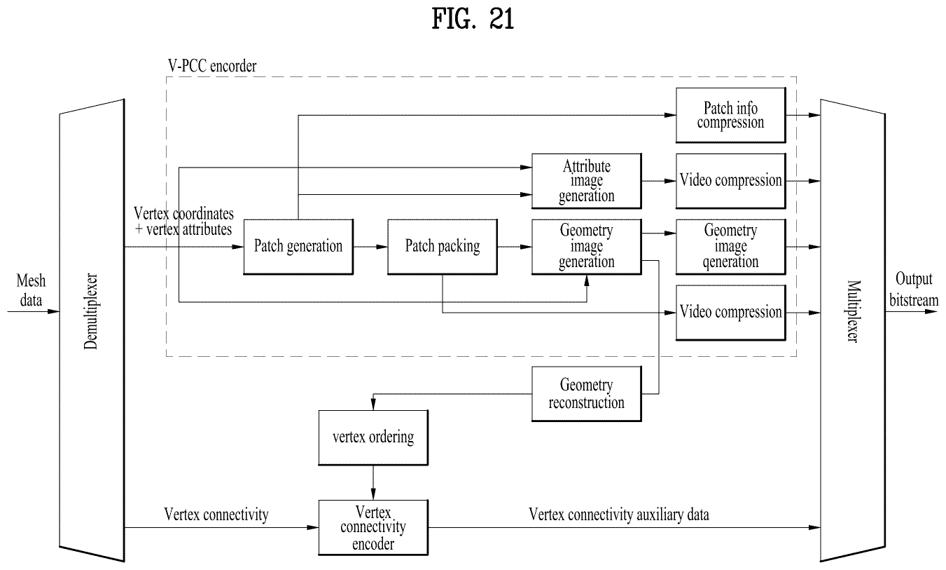

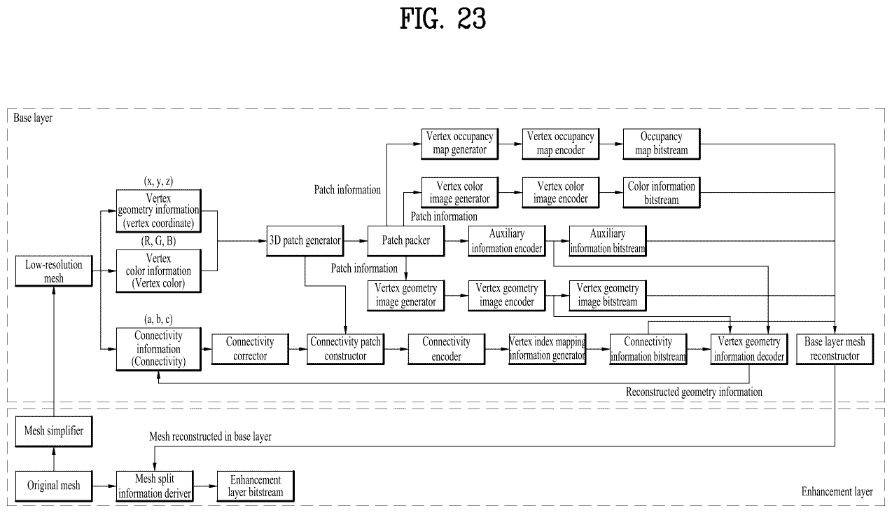

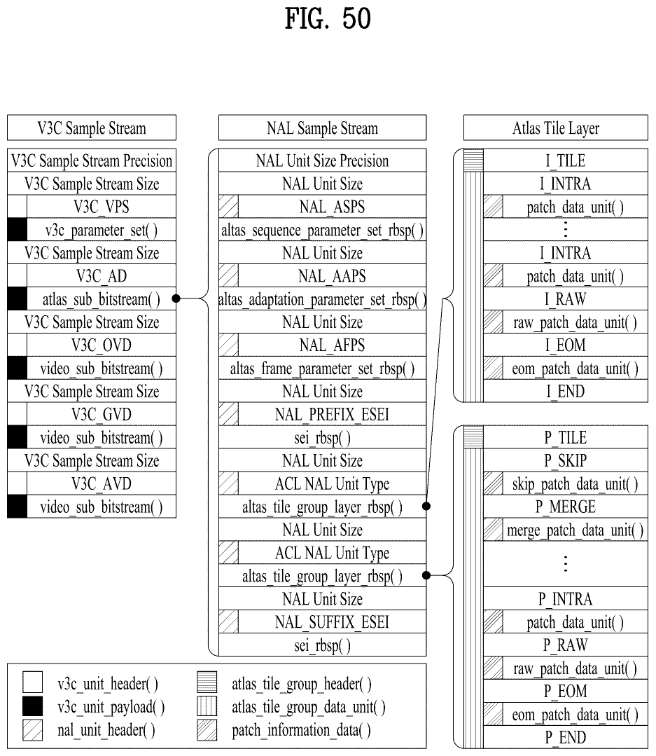

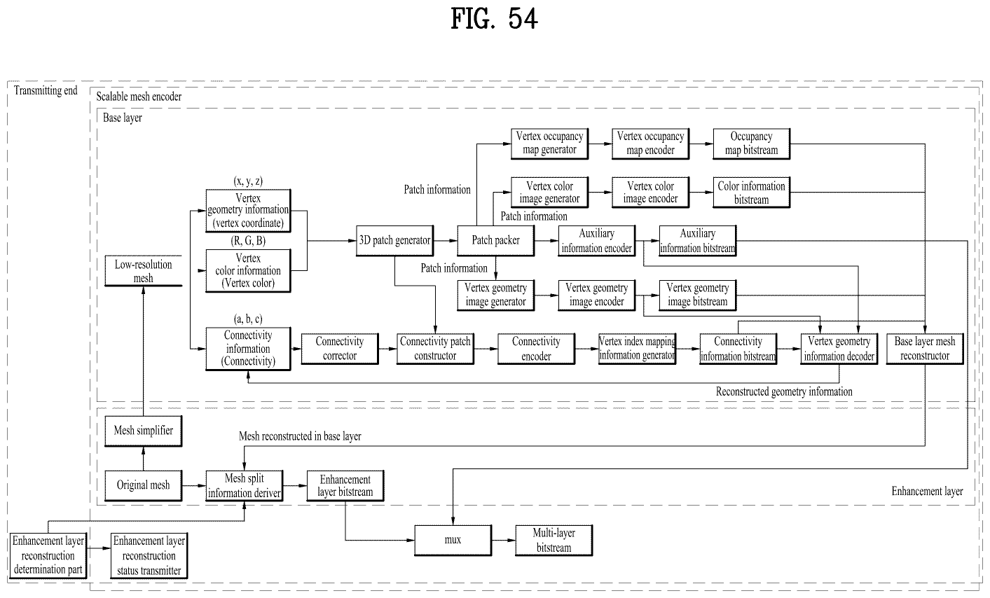

A point cloud data transmission method/device according to embodiments corresponds to the operations and/or devices of the transmission device 10000, the point cloud video encoder 10002, the file/segment encapsulator 10003 of FIG. 1, the encoder of FIG. 3, the encoder of FIG. 15, the transmission device of FIG. 18, the XR device 2030 of FIG. 20, the point cloud data encoder for mesh data of FIG. 21, the scalable mesh encoder of FIG. 23, the bitstream generation of of FIGS. 50 to 52, the scalable mesh encoder of FIG. 54, and the like.

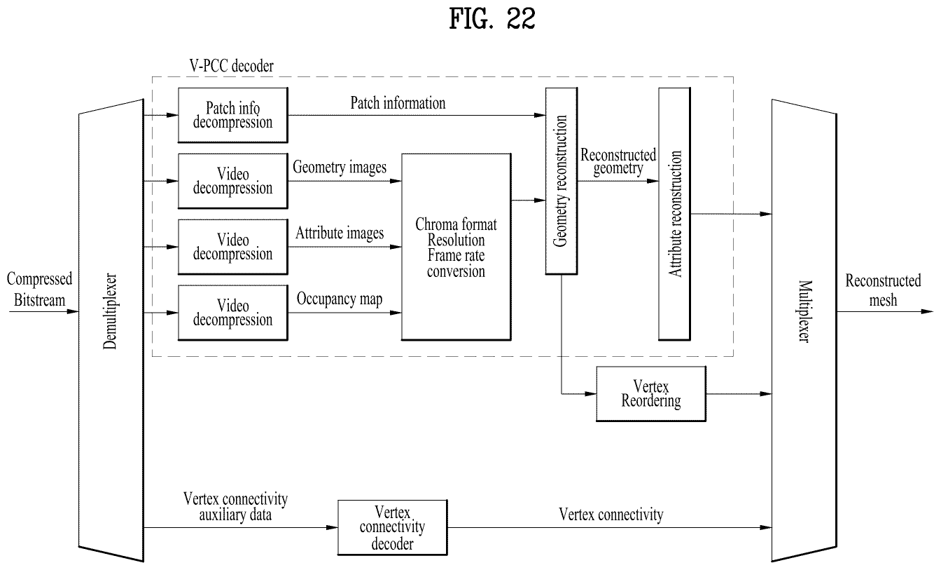

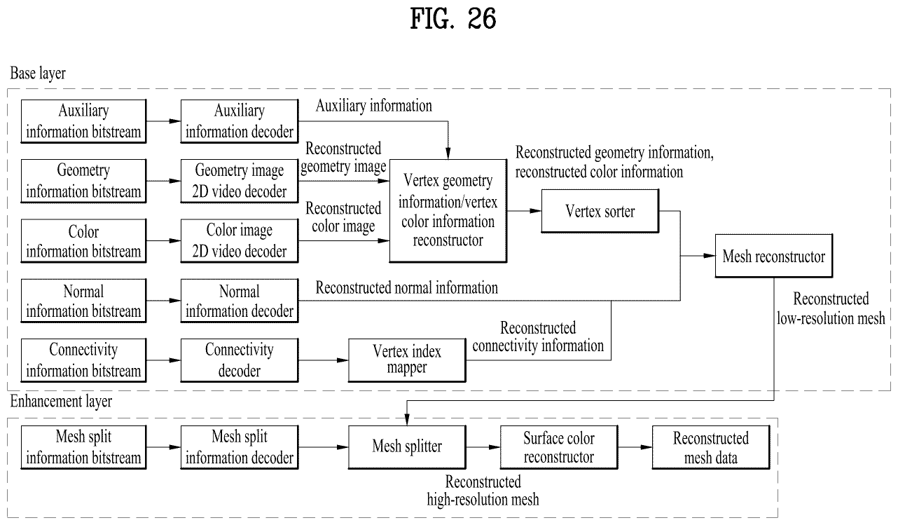

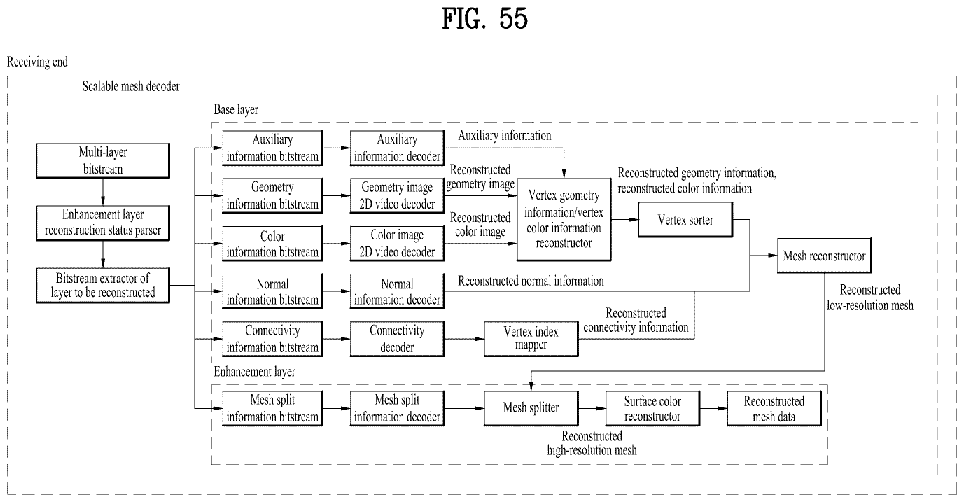

A point cloud data reception method/device according to embodiments corresponds to the operations and/or devices of the reception device 10005, the receiver 10006, the file/segment decapsulator 10007, the point cloud video decoder 10008, the renderer 10009 of FIG. 1, the decoder of FIG., the decoder of FIG. 17, the reception device of FIG. 19, the XR device 2030 of FIG. 20, the point cloud data decoder for mesh data of FIG. 22, the scalable mesh decoder of FIGS. 26, 27, 29, 33, 34, and 35, the bitstream parsing of FIGS. 50 to 52, the scalable mesh decoder of FIG. 55, and the like.

The method/device for transmitting or receiving point cloud data according to the embodiments may be referred to simply as a method/device.

The method/device according to the embodiments may include and execute a scalable mesh encoding/decoding method and device.

Embodiments include a mesh coding method/device that adds a separate encoder/decoder to the standard method of video-based point cloud compression (V-PCC), which is a method of compressing 3D point cloud data using a 2D video codec, to encode/decode mesh information. Embodiments include a method/device that simplifies mesh data to compress and reconstruct a low-resolution mesh at the base layer and split the mesh at the enhancement layer to reconstruct a high-resolution mesh. Scalable transmission of the mesh may improve transmission efficiency by allowing applications that use a network bandwidth and mesh data to adjust data volume and quality to meet user requirements.

Embodiments include a structure and syntax and semantics information for splitting connectivity information in a frame into multiple connectivity patches and performing encoding/decoding on a patch-by-patch basis. The operations of a transmitter and receiver applying the same will be described.

FIG. 21 illustrates a video-based point cloud compression (VPCC) encoder and a mesh encoder according to embodiments.

FIG. 22 illustrates a VPCC decoder and a mesh decoder according to embodiments.

Based on the V-PCC standard, progress is being made to standardize V-Mesh technology, including mesh information. A separate encoder and decoder may be added to the V-PCC standard, as shown in FIGS. 21 and 22. The added encoder and decoder encode and decode the vertex connectivity information related to the mesh information and transmit the same as a bitstream. The mesh compression structure encodes the mesh frame input to the encoder into one bitstream according to the quantization rate. Therefore, regardless of the network situation or the resolution of the reception device when a pre-compressed mesh frame is to be transmitted, there is a limitation that the mesh frame with the bitrate (or image quality) determined by the encoding must be transmitted, or transcoding must be performed at the desired bitrate. In the case where the mesh frames are encoded and stored at multiple bitrates in order to variably adjust the transmission amount of the mesh frames, the memory capacity required for storage and the encoding time are greatly increased. Accordingly, methods/devices according to embodiments include a scalable mesh compression method/device as a method for variably adjusting the transmission amount of encoded frames while minimizing the above-described disadvantages.

Embodiments include a scalable mesh structure in which a low-resolution mesh is reconstructed at a base layer and an enhancement layer receives mesh split information to reconstruct a high-resolution mesh. The enhancement layer may parse a mesh splitting method on a patch-by-patch basis, and may perform mesh splitting in a patch per triangle fan, triangle strip, or triangle.

As used herein, the term video-based point cloud compression (V-PCC) may have the same meaning as visual volumetric video-based coding (V3C). The two terms may be used interchangeably. Accordingly, in the present disclosure, the term V-PCC may be construed as V3C.

FIG. 23 illustrates a scalable mesh encoder according to embodiments.

The encoder of FIG. 23 corresponds to the operations and/or devices of the transmission device 10000 of FIG. 1, the point cloud video encoder 10002 of FIG. 1, the encoder of FIG. 3, the encoder of FIG. 15, the transmission device of FIG. 18, the XR device 2030 of FIG. 20, the point cloud data encoder for mesh data of FIG. 21, the scalable mesh encoder of FIG. 54, and the like.

Each component of the encoder of FIG. 23 may correspond to hardware, software, a processor, and/or a combination thereof. The encoder of FIG. 23 may include a memory and a processor connected to the memory, and instructions stored in the memory may cause the processor to perform operations of the encoder of FIG. 23.

The encoder of FIG. 23 may be referred to as a point cloud data transmission device, a mesh data encoder, or the like according to embodiments.

Embodiments may simplify the original mesh input to the scalable mesh encoder to output a low-resolution mesh. The low-resolution mesh may be compressed at the base layer, and the base layer may derive splitting information for splitting the reconstructed low-resolution mesh into high-resolution meshes, and transmit the same in a bitstream to the enhancement layer. In this regard, it may be derived whether to split the reconstructed mesh on a per patch basis. When patch splitting is performed, the submesh type (triangle, triangle fan, triangle strip) that is the basic unit of splitting may be determined. The principles behind each of the steps are described in detail below.

A 3D patch generator receives vertex geometry information, vertex color information, normals, and/or connectivity information as input and may perform splitting into multiple 3D patches based on the information. For each of the split 3D patches, an optimal projection plane may be determined based on the normal information and/or the color information.

A patch packer determines positions in the W×H image space where the patches determined by the 3D patch generator are to be packed without overlapping each other. According to an embodiment, the patches may be packed such that only one patch is present in the M×N space when the W×H image space is divided into M×N grids for the respective patches.

An auxiliary information encoder may encode a 3D reconstruction position (x0, y0, z0), and/or a patch index map in M×N units in the W×H image space based on a projection plane index determined per patch, a 2D bounding box position (u0, v0, u1, v1) of the patch, and/or the bounding box of the patch.

A vertex geometry image generator generates a vertex geometry image by constructing a single channel image of the distance of each vertex to the plane onto which each vertex is projected, based on the patch information generated by the patch packer.

When the original mesh data has vertex color information, a vertex color image generator generates a vertex color image for the vertex color information about the projected patch.

A 2D video encoder may encode the images generated by the vertex geometry image generator and the vertex color image generator.

A vertex geometry decoder may reconstruct the encoded auxiliary information and geometry information to generate reconstructed vertex geometry information.

A vertex occupancy map generator may generate a map with a value of 1 for a pixel with a projected vertex and a value of 0 for an empty pixel based on the patch information generated by the patch packer.

A vertex occupancy map encoder may encode a binary image indicating whether a pixel has a projected vertex in the image space in which the patches determined by the patch packer are positioned. According to embodiments, the occupancy map binary image may be encoded by the 2D video encoder.

The connectivity corrector may correct the connectivity information with reference to the reconstructed vertex geometry information.

A connectivity patch constructor may split connectivity information into one or more connectivity patches using point partitioning information generated by the 3D patch generator in the process of partitioning the input points into one or more 3D vertex patches.

The connectivity encoder may encode the connectivity on a patch-by-patch basis.

A vertex index mapping information generator may generate information for mapping a vertex index of the connectivity information to a corresponding reconstructed vertex index.

Referring to FIG. 23, a transmission method or transmission device (encoder) may include an operation of encoding mesh data according to a base layer and an enhancement layer. By simplifying the original mesh data, low-resolution mesh data for the base layer is generated. The low-resolution mesh data for the base layer may be encoded to generate a bitstream for the base layer to be delivered to the decoder. The encoder may reconstruct the mesh data of the base layer for the enhancement layer. Mesh splitting information may be derived from the mesh data reconstructed in the base layer. The low-resolution mesh data of the base layer may be further split to generate high-resolution mesh data for the enhancement layer. The encoder may generate the high-resolution mesh data for the enhancement layer to derive parameter information for the decoder, which may be delivered in the bitstream. The encoder may deliver in the bitstream residual between the high-resolution mesh data for the enhancement layer' and the original mesh data. The reception method or reception device (decoder) according to embodiments of FIG. 26 may include an operation of receiving mesh data of the base layer according to the performance of the decoder and reconstruct high-resolution mesh data from the received low-resolution mesh data based on the splitting operation. The decoder may reconstruct the mesh data of the enhancement layer based on information related to the mesh data contained in the received bitstream. For example, when the receiver performance only allows the mesh data of the base layer to be decoded, the decoder may decode the low-resolution mesh data of the base layer and split the same to reconstruct the high-resolution mesh data of the enhancement layer. When the receiver performance allow both the mesh data of the base layer and/or the enhancement layer, the decoder may receive the mesh data and/or mesh data-related information of the enhancement layer as well as the base layer to decode the mesh data of the base layer and/or the mesh data of the enhancement layer.

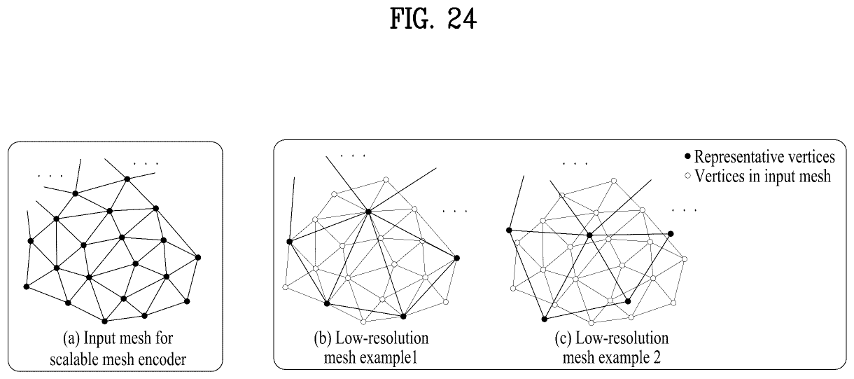

FIG. 24 illustrates a low-resolution mesh according to embodiments.

Next, the operation of the encoder of FIG. 23 will be described.

The mesh simplifier of FIG. 23 may simplify the mesh input to the scalable mesh encoder and output a low-resolution mesh. The mesh simplification may be performed as follows.

The vertices in the mesh input to the encoder (FIG. 24-a) may be grouped into multiple sets, and a representative vertex may be derived from each group. The representative vertex may be a specific vertex in the group (FIG. 24-b), or a new vertex generated by weighted summation of the geometry information about the vertices in the group (FIG. 24-c). The procedure of grouping and selecting a representative vertex in a group may be performed as follows. Grouping may be performed such that the distance between centers in the groups is above a threshold and each group has a uniform shape. The threshold may be set to differ between a specific important region and an unimportant region specified by the encoder. The most centered vertex in a group may be selected as a representative vertex (FIG. 24-b), or the representative vertices may be derived by averaging all vertices in the group (FIG. 24-c).

After deleting all vertices other than the representative vertices, the connections between the representative vertices may be newly defined to generate a low-resolution mesh. The generated low-resolution mesh may be encoded in the base layer.

The mesh split information deriver of FIG. 23 may derive splitting information for splitting the encoded and reconstructed low-resolution mesh in the base layer into a high-resolution mesh. The mesh split information may be derived in order to reduce the difference between the high-resolution mesh generated by splitting the reconstructed low-resolution mesh and the original mesh.

By referencing encoding and transmission status (is_enhancement_layer_coded) from an enhancement layer reconstruction determination part, whether to split the mesh (split_mesh_flag) may be derived per patch of the reconstructed low-resolution mesh.

When splitting is performed on a patch, the submesh type (submesh_type_idx) and submesh split type (submesh_split_type_idx), which are the basic units for splitting, may be determined.

Information such as whether to split the mesh (split_mesh_flag), submesh type (submesh_type_idx), and submesh split type (submesh_split_type_idx) may be transmitted through the enhancement_layer_patch_information_data syntax, or may be invoiked in the form of a function on enhancement_layer_tile_data_unit.

To split a submesh, one or more vertices may be added in the submesh and the connections between the vertices may be newly defined. In splitting a submesh, the number of vertices added (split_num) or the split depth (split_depth) may be determined. To derive the geometry of the added vertices, the initial geometry of the added vertices may be derived by weighted summation of the geometry of the existing vertices, and the final geometry may be derived by summing the offset to the initial geometry. The offset may be determined for the purpose of reducing the difference between the high-resolution mesh generated by newly defining the connections between the added vertices and the existing vertices and the original mesh. The offset may be an offset value (delta_geometry_x, delta_geometry_y, delta_geometry_z) or an offset index (delta_geometry_idx) with respect to each of the x, y, and z axes. The offset may be an index of a combination of offsets on two or more of the x, y, or z axes. Information such as the number of vertices added when splitting the submesh (split_num), the depth of the split (split_depth), the offset values (delta_geometry_x, delta_geometry_y, delta_geometry_z), and the offset index (delta_geometry_idx) may be transmitted in the submesh_split_data syntax.

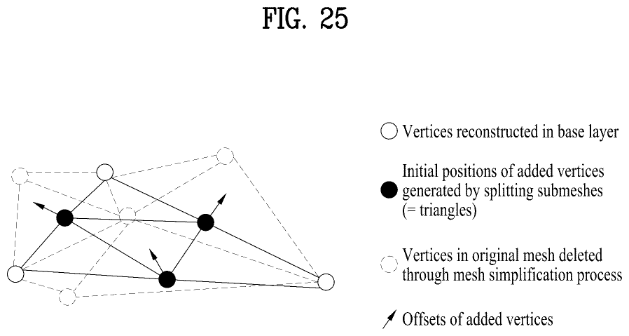

FIG. 25 illustrates initial positions and offsets of additional vertices when a submesh is a triangle according to embodiments.

FIG. 25 is an example in which the submesh is a triangle and the initial positions of the added vertices are derived by splitting of the centers of the triangle edges. The n original mesh vertices closest to the respective added vertices may be selected, and the offset may be the difference between the average geometry of the selected vertices and the geometry of the added vertices.

FIG. 26 illustrates a scalable mesh decoder according to embodiments.

The decoder of FIG. 26 is a decoder device corresponding to the encoder of FIG. 23, and may perform a corresponding operation and/or reverse operation to the operation of the encoder.

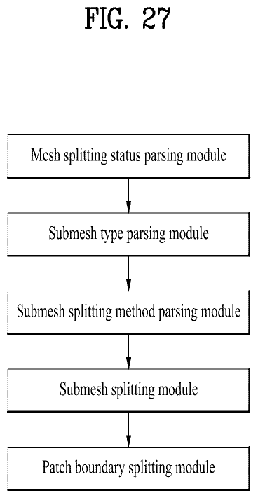

FIG. 26 corresponds to the operations and/or devices of the reception device 10005, receiver 10006, point cloud video decoder 10008 of FIG. 1, the decoder of FIG. 16, the decoder of FIG. 17, the reception device of FIG. 19, the XR device 2030 of FIG. 20, the 22 point cloud data decoder for mesh data of FIG., the scalable mesh decoder of FIGS. 27, 29, 33, 34, 35, etc., the scalable mesh decoder of FIG. 55, and the like.

Each component of the decoder of FIG. 26 may correspond to hardware, software, a processor, and/or a combination thereof. The decoder of FIG. 26 may include a memory and a processor connected to the memory, and instructions stored in the memory may cause the processor to perform the operation of the decoder of FIG. 26.

The decoder of FIG. 26 may be referred to as a point cloud data reception device, a mesh data decoder, or the like according to embodiments.

The mesh splitter of FIG. 26 may generate a high-resolution mesh by splitting the reconstructed low-resolution mesh into submesh units. The mesh splitter may perform operations as shown in FIG. 27. Modules such as a mesh splitting status parsing module, a submesh type parsing module, a submesh splitting method parsing module, a submesh splitting module, and/or a patch boundary splitting module may be executed. Some modules may be omitted or the order of execution of the modules may change.

The decoder according to the embodiments may decode point cloud data based on a base layer and an enhancement layer.

In the processing for the base layer, an auxiliary information decoder may receive an auxiliary information bitstream, and generate auxiliary information by decoding the bitstream. A geometry image 2D video decoder may receive a geometry information bitstream, and generate a reconstructed geometry image by decoding the bitstream. A color image 2D video decoder may receive a color information bitstream, and generate a reconstructed color image by decoding the bitstream. A normal information decoder may receive a normal information bitstream, and generate a reconstructed normal information by decoding the bitstream. A connectivity decoder may receive a connectivity information bitstream, decode the bitstream, and generate reconstructed connectivity information by mapping the vertex indices by a vertex index mapper. A vertex sorter may sort the vertices in order based on the reconstructed geometry information and/or the reconstructed color information. A mesh reconstructor may receive the geometry information, color information, reconstructed normal information, and reconstructed connectivity information about the sorted vertices, reconstruct the mesh, and generate a reconstructed low-resolution mesh.

In the processing for the enhancement layer, a mesh split information decoder may receive a mesh split information bitstream and decode the mesh split information. The mesh splitter may receive the reconstructed low-resolution mesh from the base layer, receive the reconstructed mesh split information, and split the mesh. A surface color reconstructor may reconstruct the surface color of the mesh. As a result, reconstructed mesh data may be generated. A reconstructed high-resolution mesh may be generated through the enhancement layer.

FIG. 27 illustrates operation of a mesh splitter according to embodiments.

FIG. 27 illustrates in detail the operation of the mesh splitter of FIG. 26. The mesh splitter may include a mesh splitting status parsing module, a submesh type parsing module, a submesh splitting method parsing module, a submesh splitting module, and/or a patch boundary splitting module. The operation of each module is described below with reference to the respective drawings.

Regarding the mesh splitting status parsing module, depending on the information indicating whether the mesh is split (split_mesh_flag), the mesh may be parsed or derived on a per object or 3D vertex patch basis. A 3D vertex patch may be a patch obtained by back-projecting a reconstructed 2D vertex patch (geometry information patch, color information patch, occupancy map patch) into 3D space based on atlas information. For example, information indicating whether to split the mesh (split_mesh_flag) may be parsed on a per 3D vertex patch basis. When the information indicating whether to split the mesh (split_mesh_flag) indicates splitting, a subsequent splitting operation may be performed on the 3D vertex patch.

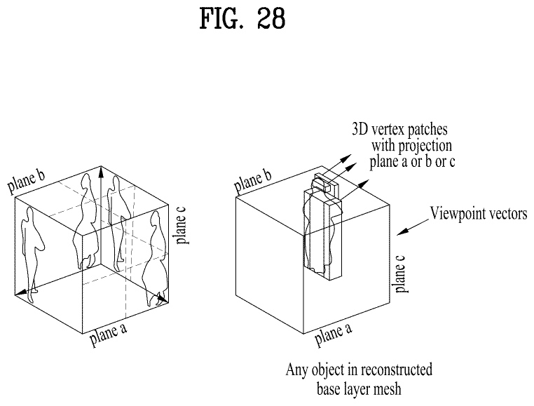

FIG. 28 illustrates an example of an object and a 3D vertex patch in a mesh reconstructed from a base layer according to embodiments.

A mesh is reconstructed by reconstructing geometry information, color information, normal information, and connectivity information from the base layer. The mesh may include an object. The object may be back-projected into 3D space based on the viewpoint vector and atlas information to generate 3D vertex patches for the projection planes a, b, and c.

The mesh splitting method is summarized as follows.
1) Whether to split the mesh (split_mesh_flag) may be parsed or inferred on a per object basis.
2) Whether to split the mesh may be parsed on a per 3D vertex patch basis. When mesh splitting is performed, the splitting method may be parsed on a per 3D vertex patch or per submesh in a 3D vertex patch.
3) Whether to split the mesh on the per 3D vertex patch basis may be inferred. A viewpoint vector index may be parsed from high-level information in the enhancement layer. The viewpoint vector index may be used to derive the 3D vertex patch index on which mesh splitting is to be performed. A viewpoint vector may be derived from the viewpoint vector index. The viewpoint vector may be a vector in 3D space of the reconstructed mesh in the base layer. Semantically, the viewpoint vector may be the user's viewpoint or a major viewpoint in the application where the reconstructed mesh is used. Mesh splitting may be performed on a 3D vertex patch when the normal vector to a plane (atlas) and the viewpoint vector in the 3D space into which the 3D vertex patch has been projected form an angle less than or equal to 6°.

The submesh type parsing module may parse the submesh type (submesh_type_idx) per mesh object or patch on mesh splitting is performed. The submesh type may be identified by information (submesh_type_idx) indicating the submesh type index. A submesh may refer to the basic unit in which the splitting is performed. For example, when the submesh of any patch is a triangle fan, each triangle fan may be split by traversing multiple triangle fans in the patch. The syntax related to the submesh type index (submesh_type_idx) may be an index representing a submesh type, and the submesh type corresponding to the index may be set. Submesh types may be triangle, triangle fan, and triangle strip.

The submesh splitting method parsing module may parse the submesh split type (submesh_split_type_idx) on a per mesh object or per patch basis. Information (submesh_split_type_idx) indicating the submesh split type index may indicate the submesh split type. The unit of submesh splitting method parsing may be the same as or smaller than the unit of submesh type parsing. For example, when the submesh type is parsed on the per mesh object basis and is triangle fan, the triangle fan splitting method may be parsed per patch. The submesh_split_type_idx syntax may be an index indicating a submesh splitting method, and may be set to the submesh splitting method that corresponds to the index. When the submesh is a triangle fan, the triangle fan may be split using a triangle fan vertex splitting method, a triangle fan edge splitting method, or the like. When the submesh is a triangle, the triangle may be split using one of multiple triangle splitting methods. When the submesh is a triangle strip, a triangle splitting method may be used to split the triangles in the strip.

The submesh splitting module may traverse multiple submeshes in a mesh and split each submesh with a parsed splitting method. Splitting may be performed successively on all submeshes in any unit of mesh splitting status parsing or any unit of submesh type parsing. This operation may be performed in a specific order for every mesh splitting parsing unit or any submesh type parsing unit in which splitting is performed.

Each of these syntaxes may be entropy decoded using Exponential Golomb, Variable Length Coding (VLC), Context-Adaptive Variable Length Coding (CAVLC), Context-Adaptive Binary Arithmetic Coding (CABAC), or the like.

The submesh splitting module may vary depending on the shape of the submesh and a splitting method for the same, as described below.

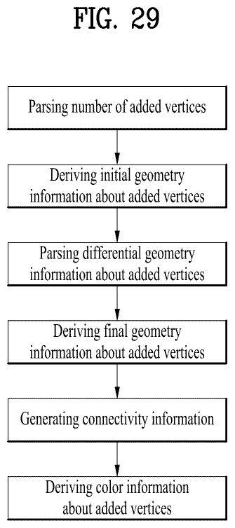

FIG. 29 illustrates a method of splitting triangle fan vertices according to embodiments.

The triangle fan vertex splitting method (where submesh=triangle fan) is configured as follows.

The triangle fan vertex splitting method may include splitting a center vertex in a triangle fan into two or more vertices and splitting the triangle fan by correcting the connections between the vertices. The method may be carried out as illustrated in FIG. 29. After splitting the center vertex, the center vertex may or may not be deleted. The geometry information about the split vertices may be derived by parsing the number of vertices into the center vertex is to be split (split_num), the differential geometry index of each vertex generated by splitting (delta_geometry_idx, delta_geometry_x, delta_geometry_y, delta_geometry_z), and the like.

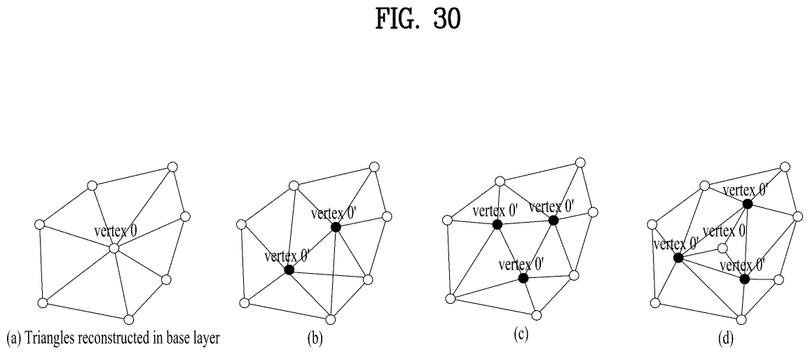

FIG. 30 illustrates an example of splitting an arbitrary triangle fan using a triangle fan vertex splitting method according to embodiments.

Regarding the submesh splitting described above, FIG. 30 illustrates a method used when the submesh is a triangle fan. (a) may illustrate an example of the result of splitting a triangle fan reconstructed in the base layer using the “triangle fan vertex splitting method,” (b) may illustrate the result of splitting a center vertex (vertex 0) into two vertices (two vertices 0′) and removing the center vertex, (c) may illustrate the result of splitting the center vertex (vertex 0) into three vertices (three vertices 0′) and removing the center vertex, and (d) may illustrate the result of splitting the center vertex (vertex 0) into three vertices (three vertices 0′) and not removing the center vertex.

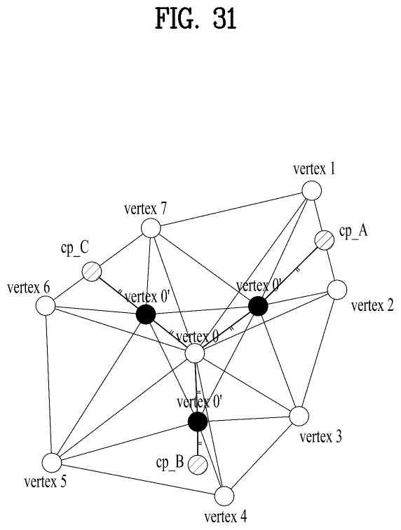

FIG. 31 illustrates an example of splitting an arbitrary triangle fan using a triangle fan vertex splitting method according to embodiments.

FIG. 31 may illustrate a method of deriving geometry information about vertices generated by splitting a triangle fan using the “triangle fan vertex splitting method.” In the operation of parsing the number of added vertices of FIG. 9, a value or index (split_num) indicating the number of vertices into which the center vertex is to be split may be parsed. When the index is parsed, the value corresponding to the index may be derived from a predefined table.

In the operation of deriving the initial geometry information about the added vertices in FIG. 29, a submesh may be split to derive the initial geometry information about the added vertices generated by the splitting. When the value indicated by the split_num syntax is n, the initial geometry information about the n added vertices may be derived. In FIG. 10, (b) may show the result of deriving the initial geometry information about n added vertices (vertex 0′) when n=2, and (c) and (d) may show the results when n=3, respectively. The initial geometry information about the added vertices may be derived based on the geometry information about the base layer vertices as follows. The boundary vertices of the current triangle fan may be classified into N groups based on the geometry information, and the center vertices (cp_A, cp_B, and cp_C in FIG. 31) of the respective groups may be derived. The initial geometry information about each vertex 0′ may be the average of the geometry information about the center vertices of the respective groups and the geometry information about the center vertex of the current triangle fan. Alternatively, the initial geometry information about each vertex 0′ may be the average of the geometry information about the vertices in each group and the geometry information about the center vertex of the current triangle fan.

In the operation of parsing differential geometry information about the added vertices in FIG. 29, the differential geometry information to be added to the initial geometry information about the added vertices may be parsed. The differential geometry information may be values for the x, y, and z axes (delta_geometry_x, delta_geometry_y, and delta_geometry_z), or may be a bundle of differential geometry information for the three axes represented as an index (delta_geometry_idx). When the index is parsed, the geometry information values corresponding to the index may be derived from a predefined table.

In the operation of deriving the final geometry information about added vertices in FIG. 29, the final geometry information may be derived by summing the initial geometry information about the added vertices and the differential geometry information.

In the operation of generating connectivity information in FIG. 29, the existing connection of the base layer may be removed, and the connectivity between the base layer vertices and the added vertices may be newly defined.

In the operation of deriving the color information about the added vertices in FIG. 29, the color information about the added vertices may be derived based on the color information about the base layer vertices. For example, to derive the color information about the current added vertex, the color information about a specific number of base layer vertices adjacent to the current added vertex may be weighted and summed, wherein the weight may be inversely proportional to the distance from the current added vertex.

Alternatively, in the operation of deriving the initial geometry information about the added vertices in FIG. 29, the initial geometry information on some axes of the added vertices may be derived based on the geometry information in 3D space of the existing vertices reconstructed from the base layer, and the initial geometry information about the remaining axes may be derived with reference to the geometry image reconstructed from the base layer. The operations of FIG. 29 may be performed as in FIG. 31. The process of FIG. 31 may be performed to derive initial geometry information about each added vertex (vertex 0′ in FIG. 31).

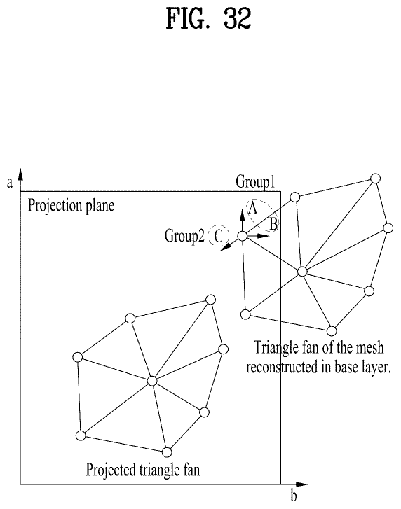

FIG. 32 illustrates an example of axes of a vertex included in groups 1 and 2 according to embodiments.

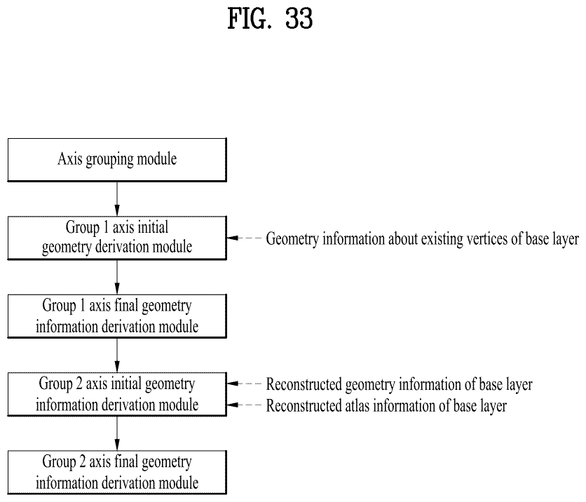

FIG. 33 illustrates a procedure of deriving an added vertex initial geometry and deriving an added vertex final geometry according to embodiments.

The axis grouping module of FIG. 33 may group the axes of the added vertex geometry information into multiple groups, wherein each group may have a different method of deriving the initial geometry information. For example, as shown in FIG. 32, the three axes of the geometry information, A, B, and C, may be grouped into groups 1 (A and B axes) and 2 (C axis). Among the axes, i axes may belong to group 1, and the remaining j axes may belong to group 2 (i+j=the total number of axes in the geometry information about the vertex). The axes included in group 1 may be the two axes parallel to the plane onto which the current triangle fan has been projected in the base layer, and the axis included in group 2 may be the axis perpendicular to the plane. The initial geometry information about the axes included in group 1 may be derived in a 3D domain based on the existing vertex geometry information, and the initial geometry information about the axis included in group 2 may be generated by referencing a geometry image reconstructed in the base layer.

The group 1 axis initial geometry derivation module of FIG. 33 may derive the initial geometry information about the axes included in group 1 (the A and B axes of FIG. 32) among the axes of the added vertex geometry information. The information may be derived by performing the following operations for the axes included in group 1 only. The boundary vertices of the current triangle fan in FIG. 31 may be classified into N groups based on the geometry information, and the center vertices of the respective groups (cp_A, cp_B, and cp_C in FIG. 31) may be derived. The initial geometry information about each added vertex (vertex 0′ in FIG. 31) may be the average of the geometry information about the center vertices of the respective groups and the geometry information about the center vertex of the current triangle fan. Alternatively, the initial geometry information about each added vertex (vertex 0′ in FIG. 31) may be the average of the geometry information about the vertices in each group and the geometry information about the center vertex of the current triangle fan.

The group 1 axis final geometry information derivation module of FIG. 33 may derive the final geometry by summing the residual geometry and the initial geometry information about the group 1 axes of the added vertices. The residual geometry information may be parsed as a value or an index. When parsed as an index, residual geometry information or a residual geometry information group corresponding to the index may be derived.

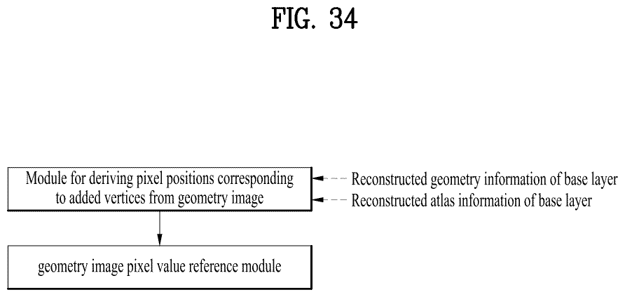

The group 2 axis initial geometry information derivation module of FIG. 33 may derive the initial geometry information about the axis included in group 2 (the C axis of FIG. 32) among the axes of the added vertex geometry information based on the corresponding pixel values in the geometry image. The derivation operation may be performed as illustrated in FIG. 34. A module for deriving pixel positions corresponding to added vertices from the geometry image and a geometry image pixel value correction module may be executed sequentially.

FIG. 34 illustrates a procedure of executing the group 2 axis initial geometry derivation module described in FIG. 33 according to embodiments.

The module for deriving pixel positions corresponding to added vertices from the geometry image of FIG. 34 may derive pixel positions in the geometry image corresponding to the final geometry information about the axes of group 1 of added vertices based on atlas information. The atlas information may include information such as coordinates of the vertices of a bounding box of each 3D patch into which the mesh is split, and coordinates/width/height of the upper left corner of a bounding box of a 2D patch into which the 3D patch is projected as an image (For example, the atlas information may be the same information, may include the same information, and/or may serve the same purpose as the auxiliary patch information in 6. 0. General Point Cloud Compression Processing).

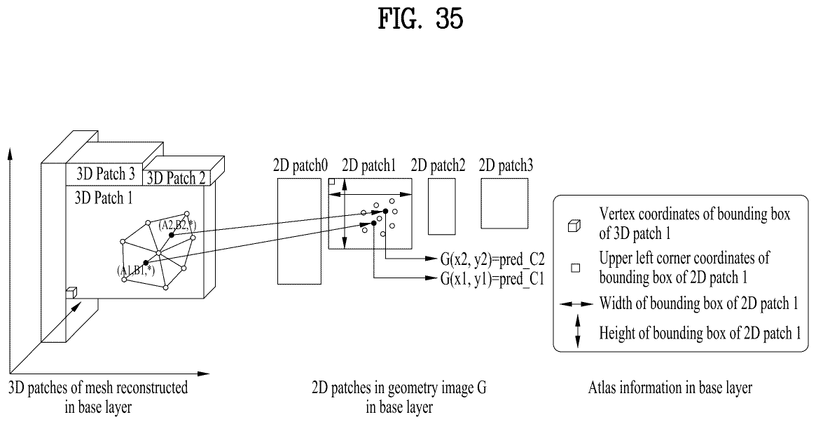

FIG. 35 illustrates a visualization of a procedure of executing the group 2 axis initial geometry derivation module described in FIG. 33 according to embodiments.

FIG. 35 may visualize the execution process, which may be performed as follows. A 2D patch corresponding to the 3D patch containing the current triangle fan may be derived from the geometry image recovered in the base layer. For the leftmost pixel coordinates, width, and height of the 2D patch corresponding to the 3D patch, the atlas information reconstructed in the base layer may be referenced, and the corresponding 2D patch may be derived from the geometry image based on the atlas information. Within the 3D patch, relative values of the axis values of added vertex group 1 (A1, A2, B1, and B2 in FIG. 35) with respect to the axes of group 1 (A and B axes in FIG. 35) may be derived, and pixels corresponding to the relative values may be derived in the 2D patch region. The derived pixels may be G(x1, y1) and G(x2, y2) in FIG. 35.

The geometry image pixel value reference module of FIG. 34 may specify group 2 axis initial geometry information by referencing the values (pred_C1, pred_C2) of the pixels (G(x1, y1) and G(x2, y2) of FIG. 35) derived by the previous module.

The group 2 axis final geometry information derivation module of FIG. 33 may derive the final geometry information by summing the residual geometry with the initial geometry about the group 2 axes of the added vertices. The residual geometry information may be parsed as a value or an index. When parsed as an index, residual geometry information or a residual geometry information group corresponding to the index may be derived.

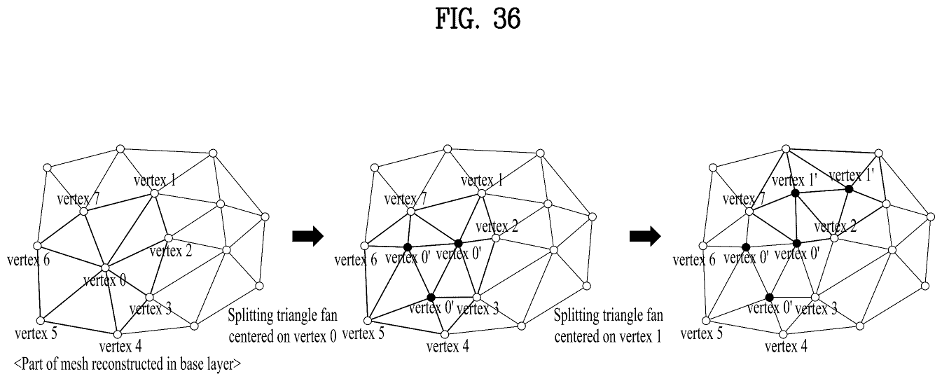

FIG. 36 illustrates an example of traversing multiple triangle fans in a reconstructed mesh and splitting each triangle fan with a triangle fan vertex splitting method according to embodiments.

FIG. 36 may be an example of traversing vertices within a mesh reconstructed in the base layer and splitting a triangle fan centered on the vertices using the “triangle fan vertex splitting method.”

Starting from any vertex within the mesh, all or some of the vertices may be traversed. The vertices traversed may be those reconstructed in the base layer, and the vertices generated by the splitting may not be traversed. The boundary vertices of the triangle fan centered on the traversed vertices may include vertices generated by the splitting.

The vertices may be traversed in the following order. The boundary vertices of the triangle fan currently being split may be stored in a stack in a specific order, and the operation of traversing a vertex stored last in the stack as a next traverse target may be recursively repeated until the stack becomes empty. Alternatively, the reconstructed mesh may be divided into multiple non-overlapping triangle fans and splitting may be performed on the triangle fans in parallel.

Next, a description will be given of a method of splitting triangle fan edges when the submesh is a triangle fan. The method/device according to embodiments may split the edges of the submesh (=triangle fan) as follows.

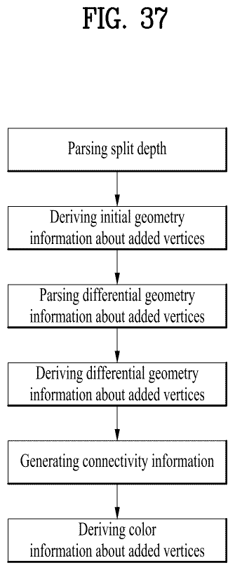

FIG. 37 illustrates the execution of a triangle fan edge splitting method according to embodiments.

According to the “triangle fan edge splitting method,” new vertices may be added by splitting an edge between a center vertex and a boundary vertex of a triangle fan, and the triangle fan may be split by correcting connections between vertices. The operations may be performed as illustrated in FIG. 37. The geometry information about the vertices may be derived based on information obtained by parsing the split depth (split_depth) and the differential coordinates or indices (delta_geometry_idx, delta_geometry_x, delta_geometry_y, delta_geometry_z) of each vertex added by splitting.

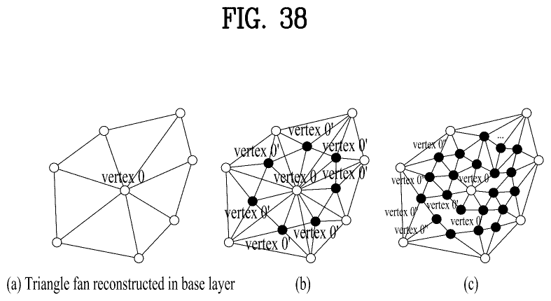

FIG. 38 illustrates an example of splitting a reconstructed triangle fan with a triangle fan edge splitting method according to embodiments.

FIG. 38 may be an example of splitting a reconstructed triangle fan using the “triangle fan edge splitting method,” where (a) may shown an arbitrary triangle fan reconstructed ni the base layer, (b) may be an example of splitting a triangle fan by depth 1 using the “triangle fan edge splitting method,” and (c) may be an example of splitting a triangle fan by depth 2 using the “triangle fan edge splitting method.”

Each of the operations in FIG. 37 may be performed as follows. In the operation of parsing a split depth in FIG. 37, the split depth index (split_depth) may be parsed to derive a depth value by which the current triangle fan is to be split. The operation of splitting the submesh may be repeated as many times as the depth value indicated by split_depth in the operation of deriving initial geometry information about added vertices in FIG. 37. In the operation of deriving initial geometry information about added vertices in FIG. 37, the submesh may be split to derive the initial geometry information about the added vertices generated by the splitting. When split_depth is n, the initial geometry information about the added vertices corresponding to depths 1 to n of the current submesh may be derived. For example, initial geometry information about vertices corresponding to depth 1 may be derived based on the base layer vertices of the current submesh, initial geometry information about depth 2 may be derived based on the base layer vertices and the vertices at depth 1. This process may be repeated until the initial geometry information about depth n is generated. The initial geometry information about the added vertices to be added to depth n may be a weighted average of the geometry information about two neighboring vertices a depth n−1 and the geometry information about a vertex in the base layer, or a weighted average of the geometry information about a vertex at depth n and two neighboring vertices in the base layer. For example, as shown in (b) of FIG. 38, the initial geometry information about a vertex (vertex 0′) to be generated in the depth 1 splitting process may be derived by weighted summation of the geometry information about the center vertex (vertex 0) of the triangle fan and the geometry information about two neighboring vertices at the boundary. For example, as shown in (c) of FIG. 38, the initial geometry information about a vertex (vertex 0”) to be generated during the depth 2 splitting process may be derived by weighted averaging of the geometry information about two neighboring vertices at the base layer boundary and a vertex at depth 1, or by weighted averaging of the geometry information about a vertex in the base layer boundary and two neighboring vertices at depth 1. Depending on the total split_depth of the current triangle fan, the weights to use in the weighted averaging in generating vertices at each depth may be defined. For example, when split_depth=1, the weights for generating added vertices of depth 1 may be 1:1:1. For example, when split_depth=2, the weights for generating added vertices of depth 1 may be 2 (for the center of the submesh): 1 (for boundary vertices): 1 (for boundary vertices), and the weights for generating added vertices of depth 2 may be 1:1:1.

In the operation of parsing differential geometry information about added vertices in FIG. 37, the differential geometry information to be added to the initial geometry information about the added vertices may be parsed. The differential geometry information may be values for the x, y, and z axes (delta_geometry_x, delta_geometry_y, and delta_geometry_z), or may be a bundle of differential geometry information for the three axes represented as an index (delta_geometry_idx). When the index is parsed, the geometry information values corresponding to the index may be derived from a predefined table.

In the operation of deriving the final geometry information about added vertices in FIG. 37, the final geometry information may be derived by summing the initial geometry information about the added vertices and the differential geometry information.

In the operation of generating connectivity information in FIG. 37, the existing connection of the base layer may be removed, and the connectivity between the base layer vertices and the added vertices may be newly defined.

In the operation of deriving the color information about the added vertices in FIG. 37, the color information about the added vertices may be derived based on the color information about the base layer vertices. For example, to derive the color information about the current added vertex, the color information about a specific number of base layer vertices adjacent to the current added vertex may be weighted and summed, wherein the weight may be inversely proportional to the distance from the current added vertex.

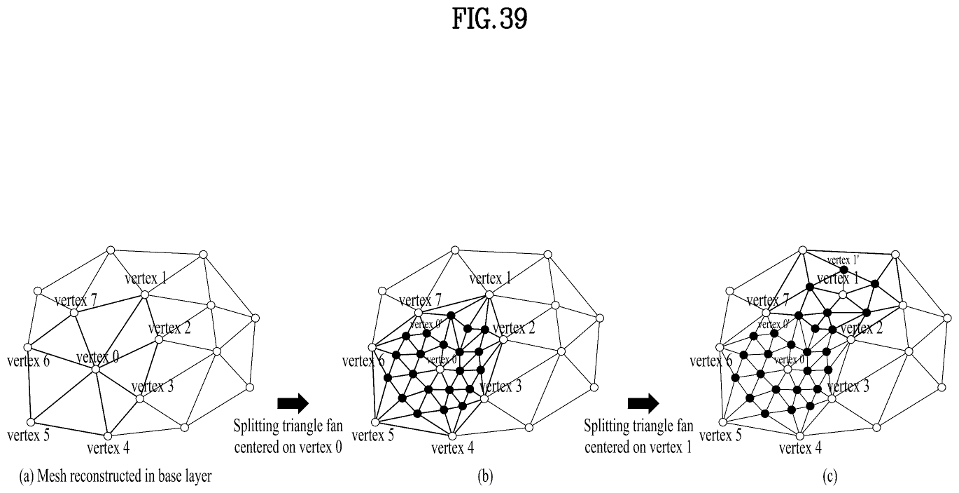

FIG. 39 illustrates an example of traversing multiple triangle fans in a reconstructed mesh and splitting each triangle fan with a triangle fan edge splitting method according to embodiments.

FIG. 39 may be an example of traversing vertices within a mesh reconstructed in the base layer and splitting a triangle fan centered on the vertices using the “triangle fan edge splitting method.”

Starting from any vertex within the mesh, all or some of the vertices may be traversed. The vertices traversed may be those reconstructed in the base layer, and the vertices generated by the splitting may not be traversed. The boundary vertices of the triangle fan centered on the traversed vertices may include vertices generated by the splitting.

The vertices may be traversed in the following order. The boundary vertices of the triangle fan currently being split may be stored in a stack in a specific order, and a vertex stored last in the stack may be traversed as a next traverse target. These operations may be repeated until the stack becomes empty. Alternatively, the reconstructed mesh may be divided into multiple non-overlapping triangle fans and splitting may be performed on the triangle fans in parallel.

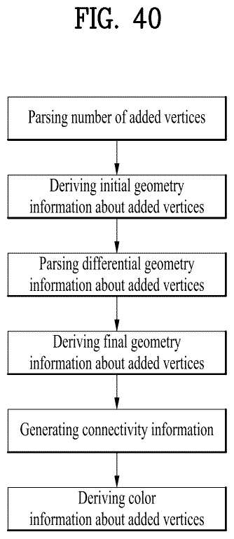

FIG. 40 illustrates a procedure of performing triangle splitting according to embodiments.

When the submesh is a triangle, the method/device according to the embodiments may split the submesh (=triangle).

The triangle splitting method may include splitting a triangle in the reconstructed mesh into multiple triangles and may be carried in a process as illustrated in FIG. 39. The triangles may be split according to triangle splitting methods 1, 2, 3, 4, etc. The splitting method for each triangle may be parsed on a triangle-by-triangle, patch-by-patch, or frame-by-frame basis.

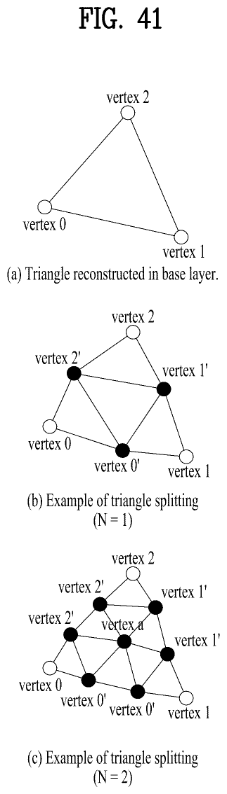

FIG. 41 illustrates an example of splitting a reconstructed triangle with triangle splitting method 1 according to embodiments.

### Triangle Splitting Method 1

In triangle splitting method 1, N vertices may be added to each edge of the triangle and edges connecting the added vertices may be generated to split the triangle. FIG. 41 may illustrate an example of splitting a triangle when N=1 in (b) and N=2 in (c).

In the split depth or number parsing operation of FIG. 40, the number of vertices to add to each edge of the triangle (split_num) may be parsed. split_num may indicate the number or number index of the added vertices. When it indicates the index, a value mapped to the index may be derived from a predefined table.

In the operation of deriving the initial geometry information about the vertices in FIG. 40, the initial geometry information about the N vertices indicated by split_num for each edge and the vertices inside the triangle may be derived. The initial geometry information about the added edge vertices (vertex 0′, vertex 1′, and vertex 2′ in FIG. 21) may be N pieces of geometry information that are evenly spaced between the two vertices of the base layer that are the end vertices of each edge. When the vertices added to each edge are connected, an added vertex (vertex a) may be generated at the intersection of the vertices.

In the operation of parsing differential geometry information about added vertices in FIG. 40, the differential geometry information to be added to the initial geometry information about the added vertices may be parsed. The differential geometry information may be values for the x, y, and z axes (delta_geometry_x, delta_geometry_y, and delta_geometry_z), or may be a bundle of differential geometry information for the three axes represented as an index (delta_geometry_idx). When the index is parsed, the geometry information values corresponding to the index may be derived from a predefined table.

In the operation of deriving the final geometry information about added vertices in FIG. 40, the final geometry information may be derived by summing the initial geometry information about the added vertices and the differential geometry information.

In the operation of generating connectivity information in FIG. 40, the existing connection of the base layer may be removed, and the connectivity between the base layer vertices and the added vertices may be newly defined.

In the operation of deriving the color information about the added vertices in FIG. 40, the color information about the added vertices may be derived based on the color information about the base layer vertices. For example, to derive the color information about the current added vertex, the color information about a specific number of base layer vertices adjacent to the current added vertex may be weighted and summed, wherein the weight may be inversely proportional to the distance from the current added vertex.

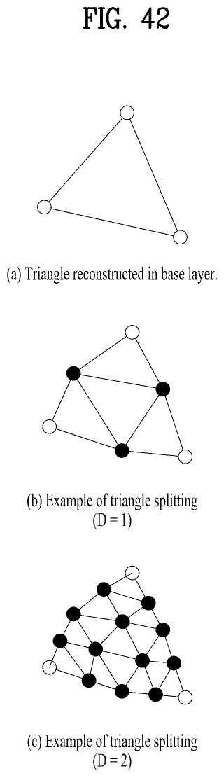

FIG. 42 illustrates an example of splitting a reconstructed triangle with triangle splitting method 2 according to embodiments.

### Triangle Splitting Method 2

In triangle splitting method 2, a triangle may be recursively split as many times as a split depth. In FIG. 42, (b) shows the result of splitting of (a) when D=1, and (c) shows the result of the splitting when D=2. In the operation of deriving initial geometry information about added vertices in FIG. 40, splitting the submesh may be repeated as many times as the depth value indicated by split_depth.

In the operation of deriving initial geometry information about added vertices in FIG. 40, the initial geometry information about added vertices corresponding to depths 1 to D of the current submesh may be derived as much as the value of D indicated by split_depth. For example, the initial geometry information about the vertices corresponding to depth 1 may be derived based on the vertices of the base layer of the current submesh, and the initial geometry information about depth 2 may be derived based on the vertices of the base layer and the vertices of depth 1. This process may be repeated until the initial geometry information about depth D is generated. The initial geometry generation method may be carried out as follows. Each edge of the triangle reconstructed in the base layer may be split at the center to derive the initial geometry information about the added vertices at depth 1. FIG. 42-(b) may show four triangles configured by the added vertices generated at depth 1, base layer vertices, and added vertices. Starting at depth 2, the initial geometry information about the added vertices may be derived by splitting the centers of the edges of all currently existing triangles. In the operation of parsing differential geometry information about added vertices in FIG. 40, the differential geometry information to be added to the initial geometry information about the added vertices may be parsed. The differential geometry information may be values for the x, y, and z axes (delta_geometry_x, delta_geometry_y, and delta_geometry_z), or may be a bundle of differential geometry information for the three axes represented as an index (delta_geometry_idx). When the index is parsed, the geometry information values corresponding to the index may be derived from a predefined table.

In the operation of deriving the final geometry information about added vertices in FIG. 40, the final geometry information may be derived by summing the initial geometry information about the added vertices and the differential geometry information.

In the operation of generating connectivity information in FIG. 40, the existing connection of the base layer may be removed, and the connectivity between the base layer vertices and the added vertices may be newly defined.

In the operation of deriving the color information about the added vertices in FIG. 40, the color information about the added vertices may be derived based on the color information about the base layer vertices. For example, to derive the color information about the current added vertex, the color information about a specific number of base layer vertices adjacent to the current added vertex may be weighted and summed, wherein the weight may be inversely proportional to the distance from the current added vertex.

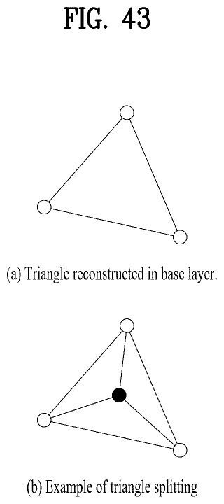

FIG. 43 illustrates an example of splitting a reconstructed triangle with triangle splitting method 3 according to embodiments.

### Triangle Splitting Method 3

Triangle splitting method 3 may add vertices inside the triangle by weighted averaging of the three vertices of the triangle. In FIG. 43, (b) may be the results obtained by deriving the center positions of the three existing vertices in (a) and generating vertices by adding the parsed or derived residual geometry information to the derived positions. The split depth or number parsing operation of FIG. 39 may be skipped. In the operation of deriving the initial geometry information about the added vertices in FIG. 40, the initial geometry information about the added vertices may be derived by weighted averaging of the three vertices of the triangle. The weights used in the weighted averaging may be fixed to a specific value, or may be derived by parsing weight indexes. In the operation of deriving the final geometry information about the added vertices in FIG. 40, the final geometry information may be derived by adding the offsets (delta_geometry_idx, delta_geometry_x, delta_geometry_y, delta_geometry_z) to the initial geometry information about the added vertices.

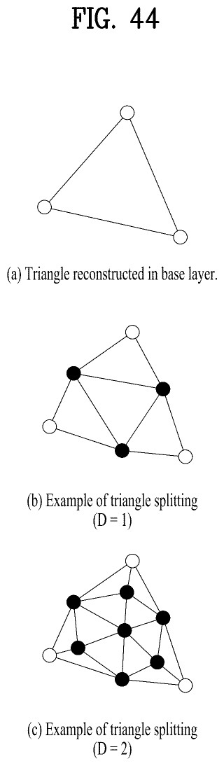

FIG. 44 illustrates an example of splitting a reconstructed triangle with triangle splitting method 4 according to embodiments.

### Triangle Splitting Method 4

In triangle splitting method 4, the total split depth is D, and a different splitting method may be used for splitting at each depth. The split depth or the splitting method at each split depth may be parsed, or a combination of splitting methods may be parsed. Alternatively, the splitting method may be derived in a predetermined way without parsing. In FIG. 44, (b) may be the result of carrying out “triangle splitting method 1” in (a) when D=1, and (c) may be the result of carrying out “triangle splitting method 3” after carrying out “triangle splitting method 1” in (a) when D=2.

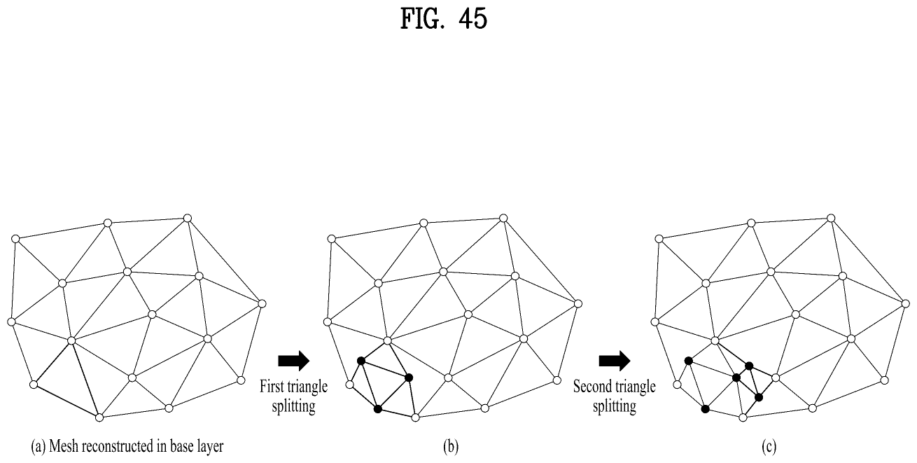

FIG. 45 illustrates an example of traversing multiple triangles in a reconstructed mesh and splitting each triangle with triangle splitting method 2 according to embodiments.

FIG. 45 may be an example of traversing triangles in the mesh reconstructed in the base layer and splitting the triangles using “triangle splitting method 2 (D=1).”

Starting from any triangle in the mesh, all or some triangles may be traversed, and the triangles traversed may be the triangles reconstructed in the base layer, and the triangles generated by the splitting may not be traversed.

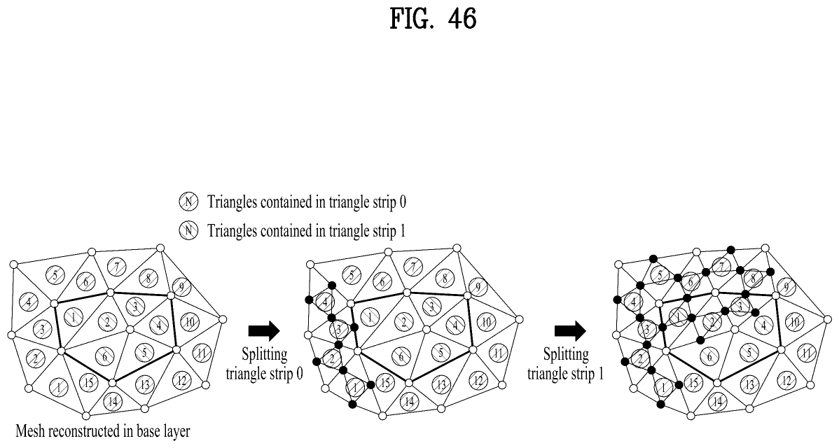

FIG. 46 illustrates an example of traversing multiple triangles in a reconstructed mesh and splitting each triangle with an edge splitting method according to embodiments.

The method/device according to embodiments may construct a submesh composed of triangle strips, and may split the submesh (=triangle strips) as follows.

### Strip Splitting Method (Submesh=Triangle Strips)

According to the strip splitting method, the mesh reconstructed in the base layer may be split into triangle strips. In the case where the reconstructed mesh has been reconstructed on a per triangle strip basis, the splitting may be performed in the order of the reconstructed triangle strips. Alternatively, the reconstructed mesh may be divided into triangle strips by performing a separate addition operation, and the splitting may be performed by traversing the triangle strips in a separate order.

The splitting method may be parsed for each triangle strip or each group of triangle strips. The splitting method may be to split triangles in a triangle strip, and may include triangle splitting method 1, 2, 3, 4, or other methods.

After completing the splitting of each triangle strip, two or more adjacent triangles from different strips may be merged or may be merged and then split.

FIG. 46 may illustrate an example of traversing one or more triangle strips in a reconstructed mesh object or patch and splitting the same with an edge splitting method.

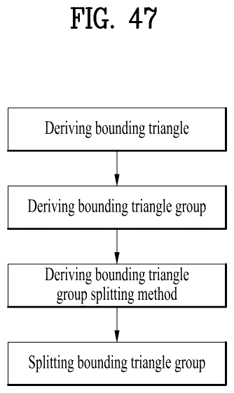

FIG. 47 illustrates the execution of a patch boundary splitting module according to embodiments.

The patch boundary splitting module of FIG. 27 may split a bounding triangle including boundary vertices of two or more patches. The operations may be performed in the same order as in FIG. 47.

In the operation of deriving a bounding triangle in FIG. 47, a bounding triangle may be derived by connecting the base layer vertices from adjacent 3D patches. The three vertices of the bounding triangle may belong to different 3D patches, or two of the vertices may belong to the same 3D patch. The operation of deriving a bounding triangle may be performed as follows. Two adjacent boundary vertices may be selected within any 3D patch, and the vertex that is closest to the selected two vertices may be selected from among the boundary vertices of a 3D patch adjacent to the current 3D patch, thereby deriving a single bounding triangle The next bounding triangle may be derived that shares one edge with the derived bounding triangle and contains the vertex closest to the edge. This process may be repeatedly performed until all bounding triangles are derived.

In the operation of deriving a bounding triangle group in FIG. 47, the bounding triangles of the current mesh object may be grouped into one or more bounding triangle groups. A bounding triangle group may be a group of bounding triangles that have the same combination of indexes of the 3D patches containing the vertices of the bounding triangles. FIG. 427 may illustrate an example of a bounding triangle group. The bounding triangle group may include a single bounding triangle (bounding triangle group 4 in FIG. 47), or multiple bounding triangles in the form of triangle strips (bounding triangle groups 1, 2, and 3 in FIG. 47). Boundary triangle group 1 of FIG. 47 may include the boundary vertices of 3D patch 1 and 3D patch 2, and bounding triangle group 2 may include the boundary vertices of 3D patch 2 and 3D patch 3. Boundary triangle group 3 may include the boundary vertices of 3D patch 1 and 3D patch 3, and bounding triangle group 4 may include the boundary vertices of 3D patch 1, 3D patch 2, and 3D patch 3.

In the operation of deriving a bounding triangle group splitting method in FIG. 47, a triangle-by-triangle splitting method may be derived for each bounding triangle group.

A splitting method index may be parsed per bounding triangle group, and a splitting method may be derived from the index. The splitting method may be one of the triangle splitting methods.

A specific predefined splitting method may be inferred for every bounding triangle group.

The splitting method may be derived by determining a specific condition on a per-bounding triangle group basis. The splitting method may be determined based on the number of vertices included in a triangle in the bounding triangle group. For example, when any triangle in a bounding triangle group includes four vertices, the splitting method may be triangle splitting method 1, 2, or 4. For example, when every triangle in a bounding triangle group includes 3 vertices, the splitting method may be triangle splitting method 3.

In the operation of splitting the bounding triangle group in FIG. 47, the bounding triangle group may be split by the splitting method derived for each bounding triangle group in the previous operation.

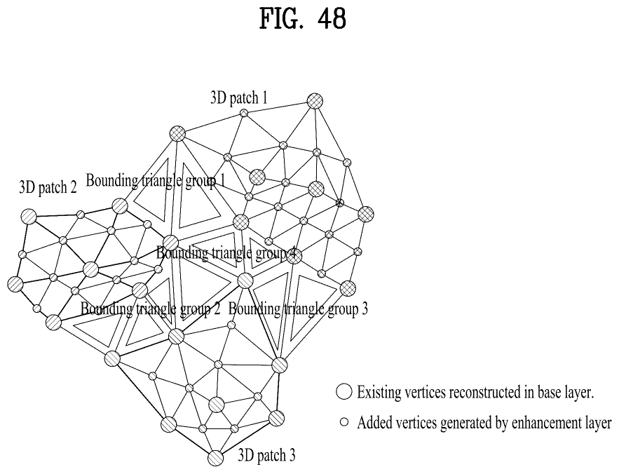

FIG. 48 illustrates an example of bounding triangle groups according to embodiments.

FIG. 48 may illustrate the result of splitting bounding triangle group 2 in FIG. 47 using triangle splitting method 1.

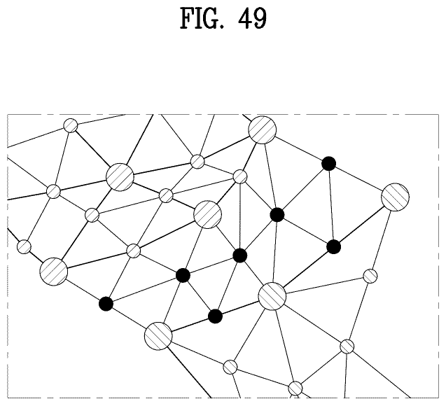

FIG. 49 illustrates an example of a splitting result of bounding triangle group 2 according to embodiments.

As described above, in the case of bounding triangle group 2, bounding triangle group 2 may include the boundary vertices of 3D patch 2 and 3D patch 3.

FIG. 50 illustrates a VPCC bitstream according to embodiments.

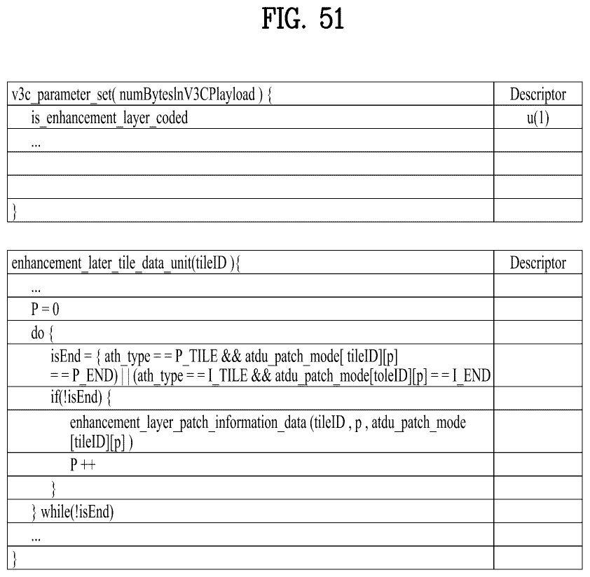

A point cloud data transmission method/device according to embodiments may compress (encode) point cloud data and generate related parameter information (in FIGS. 51 to 53, etc.) to generate and transmit a bitstream as shown in FIG. 50.

A point cloud data reception method/device according to embodiments may receive a bitstream as shown in FIG. 50 and decode point cloud data contained in the bitstream based on parameter information contained in the bitstream.

In the point cloud data transmission device according to the embodiments, the signaling information (which may be referred to as parameters/metadata, etc.) may be encoded by a metadata encoding device (which may be referred to as a metadata encoder, etc.) and transmitted in the bitstream. Further, in the point cloud data reception device according to the embodiments, it may be decoded by a metadata decoding device (which may be referred to as a metadata decoder or the like) and provided to a process of decoding the point cloud data.

A transmitter according to embodiments may encode the point cloud data to generate a bitstream.

The bitstream according to the embodiments may contain V3C units.

A receiver according to embodiments may receive the bitstream transmitted by the transmitter, and decode and reconstruct the point cloud data. Hereinafter, a specific syntax of the V3C unit and the elements included in the V3C unit according to embodiments are described.

The bitstream according to embodiments may carry a syntax related to whether to perform and transmit enhancement layer encoding to perform scalable mesh encoding/decoding, mesh split information per tile reconstructed in the base layer, mesh split information per patch, and mesh split information transmitted per submesh in a patch.

FIG. 51 illustrates a V3C parameter set and enhancement layer tile data unit according to embodiments.

is_enhancement_layer_coded: may indicate whether the current frame or sequence is to be subjected to the enhancement layer encoding and transmitted.

The V3C parameter set according to embodiments may further include the following elements.

vps_v3c_parameter_set_id provides an identifier for the V3C VPS for reference by other syntax elements.

vps_atlas_count_minus1+1 indicates the total number of atlases supported in the current bitstream.

vps_atlas_id[k] indicates the ID of the atlas with index k.

vps_frame_width[j] indicates the atlas frame width in integer luma samples for the atlas with the atlas ID of j.

vps_frame_height[j] indicates the atlas frame height in integer luma samples for the atlas with the atlas ID of j.

vps_map_count_minus1[j]+1 indicates the number of maps used to encode geometry and attribute data for the atlas with the atlas ID of j.

vps_multiple_map_streams_present_flag[j] equal to 0 indicates that all geometry or attribute maps for the atlas with atlas ID j are each placed in a single geometry or attribute video stream. vps_multiple_map_streams_present_flag[j] equal to 1 indicates that all geometry or attribute maps for the atlas with the atlas ID of j are placed in separate video streams.

vps_map_absolute_coding_enabled_flag[j][i] equal to 1 indicates that geometry maps with index i for the atlas with the atlas ID of j are coded without any form of map prediction. vps_map_absolute_coding_enabled_flag[j][i] equal to 0 indicates that the geometry map with index i for the atlas with the atlas ID of j is first predicted from another initial coding map prior to coding.

vps_map_predictor_index_diff[j][i] is used to compute the predictor of the geometry map with index i for the atlas with the atlas ID of j when vps_map_absolute_coding_enabled_flag[j][i] is equal to 0.

vps_auxiliary_video_present_flag[j] equal to 1 indicates that auxiliary information about a patch in the atlas with the atlas ID of j, namely, information related to the RAW or EOM patch type, may be stored in a separate video stream, called an auxiliary video stream. vps_auxiliary_video_present_flag[j] equal to 0 indicates that auxiliary information about a patch in the atlas with the atlas ID of j, namely, information related to the RAW or EOM patch type, is not stored in the auxiliary video stream.

vps_occupancy_video_present_flag[j] equal to 0 indicates that the atlas with the atlas ID of j does not have any related occupancy video data. vps_occupancy_video_present_flag[j] equal to 1 indicates that the atlas with the atlas ID of j should have related occupancy video data.

vps_geometry_video_present_flag[j] equal to 0 indicates that the atlas with the atlas ID of j does not have any related geometry video data. vps_geometry_video_present_flag[j] equal to 1 indicates that the atlas with the atlas ID of j should have related geometry video data.

vps_attribute_video_present_flag[j] equal to 0 indicates that the atlas with the atlas ID of j does not have any related attribute video data. vps_attribute_video_present_flag[j] equal to 1 indicates that the atlas with the atlas ID of j should have at least one related video data attribute.

The bitstream may contain a data unit per tile ID. The data unit per tile ID may include an enhancement layer tile data unit.

ath_type: May indicate the coding type (P_TILE, I_TILE) of an atlas tile. For example, it may indicate a p-type tile or an i-type tile.

atdu_patch_mode[tileID][p]: May indicate a patch mode related to an atlas tile data unit.

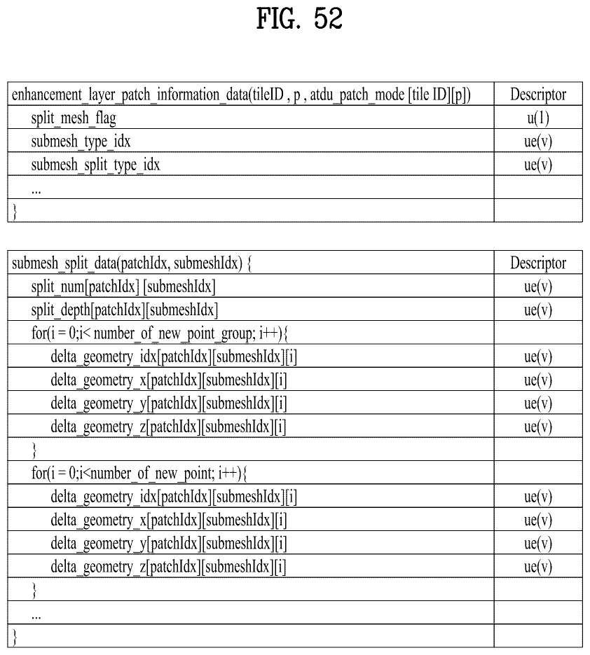

FIG. 52 illustrates enhancement layer patch information data and submesh split data according to embodiments.

A bitstream may contain enhancement layer patch information data based on a tile ID and/or patch index. The enhancement layer patch information data may include the following elements

split_mesh_flag: May indicate whether the mesh in the current patch is split.

submesh_type_idx: May indicate the submesh type index of the current patch.

submesh_split_type_idx: May indicate the submesh split type index of the current patch.

The bitstream may contain submesh split data based on the patch index and/or submesh index. The submesh split data may include the following elements

num[patchIdx][submeshIdx]: May indicate the number of vertices added when a submesh is split.

split_depth[patchIdx][submeshIdx]: May indicate the depth of the submesh split.

delta_geometry_idx[patchIdx][submeshIdx][i]: May indicate the geometry offset index of the added vertex.

delta_geometry_x[patchIdx][submeshIdx][i]: May indicate the x-axis geometry offset of the added vertex.

delta_geometry_y[patchIdx][submeshIdx][i]: May indicate the y-axis geometry offset of the added vertex.

delta_geometry_z[patchIdx][submeshIdx][i]: May indicate the z-axis geometry offset of the added vertex.

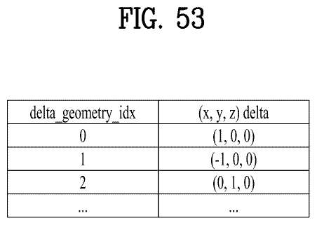

FIG. 53 shows (x, y, z) delta values for each delta geometry index according to embodiments.

The delta values for (x, y, z) may be represented as coordinates for each delta geometry index.

FIG. 54 illustrates a point cloud data transmission device according to embodiments.

FIG. 54 illustrates a point cloud data transmission method/device according to embodiments, corresponding to the transmission device 10000, the point cloud video encoder 10002, the file/segment encapsulator 10003 of FIG. 1, the encoder of FIG. 3, the encoder of FIG. 15, the transmission device of FIG. 18, the XR device 2030 of FIG. 20, the point cloud data encoder for mesh data of FIG. 21, the scalable mesh encoder of FIG. 23, and the like.

Based on the network situation between the transmitting and receiving ends, the environment of the receiving end (such as the computation/memory performance of the reception device), or the consumption setting at the receiving end (such as the resolution setting of the content consumption application), the decoder may determine whether to reconstruct the enhancement layer for the current frame or sequence.

When the reconstruction status is determined to be TRUE, the enhancement layer may be mandatorily encoded and transmitted by the encoder. When the reconstruction status is determined to be FALSE, the enhancement layer may or may not be encoded and transmitted by the encoder. Whether the enhancement layer is encoded and transmitted (is_enhancement_layer_coded) may be transmitted in v3c_parameter_set, a parameter set that is transmitted on a per sequence or frame basis.

The original 3D mesh data input to the transmitter is simplified to a low-resolution mesh, and is subdivided into basic units called patches based on a reference including characteristics information about the mesh of the points through the V-PCC encoding process. The patches are then appropriately patch-packed into 2D image regions. For the arrangement of the patches in the 2D image, is shown in FIG. 54, the depth information and texture information about the patches are compressed and transmitted to the vertex occupancy map generator in the vertex geometry image and vertex color image, respectively. The vertex occupancy map image, vertex geometry image, and vertex color image may have different resolutions, and may be compressed in different ways using different video codecs. The connectivity information is encoded by a separate encoder and transmitted in a bitstream along with the result of compression of the existing vertex occupancy map image, vertex geometry image, and vertex color image. The mesh split information deriver of the enhancement layer may derive mesh split information for the purpose of reducing the difference of a high-resolution mesh generated by splitting the reconstructed mesh in the base layer from the original mesh. Then, the mesh split information (enhancement_layer_tile_data_unit) syntax is transmitted per tile reconstructed in the base layer, and the per-patch mesh split information function (enhancement_layer_patch_information_data) is performed in the same patch order as when parsing the atlas information about the patches in the base layer. A tile described above may be a unit of parallel decoding when the vertex occupancy map, vertex color image, and vertex geometry image are decoded. Tiles may have a rectangular shape generated by splitting the image along the width and height directions. Multiple 2D patches may be present in a tile, and the region of a 2D patch may be included in a tile.

In the per-patch split information syntax, data may be transmitted that derives information such as whether the reconstructed low-resolution mesh is subjected to mesh splitting on a per-patch basis (split_mesh_flag), the submesh type of the current patch (submesh_type_idx), and the submesh split type (submesh_split_type_idx).

In addition, to split a submesh, one or more vertices may be added in the submesh and the connectivity between the vertices may be newly defined. In splitting a submesh, the number of vertices added (split_num) or the split depth (split_depth) may be determined. Also, the offset values on the x, y, and z axes (delta_geometry_x, delta_geometry_y, delta_geometry_z) or an offset index (delta_geometry_idx) may be determined in order to reduce the difference of the high-resolution mesh generated by newly defining the connections between the added vertices and the existing vertices from the original mesh. Then, the syntax of mesh split information (Submesh_split_data) may be transmitted per submesh in the patch.

The enhancement layer bitstream containing the mesh split information is transmitted to the multiplexer and transmitted to the receiver through the transmitter as a single bitstream along with the compressed bitstreams in the base layer.

The transmission device (encoder) may include a scalable mesh encoder. The scalable mesh encoder may encode the point cloud data into low- and high-resolution meshes based on a base layer and an enhancement layer.

In the base layer, the low-resolution mesh is encoded. The low-resolution mesh includes vertex geometry information, vertex color information, and connectivity information. A 3D patch generator receives the vertex geometry information and vertex color information and generates 3D patches. A patch packer packs the patches. An auxiliary information encoder encodes auxiliary information related to the patches to generate an auxiliary information bitstream. A vertex occupancy map generator receives matching information and generates a vertex occupancy map, and a vertex occupancy map encoder encodes the generated vertex occupancy map and generates an occupancy map bitstream. A vertex color image generator receives patch information and generates a vertex color image, and a vertex color image encoder encodes the generated vertex color image and generates a color information bitstream. A vertex geometry generator receives patch information and generates a vertex geometry image, and a vertex geometry encoder encodes the generated vertex geometry image and generates a geometry information bitstream. A connectivity corrector corrects the connectivity information, and a connectivity patch constructor constructs a connectivity patch based on the generated patches. A connectivity encoder encodes the connectivity information, and a vertex index mapping information generator generates vertex index mapping information and generates a connectivity information bitstream. A vertex geometry information decoder may receive auxiliary information and a vertex geometry image and reconstruct geometry information. A base layer mesh reconstructor may receive an occupancy map, color information, auxiliary information, geometry information, and connectivity information, and may reconstruct the mesh for the base layer and deliver the same to the enhancement layer.

At the enhancement layer, upon receiving the original mesh, a mesh split information deriver generates an enhancement layer bitstream based on the reconstructed mesh of the base layer. The enhancement layer bitstream and the auxiliary information bitstream may be multiplexed to generate a multi-layer bitstream.

FIG. 55 illustrates a point cloud data reception device according to embodiments.

FIG. 55 deriver a point cloud data reception method/device according to embodiments, corresponding to the reception device 10005, the receiver 10006, the file/segment decapsulator 10007, the point cloud video decoder 10008, the renderer 10009 of FIG. 1, the decoder of FIG., the decoder of FIG. 17, the reception device of FIG. 19, the XR device 2030 of FIG. 20, the point cloud data decoder for mesh data of FIG. 22, the scalable mesh decoder of FIGS. 26, 27, 29, 33, 34, and 35, and the like.

The is_enhancement_layer_coded in the v3c_parameter_set may be parsed from the received multilayer bitstream to determine whether the enhancement layer is to be reconstructed in the current frame or sequence. Then, the bitstream be demultiplexed to auxiliary information, geometry information, color information, normal information, connectivity information, and mesh split information bitstreams by a demultiplexer. According to the semantics of the syntax of Is_enhancemet_layer_coded, when there is no enhancement layer information transmitted or decoded, the mesh reconstructed by the mesh reconstructor of the base layer becomes the final reconstructed mesh data; when the enhancement layer information is transmitted and decoded, the reconstructed low-resolution mesh is transmitted to the mesh splitter and the operation of reconstructing a high-resolution mesh is performed.

At the base layer, vertex geometry information and vertex color information may be reconstructed based on the vertex occupancy map, auxiliary information, geometry image, color image, normal information, and connectivity information. Reconstructed low-resolution mesh data may be acquired based on the reconstructed geometry information, color information, normal information, and reconstructed connectivity information.

When a high-resolution mesh is reconstructed, the mesh splitter reconstructs a high-resolution mesh from the low-resolution mesh reconstructed in the base layer by referencing the decoded mesh split information.

The mesh splitting status parsing module of the mesh splitter may perform mesh splitting on a per frame basis or a per 3D vertex patch basis by referencing split_mesh_flag in the enhancement_layer_patch_information_data function. The submesh type parsing module of the mesh splitter may set the type of submesh (triangle, triangle fan, triangle strip, etc.) by referencing submesh_type_idx. In addition, the submesh splitting method parsing module may set a triangle splitting method (triangle fan vertex/edge splitting, triangle splitting, etc.) according to the submesh by referencing submesh_split_type_idx.

The reconstructed low-resolution mesh is split according to the submesh type and submesh splitting method set as described above, and each submesh splitting module performs submesh splitting by parsing the submesh_split_data( ) function and referencing the mesh split information transmitted per submesh in the patch.

In parsing the number of added vertices by the submesh splitting module, a value or index (split_num) indicating the number of vertices to split the center vertex into may be parsed. Here, when split_num is parsed as an index, the value corresponding to the index may be derived from a predefined table.

Also, depending on the submesh splitting method, added vertex initial geometry information may be derived based on the split depth information about how many times the submesh splitting is performed, through the split_depth information instead of split_num.

In parsing added vertex differential geometry information by the submesh splitting module, the differential geometry information about the added vertices may be obtained as offset values for the x, y, and z axes by referencing delta_geometry_x, delta_geometry_y, and delta_geometry_z. Alternatively, the bundle of the differential geometry information about the three axes may be represented as an index (delta_geomtery_idx).

The final geometry information may be derived by summing the differential geometry information with the previously derived initial geometry information about the added vertices. Then, by reconfiguring the connectivity information with the final geometry information and deriving the color information about the added vertices based on the base layer color information, the submesh splitting is completed. Final mesh data may be reconstructed from the high-resolution mesh obtained by the splitting, through a surface color reconstruction operation.

The reception device (decoder) may include a scalable mesh decoder. The scalable mesh decoder may receive a multi-layer bitstream, parse whether the enhancement layer is to be reconstructed, and extract the bitstream of the layer to be reconstructed. Bitstreams for the base layer and the enhancement layer may be extracted, respectively.

In the base layer, the auxiliary information decoder may receive an auxiliary information bitstream and decode auxiliary information. The geometry image 2D video decoder may receive a geometry information bitstream and decode a reconstructed geometry image. The color image 2D video decoder may receive a color information bitstream and decode a reconstructed color image. The normal information decoder may receive a normal information bitstream and decode reconstructed normal information. The connectivity decoder may receive a connectivity information bitstream and decode connectivity information, and the vertex index mapper may generate reconstructed connectivity information. The vertex geometry information and vertex color information reconstructor may generate reconstructed geometry information and reconstructed color information from the geometry image and color image based on the auxiliary information. The vertex sorter may sort the vertices in order, and the mesh reconstructor may reconstruct a low-resolution mesh based on the order of the sorted vertices, normal information, and connectivity information.

In the enhancement layer, the mesh split information bitstream may be received, and the reconstructed low-resolution mesh may be received. Then, a high-resolution mesh reconstructed by the mesh splitter may be generated, surface colors may be reconstructed, and reconstructed mesh data may be generated.

A conventional mesh compression structure encodes the mesh frame input to the encoder into one bitstream according to the quantization rate. Therefore, there is a limitation that when a pre-compressed mesh frame is to be transmitted, the mesh frame having a bitrate (or image quality) determined by the encoding should be transmitted or transcoded to a desired bitrate for transmission, regardless of the network situation or the resolution of the reception device. In addition, when the mesh frame is encoded at multiple bitrates and stored in order to variably adjust the transmission amount of the mesh frame, the memory capacity required for storage and the encoding time are greatly increased. Therefore, the present disclosure may provide a scalable mesh compression structure in which a low-resolution mesh is reconstructed at a base layer and a high-resolution mesh is reconstructed by receiving split information at the enhancement layer, as a method to variably adjust the transmission amount of the encoded frame while minimizing the above-described disadvantages.

By proposing a scalable transmission structure of the mesh, the data transmission amount and image quality may be adapted to the network bandwidth and user requirements for transmission. In addition, a streaming service with a constant frame rate (fps) may be provided by variably adjusting the bitrate per frame even in a situation where the network environment is unstable.

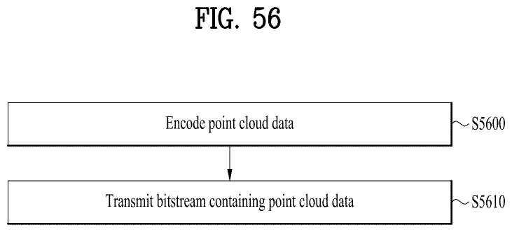

FIG. 56 illustrates a method of transmitting point cloud data according to embodiments.

The transmission method of FIG. 56 may be carried out by the transmission device 10000, the point cloud video encoder 10002, the file/segment encapsulator 10003 of FIG. 1, the encoder of FIG. 3, the encoder of FIG. 15, the transmission device of FIG. 18, the XR device 2030 of FIG. 20, the point cloud data encoder for mesh data of FIG. 21, the scalable mesh encoder of FIG. 23, the bitstream generation of of FIGS. 50 to 52, the scalable mesh encoder of FIG. 54, and the like.

S5600: The method of transmitting point cloud data according to the embodiments may include encoding point cloud data.

The encoding operation according to the embodiments may include the encoding operations of the transmission device 10000, the point cloud video encoder 10002, the file/segment encapsulator 10003 of FIG. 1, the encoder of FIG. 3, the encoder of FIG. 15, the transmission device of FIG. 18, the XR device 2030 of FIG. 20, and the like. Further, it may include bitstream generation according to the operations of the mesh encoding of FIG. 21, the scalable mesh encoding of FIG. 23, the bitstream generation of FIG. 50, the parameter generation of FIGS. 51 to 53, and the encoding of FIG. 54.

S5610: The method of transmitting point cloud data according to the embodiments may further include transmitting a bitstream containing the point cloud data.

The transmitting operation according to the embodiments may include the bitstream transmission operations of the transmission device 10000, the point cloud video encoder 10002, the file/segment encapsulator 10003 of FIG. 1, the encoder of FIG. 3, the encoder of FIG. 15, the transmission device of FIG. 18, the XR device 2030 of FIG. 20, and the like, and may include transmitting the bitstream according to the operations of the mesh encoding of FIG. 21, the scalable mesh encoding of FIG. 23, the bitstream generation of FIG. 50, the parameter generation of FIGS. 51 to 53, and the encoding of FIG. 54.

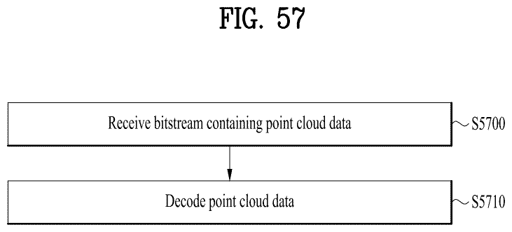

FIG. 57 illustrates a method of receiving point cloud data according to embodiments.

The reception method of FIG. 57 may be carried out by the reception device 10005, the receiver 10006, the file/segment decapsulator 10007, the point cloud video decoder 10008, the renderer 10009 of FIG. 1, the decoder of FIG., the decoder of FIG. 17, the reception device of FIG. 19, the XR device 2030 of FIG. 20, the point cloud data decoder for mesh data of FIG. 22, the scalable mesh decoder of FIGS. 26, 27, 29, 33, 34, and 35, the bitstream parsing of FIGS. 50 to 52, the scalable mesh decoder of FIG. 55, and the like.

S5700: The method of receiving point cloud data according to the embodiments may include receiving a bitstream containing point cloud data.

The receiving operation according to the embodiments may include the bitstream reception operation of the reception device 10005, the receiver 10006, the file/segment decapsulator 10007, the point cloud video decoder 10008, the renderer 10009 of FIG. 1, the decoder of FIG., the decoder of FIG. 17, the reception device of FIG. 19, the XR device 2030 of FIG. 20, and the like. It may also include the bitstream reception operations of the point cloud data decoder for mesh data of FIG. 22, the scalable mesh decoder of FIGS. 26, 27, 29, 33, 34, and 35, and the like, wherein the bitstream parsing (reception) of FIGS. 50 to 52 may be performed. It may also include the bitstream operations of the scalable mesh decoder of FIG. 55.

S5710: The method of receiving point cloud data according to the embodiments may further include decoding the point cloud data.

The decoding operation according to embodiments may include decoding the data contained in the bitstream by the reception device 10005, the receiver 10006, the file/segment decapsulator 10007, the point cloud video decoder 10008, the renderer 10009 of FIG. 1, the decoder of FIG., the decoder of FIG. 17, the reception device of FIG. 19, the XR device 2030 of FIG. 20, and the like. It may also include the bitstream parsing and data decoding operations of the point cloud data decoder for mesh data of FIG. 22, the scalable mesh decoder of FIGS. 26, 27, 29, 33, 34, and 35, and the like, wherein parameters included in the bitstream of FIGS. 50 to 53 may be decoded. It may also include the decoding operations of the scalable mesh decoder of FIG. 55.

Referring to FIG. 1, the transmission method may include: encoding point cloud data, and transmitting a bitstream containing the point cloud data.

Referring to FIGS. 23 and 24, regarding the scalable mesh encoder (base layer/enhancement layer), the encoding of the point cloud data may include encoding a low-resolution mesh data of mesh data in the point cloud data in a base layer, and encoding a high-resolution mesh data of the mesh data in the point cloud data in an enhancement layer.

Referring to FIGS. 51 to 53, regarding the parameters is_enhancement_layer_coded, split_mesh_flag, submesh_type_idx, submesh_split_type_idx, split_num, split_depth, and the like, the bitstream may contain information related to an encoding operation for the enhancement layer, information indicating whether to split the mesh data, information related to a type of a submesh, information related to a split type of the submesh, information related to a number of added vertices related to splitting of the submesh, information related to a depth related to the splitting of the submesh, and offset information related to geometry information about the added vertices.

The method of transmitting the point cloud data may be performed by a transmission device. The transmission device may include an encoder configured to encode point cloud data, and a transmitter configured to transmit a bitstream containing the point cloud data.

A reception method may correspond to the point cloud data transmission method. The method may include corresponding operations and/or reverse operations to those of the transmission method. The reception method may include receiving a bitstream containing point cloud data; and decoding the point cloud data.

Referring to FIG. 26, regarding the scalable mesh decoding, the decoding of the point cloud data may include decoding a low-resolution mesh data of mesh data in the point cloud data in a base layer, and decoding a high-resolution mesh data of the mesh data in the point cloud data in an enhancement layer.

Referring to FIGS. 27 and 28, regarding the mesh splitter, the decoding of the point cloud data may further include reconstructing, in the enhancement layer, high-resolution mesh data from a reconstructed low-resolution mesh data based on mesh split information. The reconstructing may include splitting the reconstructed low-resolution mesh data into submeshes based on at least one of information indicating whether to split the mesh data contained in the bitstream, information related to a type of the submeshes, or information related to a split type of the submeshes.

Referring to FIGS. 29 to 36, regarding splitting of a submesh (=triangle fan), the splitting into the submeshes may include, based on the submeshes being triangle fans, splitting the reconstructed low-resolution mesh data into submeshes based on at least one of information related to a number of added vertices related to the splitting into the submeshes, or offset information related to geometry information about the added vertices, wherein the information may be contained in the bitstream.

Referring to FIGS. 37 to 39, regarding splitting of the submesh (=triangle fan) edge, the splitting into the submeshes may include generating connectivity information related to the reconstructed low-resolution mesh data based on information indicating a depth related to the splitting into the submeshes, the information being contained in the bitstream.

Referring to FIGS. 40 and 41, regarding the submesh splitting (=triangle1) and the related parameters split_num, delta_geometry_x, delta_geometry_y, delta_geometry_z, and the like, the splitting into the submeshes may include, based on the submeshes being triangles, adding vertices to the edges of the triangles based on information related to a number of the added vertices contained in the bitstream, generating initial geometry information about the added vertices, and generating geometry information from the initial geometry based on offset information related to the geometry information about the added vertices, the offset information being contained in the bitstream.

Referring to FIGS. 40 and 42, regarding the submesh splitting (=triangle2) and the related parameters split_depth, delta_geometry_x, delta_geometry_y, delta_geometry_z, and the like, the splitting into the submeshes may include, based on the submeshes being triangles, splitting the submeshes based on split depth information about the submeshes contained in the bitstream, and generating geometry information based on offset information related to the geometry information about added vertices contained in the bitstream.

Referring to FIGS. 40 and 43, regarding the submesh splitting (=triangle3) and the related parameters split_depth, delta_geometry_x, delta_geometry_y, delta_geometry_z, and the like, the splitting into the submeshes may include, based on the submeshes being triangles, generating vertices based on an average of the triangles, and generating geometry information based on offset information related to the geometry information about added vertices contained in the bitstream.

Referring to FIG. 45, regarding submesh splitting (=triangle strip), the splitting into the submeshes may include, based on the submeshes being triangle strips, splitting triangles contained in the triangle strips.

Referring to FIG. 47, regarding performing patch boundary splitting, the decoding of the point cloud data may further include splitting triangles related to boundaries of the split submeshes.

The method of receiving the point cloud data may be performed by a reception device. The reception device may include a receiver configured to receive a bitstream containing point cloud data; and a decoder configured to decode the point cloud data.

Accordingly, an issue related to a conventional mesh compression structure may be addressed. In other words, a mesh frame input to the encoder may not be encoded into a single bitstream depending on a quantization rate. The disclosure may address the limitation that a mesh frame with a bitrate (or image quality) determined by the encoding should be transmitted regardless of the network situation or the resolution of the reception device when a pre-compressed mesh frame is to be transmitted. Alternatively, the limitation of transmitting mesh frames may be addressed by performing transcoding at a desired bitrate. Furthermore, the disadvantage of significantly increasing the memory capacity and encoding time required for storage when the mesh frames are stored by encoding the respective mesh frames merely at multiple bitrates as a method for varying the amount of mesh frames to be transmitted may be addressed. Thus, embodiments may provide a scalable mesh compression structure as a method for variably adjusting the amount of encoded frames to be transmitted while minimizing the above-described disadvantages.

According to embodiments, a scalable mesh structure may be used. Thus, a low-resolution mesh may be reconstructed in a base layer, and a high-resolution mesh may be reconstructed by receiving mesh split information in an enhancement layer. The enhancement layer may parse the mesh splitting method on a patch-by-patch basis, and perform mesh splitting on a per triangle fan, per triangle strip, or per triangle basis in a patch. By proposing a scalable transmission structure of the mesh, the data transmission amount and image quality may be adapted to the network bandwidth and user requirements for transmission. Accordingly, a streaming service with a constant frame rate (fps) may be provided by adjusting the bitrate per frame even in a situation where the network environment is unstable.

A low- and/or high-resolution of the current point cloud decoder may be selected by the decoder, and the occupancy, geometry, and attributes may be scalably encoded and decoded. Further, according to embodiments, the original mesh data may be simplified into a low-resolution mesh to be encoded. In other words, a high-resolution mesh may be reconstructed by splitting the reconstructed mesh in the base layer.

The embodiments have been described in terms of a method and/or a device. The description of the method and the description of the device may complement each other.

Although embodiments have been described with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may also fall within the scope of the appended claims and their equivalents. The devices and methods may not be limited by the configurations and methods of the embodiments described above. The embodiments described above may be configured by being selectively combined with one another entirely or in part to enable various modifications. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/“and”,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.” Further, in the document, the term “or” should be interpreted as “and/or.” For instance, the expression “A or B” may mean 1) only A, 2) only B, and/or 3) both A and B. In other words, the term “or” in this document should be interpreted as “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise.

The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or a combination thereof. The firmware, software, and/or a combination thereof may be stored in the processor or the memory.

As described above, related details have been described in the best mode for carrying out the embodiments.

As described above, the embodiments are fully or partially applicable to a point cloud data transmission/reception device and system.

Those skilled in the art may change or modify the embodiments in various ways within the scope of the embodiments.

Embodiments may include variations/modifications within the scope of the claims and their equivalents.

1. A method of transmitting point cloud data, the method comprising:
encoding point cloud data; and
transmitting a bitstream containing the point cloud data.

2. The method of claim 1, wherein the encoding of the point cloud data comprises:
encoding a low-resolution mesh data of mesh data in the point cloud data in a base layer, and
encoding a high-resolution mesh data of the mesh data in the point cloud data in an enhancement layer.

3. The method of claim 2, wherein the bitstream contains:
information related to an encoding operation for the enhancement layer;
information indicating whether to split the mesh data;
information related to a type of submeshes;
information related to a split type of the submeshes;
information related to a number of added vertices related to splitting of the submeshes;
information related to a depth related to the splitting of the submeshes; and
offset information related to geometry information about the added vertices.

4. A device for transmitting point cloud data, the device comprising:
an encoder configured to encode point cloud data; and
a transmitter configured to transmit a bitstream containing the point cloud data.

5. A method of receiving point cloud data, the method comprising:
receiving a bitstream containing point cloud data; and
decoding the point cloud data.

6. The method of claim 5, wherein the decoding of the point cloud data comprises:
decoding a low-resolution mesh data of mesh data in the point cloud data in a base layer, and
decoding a high-resolution mesh data of the mesh data in the point cloud data in an enhancement layer.

7. The method of claim 6, wherein the decoding of the point cloud data further comprises:
reconstructing, in the enhancement layer, high-resolution mesh data from a reconstructed low-resolution mesh data based on mesh split information,
wherein the reconstructing comprises:
splitting the reconstructed low-resolution mesh data into submeshes based on at least one of:
information indicating whether to split the mesh data contained in the bitstream;
information related to a type of the submeshes; or
information related to a split type of the submeshes.

8. The method of claim 7, wherein the splitting into submeshes comprises:
based on the submeshes being triangle fans, splitting the reconstructed low-resolution mesh data into submeshes based on at least one of:
information related to a number of added vertices related to the splitting into the submeshes; or
offset information related to geometry information about the added vertices,
wherein the information may be contained in the bitstream.

9. The method of claim 7, wherein the splitting into the submeshes comprises:
generating connectivity information related to the reconstructed low-resolution mesh data based on information indicating a depth related to the splitting into the submeshes, the information being contained in the bitstream.

10. The method of claim 7, wherein the splitting into the submeshes comprises:
based on the submeshes being triangles, adding vertices to the edges of the triangles based on information related to a number of the added vertices contained in the bitstream;
generating initial geometry information about the added vertices; and
generating geometry information from the initial geometry based on offset information related to the geometry information about the added vertices, the offset information being contained in the bitstream.

11. The method of claim 7, wherein the splitting into the submeshes comprises:
based on the submeshes being triangles, splitting the submeshes based on split depth information about the submeshes contained in the bitstream; and
generating geometry information based on offset information related to the geometry information about added vertices contained in the bitstream.

12. The method of claim 7, wherein the splitting into the submeshes comprises:
based on the submeshes being triangles, generating vertices based on an average of the triangles; and
generating geometry information based on offset information related to the geometry information about added vertices contained in the bitstream.

13. The method of claim 7, wherein the splitting into the submeshes comprises:
based on the submeshes being triangle strips, splitting triangles contained in the triangle strips.

14. The method of claim 7, wherein the decoding of the point cloud data further comprises:
splitting triangles related to boundaries of the split submeshes.

15. A device for receiving point cloud data, comprising:
a receiver configured to receive a bitstream containing point cloud data; and
a decoder configured to decode the point cloud data.
